(19) United States
(12) Patent Application Publication
(10) Pub. No.: US 2025/0375905 A1
(43) Pub. Date: Dec. 11, 2025

(54) KINEMATICS OF A MECHANICAL END EFFECTOR FOR A HUMANOID ROBOT

(71) Applicant: Figure AI Inc., San Jose, CA (US)

(72) Inventors: Jake Goldsmith, San Jose, CA (US); Michael Stevens, San Jose, CA (US); Jacob Daniel Webb, San Jose, CA (US)

(21) Appl. No.: 19/224,252

(22) Filed: May 30, 2025

Related U.S. Application Data
(63) Continuation of application No. PCT/US2025/011450, filed on Jan. 13, 2025.
(60) Provisional application No. 63/620,633, filed on Jan. 12, 2024.
(60) Provisional application No. 63/561,315, filed on Mar. 5, 2024.
(60) Provisional application No. 63/573,226, filed on Apr. 2, 2024.

(51) Int. Cl. B25J 15/10; B25J 9/10

(52) U.S. Cl. CPC B25J 15/10; B25J 9/10

(57) ABSTRACT

The present disclosure provides a thumb assembly for an end effector for a humanoid robot. The thumb assembly includes a digit assembly comprising a proximal assembly, a medial assembly, a distal assembly, a proximal interphalangeal joint pivotably coupling the proximal assembly to the medial assembly, and a distal interphalangeal joint pivotably coupling the distal assembly to the medial assembly. The thumb assembly also includes a motor assembly comprising a first motor and a second motor, and a gear assembly. The gear assembly includes a flexion gear configured to be driven by the first motor to cause the digit assembly to move about a second carpometacarpal joint axis, and an interposition gear configured to be driven by the second motor to cause the digit assembly to move about a first carpometacarpal joint axis.

### CROSS-REFERENCE TO RELATED APPLICATIONS

This application is a continuation application of PCT Application No. PCT/US25/11450 which claims benefit under 35 U.S.C. § 119 of U.S. Provisional Patent Applications Nos. 63/561,315, 63/573,226, 63/620,633 all of which are incorporated herein by reference for any purpose. U.S. patents application Ser. Nos. 19/006,191, 19/000,626, 18/919,263 and 18/919,274, and U.S. Provisional Patent Application Nos. 63/614,499, 63/617,762, 63/615,766, 63/557,874, 63/626,040, 63/626,105, 63/625,362, 63/625,370, 63/625,381, 63/625,384, 63/625,389, 63/625,405, 63/625,423, 63/625,431, 63/685,856, 63/696,507, 63/696,533, 63/706,768, 63/722,057, and 63/700,749 are all incorporated herein by reference for any purpose. PCT Application No. PCT/US25/10425 is incorporated by reference for any purpose.

### TECHNICAL FIELD

This disclosure relates to a mechanical end effector for a robot, specifically a general-purpose humanoid robot. The mechanical end effector includes various assemblies, components contained in the various assemblies, and connections between said components that provide the mechanical end effector with the ability to substantially mimic the movements, capabilities, and configuration of a human hand.

### BACKGROUND

The current workplace landscape is marked by an unparalleled labor shortage, evident in over 10 million unsafe or undesirable jobs within the United States. These positions often encompass tasks in high-risk sectors—such as manufacturing, construction, and materials handling—where human labor faces safety challenges or heightened physical strain. To mitigate this widening labor gap, there is a pronounced need for high-performance robotic systems that can assume responsibility for a variety of demanding, repetitive, or potentially dangerous operations. Consequently, ongoing advancements in robotics research have concentrated on the development of sophisticated, general-purpose humanoid robots, which are specifically engineered to function within environments originally designed for human workers. These general-purpose humanoid robots are equipped with hardware and software architectures optimized for performing diverse tasks with efficiency, accuracy, and reliability in human-centric environments.

In order to fulfill the functional and ergonomic requirements of human-centric environments, general-purpose humanoid robots are commonly outfitted with anthropomorphic features, including two legs, two arms, a torso, and a head or face-like interface that may provide user feedback or display information. Central to this anthropomorphic design philosophy is the mechanical end effector of the robot, which should be able to approximate most of the capability of the human hand in terms of dexterity, strength, and overall versatility. By being able to approximate most of the capability of the human hand, the end effector can more effectively interact with complex, real-world objects, thereby performing functions such as grasping, rotating, and manipulating items with minimal risk of slippage or damage. In addition to providing a high level of dexterity, the design must satisfy operational constraints related to energy consumption, cost efficiency, and mechanical durability. As such, there is a need for a mechanical end effector that can provide humanoid robots with the ability to execute tasks with human-equivalent precision, robustness, and adaptability in dynamic and unpredictable work environments.

### SUMMARY

The present disclosure provides a thumb assembly for an end effector for a humanoid robot, comprising: a digit assembly comprising a proximal assembly, a medial assembly, a distal assembly, a proximal interphalangeal joint pivotably coupling the proximal assembly to the medial assembly, and a distal interphalangeal joint pivotably coupling the distal assembly to the medial assembly; a motor assembly comprising a first motor and a second motor; and a gear assembly comprising a flexion gear configured to be driven by the first motor, wherein said driving of the flexion gear causes the digit assembly to move about a second carpometacarpal joint axis, and an interposition gear configured to be driven by the second motor, wherein driving of the interposition gear causes the digit assembly to move about a first carpometacarpal joint axis.

The present disclosure also provides an underactuated end effector for a humanoid robot, comprising: a frame defining a palm region; a finger assembly removably connected to the frame, wherein the finger assembly has a sagittal plane extending along a length of said finger assembly; a thumb assembly removably connected to the frame proximate the palm region, the thumb assembly comprising: a motor assembly having a first motor including a first motor shaft, wherein the first motor shaft has a first motor shaft axis, and wherein the first motor shaft is configured to rotate about the first motor shaft axis; and a second motor including a second motor shaft, wherein the second motor shaft has a second motor shaft axis, wherein the second motor shaft is configured to rotate about the second motor shaft axis; wherein the first motor shaft axis is oriented at a first acute angle relative to the sagittal plane; and wherein the second motor shaft axis is oriented at a second acute angle relative to the sagittal plane.

The present disclosure further provides a humanoid robot with an end effector for a humanoid robot, the end effector comprising: a frame; a motor assembly including: (i) a first motor removably coupled to the frame, and (ii) a second motor removably coupled to the frame and positioned adjacent to the first motor; a gear assembly coupled to a digit assembly and comprising: a flexion gear configured to be rotated by the first motor, and wherein said rotation of the flexion gear moves the digit assembly from a hyperextended state to a flexed state; and an interposition gear configured to be driven by the second motor, and wherein said rotation of the interposition gear moves the digit assembly from an unrotated state to a rotated state.

The present disclosure additionally provides an underactuated end effector for a humanoid robot, comprising: a frame; a plurality of finger assemblies removably connected to the frame, wherein each finger assembly of the plurality of finger assemblies includes a finger motor assembly; and a thumb assembly removably connected to the frame, the thumb assembly comprising: a first motor with a first motor shaft, wherein the first motor shaft is rotatable about a first motor shaft axis; a first motor gear connected to the first motor shaft and being rotatable about: the first motor shaft, and a first motor gear axis that is coaxial the first motor shaft; a second motor with a second motor shaft, wherein the second motor shaft is rotatable about a second motor shaft axis; a second motor gear connected to the second motor shaft and configured for rotation about: the second motor shaft, and a second motor gear axis that is coaxial with the second motor shaft; and wherein (i) the first motor shaft axis is oriented substantially parallel to the second motor shaft axis, and (ii) the first motor gear axis is oriented substantially parallel to the second motor gear axis.

The present disclosure also provides an underactuated end effector for a humanoid robot, comprising: a frame; a plurality of finger assemblies connected to the frame, each finger assembly of the plurality of finger assemblies comprising: a metacarpophalangeal joint; a proximal finger interphalangeal joint; a distal finger interphalangeal joint; and a thumb assembly removably connected to the frame, the thumb assembly comprising: a first carpometacarpal joint; a second carpometacarpal joint; a metacarpophalangeal joint; an interphalangeal joint; a carpometacarpal encoder positioned proximate the first carpometacarpal joint and configured to collect data related to rotation of the first carpometacarpal joint; a first thumb encoder positioned proximate the metacarpophalangeal joint and configured to collect data related to rotation of the metacarpophalangeal joint; and a second thumb encoder positioned proximate the interphalangeal joint and configured to collect data related to rotation of the interphalangeal joint, and wherein the first thumb encoder and second thumb encoder are positioned adjacent to a main medial link of the thumb assembly.

The present disclosure further provides a humanoid robot with an underactuated end effector, the end effector comprising: an end effector frame; a palm housing coupled to the end effector frame and having a sagittal plane; a plurality of finger assemblies removably connected to a first side of the end effector frame, wherein the sagittal plane of the palm housing is aligned with a longitudinal plane of a finger assembly of the plurality of finger assemblies; a thumb assembly removably connected to a second side of the end effector frame, the thumb assembly comprising: a motor assembly, the motor assembly comprising: a first motor with a first motor shaft, wherein the first motor shaft is configured to rotate about a first motor shaft axis; a second motor with a second motor shaft, wherein the second motor shaft is configured to rotate about a second motor shaft axis; wherein at least an extent of the first motor and the second motor are positioned between the frame and the palm housing; and wherein both the first motor shaft axis and the second motor shaft axis are not arranged parallel to the sagittal plane.

The described thumb assembly for a robotic or prosthetic hand includes various configurations of motors, gears, joints, and encoders to achieve a range of motion and functionality. The carpometacarpal joint axes, both first and second, may or may not intersect depending on the design configuration. The assembly integrates a first motor and a second motor, with each motor shaft oriented at acute angles relative to the sagittal plane of the end effector. The motor shaft axes and motor gear axes are configured to be substantially parallel to each other to ensure synchronized movement. Additionally, the motors are connected to a drive system that includes flexion gears, interposition gears, and worm drive gears to facilitate controlled movement of the thumb assembly between curled and uncurled positions.

The thumb assembly is equipped with a housing assembly that encases various components. This carpometacarpal joint housing assembly is designed to rotate in response to motor-driven gear rotations and includes a base joint receiver that accommodates the proximal housing assembly in different thumb positions. The assembly may also feature a textile covering for protective or other purposes. Encoders are strategically positioned near the carpometacarpal joint, proximal interphalangeal joint, and distal interphalangeal joint to collect data on the thumb's range of motion and provide feedback for precise control. The joints exhibit specific ranges of motion: the proximal interphalangeal joint between 55° and 90°, the distal interphalangeal joint between 35° and 57°, and the carpometacarpal joints between 35° and 160°, depending on the joint.

In some embodiments, the end effector may include a worm wheel and worm drive system. Bearings in the worm wheel assembly allow for slippage to protect the system from damage if resistance is encountered. The thumb drive assembly includes a combination of flexion gears, worm drive gears, and drive shafts to achieve smooth digit movement with four degrees of freedom using only two motors. Finger assemblies with three degrees of freedom are removably connected to the frame and driven by individual motors. The palm region of the frame houses the motors, and the thumb drive assembly further incorporates an interposition gear coupled to a lower frame member, enabling rotational movement. The assembly lacks mechanical cables for actuation and may be equipped with a biasing member to maintain the thumb in an uncurled position, enhancing the robustness and functionality of the overall system.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1A is a front perspective view of a humanoid robot in an upright, standing position P1 having a wrist coupler and a mechanical end effector, wherein the mechanical end effector includes a plurality of finger assemblies, a thumb assembly, a housing, and electronics for controlling the finger assemblies and the thumb assembly;

FIG. 1B is a perspective view of the wrist coupler and the mechanical end effector of FIG. 1A, wherein said wrist coupler is removably secured to a lower extent of a robot arm;

FIG. 2 is a perspective view of the wrist coupler and a mechanical end effector of FIGS. 1A-1B;

FIG. 3 is a front or palm view of the mechanical end effector of FIGS. 1A-2;

FIG. 4 is a back or top view of the mechanical end effector of FIGS. 1A-2;

FIG. 5 is a right side or thumb view of the mechanical end effector of FIGS. 1A-2;

FIG. 6 is a left side or finger view of the mechanical end effector of FIGS. 1A-2;

FIG. 7 is a bottom view of the mechanical end effector of FIGS. 1A-2;

FIG. 8 is a top view of the mechanical end effector of FIGS. 1A-2;

FIG. 9 is a perspective view of the mechanical end effector of FIGS. 1A-2, wherein an extent of the housing has been removed to show a portion of the components contained within said housing;

FIG. 10 is a perspective schematic view that shows the 16 degrees of freedom contained in the mechanical end effector of FIG. 1A-2;

FIG. 11 is a front or palm view of the mechanical end effector of FIGS. 1A-2, wherein an extent of the housing has been removed to show a portion of the components contained within said housing;

FIG. 12 is a palm schematic view that shows the 16 degrees of freedom contained in the mechanical end effector of FIG. 1A-2;

FIG. 13 is a bottom perspective view of the thumb assembly of the mechanical end effector of FIGS. 1A-2 in a partially curled configuration, wherein said thumb assemblies includes a base joint assembly and a digit assembly;

FIG. 14 is a top perspective view of the thumb assembly of FIGS. 1A-2 in the partially curled configuration includes: (i) a motor assembly with drive gears, (ii) a base joint assembly, (iii) a proximal assembly, (iv) a medial assembly, and (v) a distal assembly;

FIG. 15 is a right side view of the thumb assembly of FIGS. 13-14;

FIG. 16 is a left side view of the thumb assembly of FIGS. 13-14;

FIG. 17 is a top view of the thumb assembly of FIGS. 13-14;

FIG. 18 is a bottom view of the thumb assembly of FIGS. 13-14;

FIG. 19 is a front or palm view of the thumb assembly of FIGS. 13-14;

FIG. 20 is a back or top view of the thumb assembly of FIGS. 13-14;

FIG. 21 is a top view of the thumb assembly of FIGS. 13-14 in an uncurled configuration;

FIG. 22 is a cross-sectional view of the thumb assembly taken along line 22-22 of FIG. 21;

FIG. 23 is a cross-sectional view of the thumb assembly taken along line 23-23 of FIG. 21;

FIG. 24 is a cross-sectional view of the thumb assembly taken along line 24-24 of FIG. 21;

FIG. 25 is a palm view of the thumb assembly of FIGS. 13-14 in a curled configuration;

FIG. 26 is a cross-sectional view of the thumb assembly taken along line 26-26 of FIG. 25;

FIG. 27 is a cross-sectional view of the thumb assembly taken along line 27-27 of FIG. 25;

FIGS. 28A-28D show a front or palm view of the thumb assembly of FIGS. 13-14, wherein the housing assemblies have been omitted to better illustrate the inner linkages of said thumb assembly and angles associated therewith;

FIG. 29 is a diagram showing layers of materials contained in the housing of the thumb assembly of FIGS. 11-12;

FIGS. 30-31 show a front or palm view of the thumb assembly of FIGS. 13-14, wherein the housing assemblies have been omitted to better illustrate the inner linkages of said thumb assembly and lengths associated therewith;

FIG. 32 is a perspective view of the motor assembly and its gear assembly of FIGS. 13-14;

FIG. 33 is a right side view of the motor assembly of FIG. 32;

FIG. 34 is a palm view of the motor assembly of FIG. 32;

FIG. 35 is a perspective view of the digit assembly of FIGS. 13-14, and wherein said digit assembly includes a proximal assembly, a medial assembly, and a distal assembly;

FIG. 36 is a front or palm view of the digit assembly of FIGS. 13-14;

FIG. 37 is an exploded view of the base joint assembly and the digit assembly of the thumb assembly of FIGS. 13-14;

FIG. 38 shows a palm view of the thumb assembly of FIGS. 13-14 in a first configuration C₁, and wherein: (i) the proximal, medial, and distal assemblies are in a minimum flexion position, (ii) the medial and distal assemblies are substantially aligned in a first state, and (iii) the thumb assembly is in an uncurled and unrotated state;

FIG. 39 shows a palm view of the motor and movement assembly of the thumb assembly of FIGS. 13-14 in the first configuration C₁;

FIG. 40 is a cross-sectional view of the thumb assembly in the first configuration C₁ and taken along line 40-40 of FIG. 61;

FIG. 41 shows a palm view of the thumb assembly of FIGS. 13-14 in a second configuration C₂, and wherein: (i) the proximal and medial assemblies are in a first partially curled state, (ii) the medial and distal assemblies are substantially aligned in the first state, and (iii) the thumb assembly is in the unrotated state;

FIG. 42 shows a palm view of the motor and movement assembly of the thumb assembly of FIGS. 13-14 in the second configuration C₂;

FIG. 43 is a cross-sectional view of the thumb assembly in the second configuration C₂ and taken along line 43-43 of FIG. 72;

FIG. 44 shows a palm view of the thumb assembly of FIGS. 13-14 in a third configuration C₃, and wherein: (i) the proximal and medial assemblies are in a second partially curled state, (ii) the medial and distal assemblies are substantially aligned in the first state, and (iii) the thumb assembly is in the unrotated state;

FIG. 45 shows a palm view of the motor and movement assembly of the thumb assembly of FIGS. 13-14 in the third configuration C₃;

FIG. 46 shows a cross-sectional view of the thumb assembly in the third configuration C₃;

FIG. 47 shows a palm view of the thumb assembly of FIGS. 13-14 in a fourth configuration C₄, and wherein: (i) the proximal and medial assemblies are in a maximum flexion position, (ii) the medial and distal assemblies are aligned in the first state, and (iii) the thumb assembly is in the unrotated state;

FIG. 48 shows a palm view of the motor and movement assembly of the thumb assembly of FIGS. 13-14 in the fourth configuration C₄;

FIG. 49 is a cross-sectional view of the thumb assembly in the fourth configuration C₄ and taken along line 49-49 of FIG. 74;

FIG. 50 shows a palm view of the thumb assembly of FIGS. 13-14 in a fifth configuration Cs, and wherein: (i) the proximal and medial assemblies are in the maximum flexion position, (ii) the distal assembly is in a first partially curled state, and (iii) the thumb assembly is in the unrotated state;

FIG. 51 shows a palm view of the motor and movement assembly of the thumb assembly of FIGS. 13-14 in the fifth configuration Cs;

FIG. 52 shows a palm view of the thumb assembly in the fifth configuration C₅;

FIG. 53 shows a palm view of the thumb assembly of FIGS. 13-14 in a sixth configuration C₆, and wherein: (i) the proximal and medial assemblies are in the maximum flexion position, (ii) the distal assembly is in a second partially curled state, and (iii) the thumb assembly is in the unrotated state;

FIG. 54 shows a palm view of the motor and movement assembly of the thumb assembly of FIGS. 13-14 in the sixth configuration C₆;

FIG. 55 is a cross-sectional view of the thumb assembly in the sixth configuration C₆ and taken along line 55-55 of FIG. 76;

FIG. 56 shows a palm view of the thumb assembly of FIGS. 13-14 in a seventh configuration C₇, and wherein: (i) the proximal, medial, and distal assemblies are at a maximum flexion position, and (ii) said thumb assembly is in the fully curled state, but in the unrotated state;

FIG. 57 shows a palm view of the motor and movement assembly of the thumb assembly of FIGS. 13-14 in the seventh configuration C₇;

FIG. 58 is a cross-sectional view of the thumb assembly in the seventh configuration C₇ and taken along line 58-58 of FIG. 78;

FIG. 59 is a schematic showing the movement assembly moving of the thumb assembly from the first configuration C₁ to the seventh configuration C₇;

FIG. 60 is a schematic showing the movement of the pivot points as the movement assembly of the thumb assembly moves from the first configuration C₁ to the seventh configuration C₇;

FIG. 61 is a top view of the thumb assembly in the first configuration C₁;

FIG. 62 is a cross-sectional view of the thumb assembly in the first configuration C₁ and taken along line 62-62 of FIG. 61;

FIG. 63 is a top view of the thumb assembly in the first configuration C₁;

FIG. 64 is a cross-sectional view of the thumb assembly in the first configuration C₁ and taken along the 64-64 line of FIG. 63;

FIG. 65 is a top view of the thumb assembly of FIGS. 13-14 in the first configuration C₁;

FIG. 66 is a cross-sectional view of the thumb assembly in the first configuration C₁ taken along the 66-66 line of FIG. 65;

FIG. 67 is a cross-sectional view of the thumb assembly in the first configuration C₁ taken along the 67-67 line of FIG. 65;

FIG. 68 is a cross-sectional view of the thumb assembly in the first configuration C₁ taken along the 68-68 line of FIG. 65;

FIG. 69 is a back or rear view of the thumb assembly of FIGS. 13-14 in the first configuration C₁;

FIG. 70 is a cross-sectional view of the thumb assembly in the first configuration C₁ and taken along the 70-70 line of FIG. 69;

FIG. 71 is a cross-sectional view of the thumb assembly in the first configuration C₁ and taken along the 71-71 line of FIG. 69;

FIG. 72 is a top view of the thumb assembly of FIGS. 13-14 in the second configuration C₂;

FIG. 73 is a cross-sectional view of the thumb assembly in the second configuration C₂ and taken along 73-73 line of FIG. 72;

FIG. 74 is a top view of the thumb assembly of FIGS. 13-14 in the fourth configuration C₄;

FIG. 75 is a cross-sectional view of the thumb assembly in the fourth configuration C₄ and taken along the 75-75 line of FIG. 74;

FIG. 76 is a top view of the thumb assembly of FIGS. 13-14 in the sixth configuration C₆;

FIG. 77 is a cross-sectional view of the thumb assembly in the sixth configuration C₆ and taken along the 77-77 line of FIG. 76;

FIG. 78 is a top view of the thumb assembly of FIGS. 13-14 in the seventh configuration C₇;

FIG. 79 is a cross-sectional view of the thumb assembly in the seventh configuration C₇ and taken along the 79-79 line of FIG. 78;

FIG. 80 shows a palm view of the thumb assembly of FIGS. 13-14 in the first configuration C₁, and wherein: (i) the proximal, medial, and distal assemblies are in the minimum flexion position, (ii) the medial and distal assemblies are substantially aligned in the first state, and (iii) the thumb assembly is in the uncurled and unrotated state;

FIG. 81 shows a palm view of the motor and movement assembly of the thumb assembly of FIGS. 13-14 in the first configuration C₁;

FIG. 82 shows a cross-sectional view of the thumb assembly in the first configuration C₁;

FIG. 83 shows a palm view of the thumb assembly of FIGS. 13-14 in an eighth configuration C₈, and wherein: (i) the proximal and medial assemblies are in the third partially curled state, (ii) the proximal assembly is in contact with the first object, (iii) the medial and distal assemblies are substantially aligned in the first state, and (iv) the thumb assembly is in the unrotated state;

FIG. 84 shows a palm view of the motor and movement assembly of the thumb assembly of FIGS. 13-14 in the eighth configuration C₈;

FIG. 85 shows a cross-sectional view of the thumb assembly in the eighth configuration C₈ and taken along 85-85 line of FIG. 95;

FIG. 86 shows a palm view of the thumb assembly of FIGS. 13-14 in a ninth configuration C₉, and wherein: (i) the proximal and medial assemblies are in the third partially curled state, (ii) the proximal assembly is in contact with the first object, (iii) the distal assembly is in the third partially curled state, and (iv) the thumb assembly is in the unrotated state;

FIG. 87 shows a palm view of the motor and movement assembly of the thumb assembly of FIGS. 13-14 in the ninth configuration C₉;

FIG. 88 shows a palm view of the thumb assembly in the ninth configuration C₉;

FIG. 89 shows a palm view of the thumb assembly of FIGS. 13-14 in a tenth configuration C₁₀, and wherein: (i) the proximal and medial assemblies are in the third partially curled state, (ii) the proximal assembly is in contact with the first object, (iii) the distal assembly is in the fourth partially curled state, and (iv) the thumb assembly is in the unrotated state;

FIG. 90 shows a palm view of the motor and movement assembly of the thumb assembly of FIGS. 13-14 in the tenth configuration C₁₀;

FIG. 91 shows a palm view of the thumb assembly in the tenth configuration C₁₀;

FIG. 92 shows a palm view of the thumb assembly of FIGS. 13-14 in an eleventh configuration C₁₁, and wherein: (i) the proximal and medial assemblies are in the third partially curled state, (ii) the proximal assembly is in contact with the first object, (iii) the distal assembly is in the fifth partially curled state and in contact with the second object, and (iv) the thumb assembly is in the unrotated state;

FIG. 93 shows a palm view of the motor and movement assembly of the thumb assembly of FIGS. 13-14 in the eleventh configuration C₁₁ and taken along 93-93 line of FIG. 97;

FIG. 94 shows a palm view of the thumb assembly in the eleventh configuration Cn;

FIG. 95 is a top view of the thumb assembly of FIGS. 13-14 in the eighth configuration C₈;

FIG. 96 is a cross-sectional view of the thumb assembly in the eighth configuration C₈ and taken along 96-96 line of FIG. 95;

FIG. 97 is a top view of the thumb assembly of FIGS. 13-14 in the eleventh configuration C₁₁;

FIG. 98 is a cross-sectional view of the thumb assembly in the eleventh configuration C₁₁ and taken along 98-98 line of FIG. 97;

FIG. 99 shows a palm view of the thumb assembly in the first configuration C₁, and wherein: (i) the proximal, medial, and distal assemblies are in the minimum flexion position, (ii) the medial and distal assemblies are aligned in the first state, and (iii) the thumb assembly is in the uncurled and unrotated state;

FIG. 100 shows a palm view of the motor and movement assembly of the thumb assembly of FIGS. 13-14 in the first configuration C₁;

FIG. 101 shows a palm view of the thumb assembly in the first configuration C₁;

FIG. 102 shows a palm view of the thumb assembly of FIGS. 13-14 in a twelfth configuration C₁₂, and wherein: (i) the proximal and medial assemblies are in the fourth partially curled state, (ii) the medial and distal assemblies are aligned in the first state, (iii) the distal assembly is in contact with an object, and (iv) the thumb assembly is in the unrotated state;

FIG. 103 shows a palm view of the motor and movement assembly of the thumb assembly of FIGS. 13-14 in the twelfth configuration C₁₂;

FIG. 104 is a cross-sectional view of the thumb assembly in the twelfth configuration C₁₂ and taken along line 104-104 of FIG. 105;

FIG. 105 is a top side view of the thumb assembly of FIGS. 13-14 in the twelfth configuration C₁₂;

FIG. 106 is a cross-sectional view of the thumb assembly in the twelfth configuration C₁₂ and taken along 106-106 line of FIG. 105;

FIG. 107 shows a palm view of the thumb assembly of FIGS. 13-14 in the first configuration C₁, and wherein: (i) the proximal, medial, and distal assemblies are in the minimum flexion position, (ii) the medial and distal assemblies are aligned in the first state, and (iii) the thumb assembly is in the uncurled and unrotated state;

FIG. 108 shows a palm view of the motor and movement assembly of the thumb assembly of FIGS. 13-14 in the first configuration C₁;

FIG. 109 shows a cross-sectional view of the thumb assembly in the first configuration C₁;

FIG. 110 shows a palm view of the thumb assembly of FIGS. 13-14 in a thirteenth configuration C₁₃, and wherein: (i) the proximal and medial assemblies are in the fifth partially curled state, (ii) the medial assembly is in contact with an object, (iii) the medial and distal assemblies are aligned in the first state, and (iv) the thumb assembly is in the unrotated state;

FIG. 111 shows a palm view of the motor and movement assembly of the thumb assembly of FIGS. 13-14 in the thirteenth configuration C₁₃;

FIG. 112 is a cross-sectional view of the thumb assembly in the thirteenth configuration C₁₃ and taken along line 112-112 of FIG. 116;

FIG. 113 shows a palm view of the thumb assembly of FIGS. 13-14 in a fourteenth configuration C₁₄, and wherein: (i) the proximal and medial assemblies are in the fifth partially curled state, (ii) the medial assembly is in contact with an object, (iii) the distal assembly is in a fourth partially curled state, and (iv) the thumb assembly is in the unrotated state;

FIG. 114 shows a palm view of the motor and movement assembly of the thumb assembly of FIGS. 13-14 in the fourteenth configuration C₁₄;

FIG. 115 is a cross-sectional view of the thumb assembly in the fourteenth configuration C₁₄ and taken along line 115-115 of FIG. 118;

FIG. 116 is a top view of the thumb assembly of FIGS. 13-14 in the thirteenth configuration C₁₃;

FIG. 117 is a cross-sectional view of the thumb assembly in the thirteenth configuration C₁₃ and taken along;

FIG. 118 is a top view of the thumb assembly in the thirteenth configuration;

FIG. 119 is a cross-sectional view of the thumb assembly in the thirteenth configuration taken along 119-119 line of FIG. 118;

FIG. 120 shows a right side view of the thumb assembly of FIGS. 13-14 in the first configuration C₁, and wherein: (i) the proximal, medial, and distal assemblies are in the minimum flexion position, (ii) the medial and distal assemblies are substantially aligned in the first state, and (iii) the thumb assembly is in the uncurled and unrotated state;

FIG. 121 shows a right side view of the thumb assembly of FIGS. 13-14 in the fifteenth configuration C₁₅, and wherein: (i) the proximal, medial, and distal assemblies are in the minimum flexion position, (ii) the medial and distal assemblies are aligned in the first state, and (iii) the thumb assembly is in a first partially rotated state, but remains in the uncurled state;

FIG. 122 shows a right side view of the thumb assembly of FIGS. 13-14 in the sixteenth configuration C₁₆, and wherein: (i) the proximal, medial, and distal assemblies are in the minimum flexion position, (ii) the medial and distal assemblies are substantially aligned in the first state, and (iii) the thumb assembly is in a second partially rotated state, but remains in the uncurled state;

FIG. 123 shows a right side view of the thumb assembly of FIGS. 13-14 in the seventeenth configuration C₁₇, and wherein: (i) the proximal, medial, and distal assemblies are in the minimum flexion position, (ii) the medial and distal assemblies are substantially aligned in the first state, and (iii) the thumb assembly is in a fully rotated state, but remains in the uncurled state;

FIG. 124 is a top view of the thumb assembly of FIGS. 13-14 and 120 in the fifteenth configuration C₁;

FIG. 125 is a top view of the thumb assembly of FIGS. 13-14 and 121 in the fifteenth configuration C₁₅;

FIG. 126 is a top view of the thumb assembly of FIGS. 13-14 and 122 in the sixteenth configuration C₁₆;

FIG. 127 is a top view of the thumb assembly of FIGS. 13-14 and 123 in the seventeenth configuration C₁₇;

FIG. 128 is a perspective view of the thumb assembly of FIGS. 13-14 and 120 in the fifteenth configuration C₁;

FIG. 129 is a perspective view of the thumb assembly of FIGS. 13-14 and 121 in the fifteenth configuration C₁₅;

FIG. 130 is a perspective view of the thumb assembly of FIGS. 13-14 and 122 in the sixteenth configuration C₁₆; and

FIG. 131 is a perspective view of the thumb assembly of FIGS. 13-14 and 123 in the seventeenth configuration C₁₇.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well-known methods, procedures, components, and/or circuitry have been described at a relatively high-level, without detail, in order to avoid unnecessarily obscuring aspects of the present disclosure.

While this disclosure includes several embodiments in many different forms, there is shown in the drawings and will herein be described in detail embodiments with the understanding that the present disclosure is to be considered as an exemplification of the principles of the disclosed methods and systems, and is not intended to limit the broad aspects of the disclosed concepts to the embodiments illustrated. As will be realized, the disclosed methods and systems are capable of other and different configurations and several details are capable of being modified all without departing from the scope of the disclosed methods and systems. For example, one or more of the following embodiments, in part or whole, may be combined consistent with the disclosed methods and systems. As such, one or more steps from the flow charts or components in the Figures may be selectively omitted and/or combined consistent with the disclosed methods and systems. Additionally, one or more steps from the flow charts may be performed in a different order. Accordingly, the drawings, flow charts and detailed description are to be regarded as illustrative in nature, not restrictive or limiting.

### A. Introduction

The mechanical end effector 10 disclosed in this Application is designed to be a component within a robot system, potentially a versatile humanoid robot. Enabling such a robot system to execute general human tasks poses a challenge due to the vast array of potential positions, locations, and states said robots could occupy at any given time in a challenging environment. The multitude of these permutations can be minimized by training the robot system through various methods such as: (i) imitation learning or teleoperation, (ii) supervised learning, (iii) unsupervised learning, (iv) reinforcement learning, (v) inverse reinforcement learning, (vi) regression techniques, or (vii) other established methodologies. To further streamline the vast array of possible positions, locations, and states, reduce manufacturing steps, complexities and costs, minimize components within the robot system, enhance component modularity, and achieve several other advantages that would be apparent to those skilled in the field, two or more components of the end effector 10 can be either: (i) linked, or (ii) fixed to one another. When two or more components are linked or fused, movement of one component results in movement in another component. In contrast to conventional end effectors that fuse the medial and distal assemblies to one another, the disclosed thumb assembly 40 allows for: (i) some independent movement of the medial assembly 470 in relation to the distal assembly 480, and (ii) certain movement of the medial assembly 470 to result in movement of the distal assembly 480. Such linking allows the thumb assembly 40 to become underactuated, that is, to retain its ability to flex, curl, or rotate around an object while eliminating the necessity for multiple actuators, motors, or effectors for each movement of the thumb assembly 40. Indeed, the disclosed thumb assembly 40 includes only two motors that drive linkages that provide four degrees of freedom (DoF). Thus, the end effector 10 has at least twelve DoF, and in a preferred configuration sixteen (16) DoF.

While the disclosed thumb assembly 40 in the end effector 10 utilizes a single biasing member (e.g., spring), the thumb assembly 40 utilizes a direct drive linkage system to eliminate the need to use more than one (e.g., multiple) biasing members (e.g., springs) to force the thumb assembly 40 to remain in a predefined position (e.g., open, uncurled, or neutral). Eliminating the need to use multiple biasing members (e.g., springs) to force the thumb assembly 40 to remain open, uncurled, or in a neutral position. Eliminating the use of multiple biasing members for this purpose provides a significant benefit over conventional end effectors because it: (i) removes the need for the motor assembly to overcome a significant biasing force applied by the biasing members to move the thumb assembly 40, (ii) increases durability, robustness, and life of the end effector 10 due to the fact that said biasing members can rapidly degrade over time, and (iii) makes the control of the digit assembly simpler as the same force is exerted on the housing frame regardless of the direction (i.e., towards the palm or away from the palm) the digit assembly is moving.

Additionally, the disclosed direct drive linkages include components that nest within one another. The use of nesting components is beneficial over a conventional thumb assembly of end effectors because each link is supported by at least one coupling point on either side of a plane extending through the center of the thumb assembly 40. In other words, each link in the disclosed thumb assembly 40 is coupled on multiple sides, not simply coupled on a single side, which increases the durability of the assembly.

The disclosed thumb assembly 40 in the end effector 10 has a proximal assembly 450 that includes: (i) one component that is directly tied to the movement of the motor, and (ii) one component that is not directly tied to the movement of the motor. For example, the movement of the proximal drive link assembly is directly tied to the movement of the motor, while the proximal housing 452 is not directly tied to the movement of the motor. In fact, the proximal assembly 450 utilizes bearings to allow slippage between the motor and at least the proximal housing 452 when an extent of the proximal assembly 450 has come into contact with a resistance point or surface. This configuration is beneficial over conventional end effectors because it allows a single motor to drive the thumb assembly 40, while allowing specific components within the proximal assembly 450 to stop moving even though the motor still drives other components.

Unlike conventional end effectors with thumb assemblies, the end effector 10 disclosed in this Application includes two motors that are positioned within the palm 62 of the end effector 10, wherein: (i) both motors are designed to interact with a single gear assembly, (ii) the first motor is configured to control the digit assembly's adduction/abduction and the second motor is configured to control the digit assembly's flexion/extension. This configuration allows for a compact package that is capable of controlling multiple movements of the thumb assembly 40. Other benefits of the movement assembly are disclosed below in greater detail and/or may be obvious to one of skill in the art.

While the structural configuration of the thumb assembly 40 will be discussed in greater detail below, it should be understood that the thumb assembly 40 is configured to be a separate component of the end effector 10 that is modular and removably coupled to a frame 61.2 of the end effector 10. As such, the thumb assembly 40 is swappable (and in certain embodiments hot-swappable) with another thumb assembly 40. The separate, modular, and swappable nature of the thumb assembly 40 means that: (i) pulleys, articulation cables, and pneumatic or hydraulic mechanisms may be omitted from the end effector 10, and (ii) components of the end effector 10 are not located in the wrist, lower arm, or generally outside of the thumb assembly 40. In other words, a majority of the motors, PCBs, encoders and other electronic components needed to move the thumb assembly 40 are fully contained within said thumb assembly 40 and are not distributed throughout the end effector 10 and/or robot. This containment aspect is desirable because it increases serviceability and thus decreases the cost of ownership and operation of the robot. In other embodiments, all components (e.g., motors, PCBs, encoders, etc.) needed to move the thumb assembly 40 may be fully contained within said thumb assembly 40. In other words, the palm 62 of the end effector 10 and/or other components of the robot may not contain any components needed to move the thumb assembly 40.

Finally, the end effector 10 disclosed herein may lack several components typically found in conventional end effectors. For example, the disclosed end effector 10 (including each finger assembly 22a-22d and the thumb assembly 40) lacks pulleys, articulation cables, more than two motors used in connection with the thumb assembly 40, and force sensors, and other components typically found in conventional end effectors. Eliminating these components reduces cost and complexity, while increasing modularity, serviceability, and durability. Other benefits of the disclosed end effector 10 and its various assemblies and components should be apparent to one of skill in the art based on this disclosure and the accompanying figures.

### B. Humanoid Robot

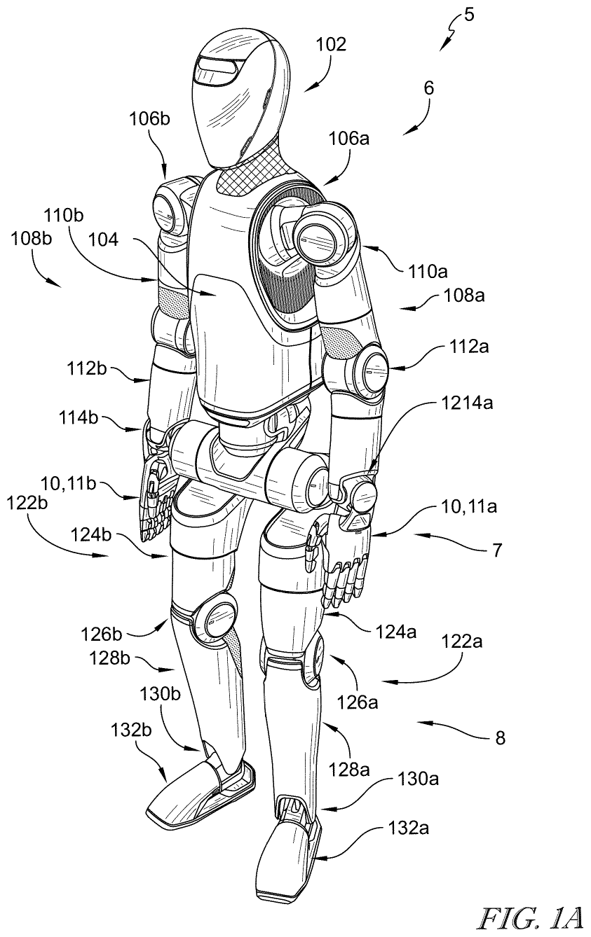

The humanoid robot 5 is designed to have a substantial similarities in form factor and anatomy to human beings including many of the same major appendages that human beings have. The humanoid robot 5 includes an upper region 6, a lower region 7 spaced apart from the upper region 6, and a central region 8 interconnecting the upper region 6 and the lower region 7. The humanoid robot 5 is shown in FIG. 1A in an upright, standing position P1 where a pair of feet 132a, 132b of the lower region 7 are standing on a floor or ground surface G such that the lower region 7 supports the upper region 6 and the central region 8 above the floor G.

The upper region 200 includes the following parts: (a) a head and neck assembly 102, (b) a torso 104, (c) left and right shoulders 106a, 106b, (d) and left and right arm assemblies 108a, 108b each including: (c) a humerus 110a, 110b, (f) a forearm 112a, 112b, (g) a wrist 114a, 114b, and (h) hand or end effector 10 (e.g., 11a, 11b). The lower region 7 includes left and right leg assemblies 120a, 120b each including: (a) a thigh 124a, 124b, (b) a knee 126a, 126b, (c) a shin 128a, 128b, (d) an ankle 130a, 130b, and (c) a foot 132a, 132b. The central region 8 is located generally in, or provides, a pelvis region of the humanoid robot 5. Each of the components of the upper region 6 and the lower region 7 noted above includes at least one actuator configured to move the components relative to one another. The central region 8 is also configured to allow movement of the upper and lower regions 6, 7 relative to one another in a three-dimensional manner.

### C. End Effector

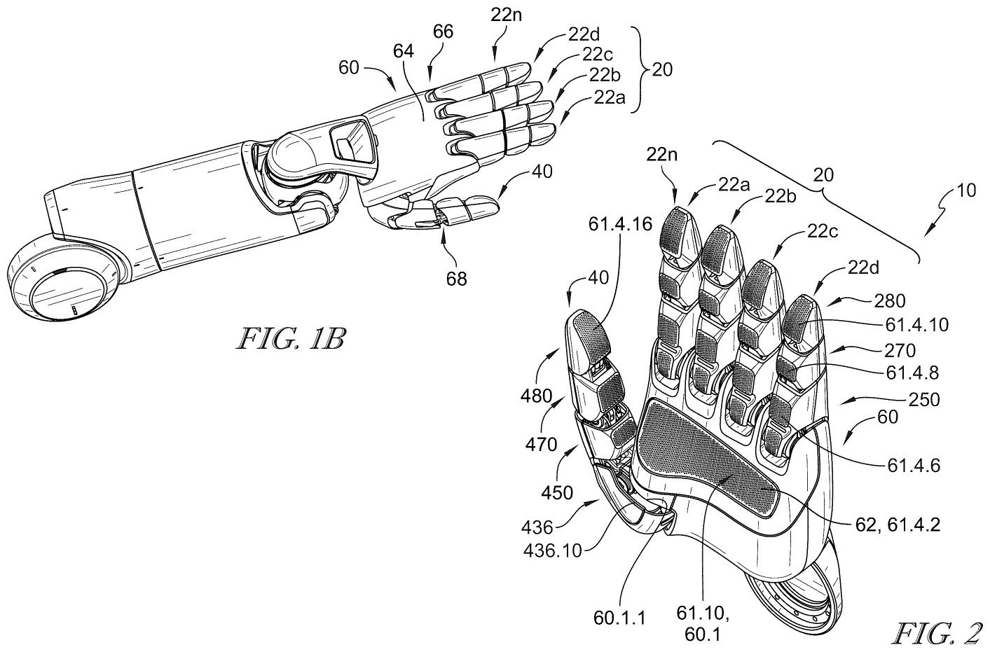

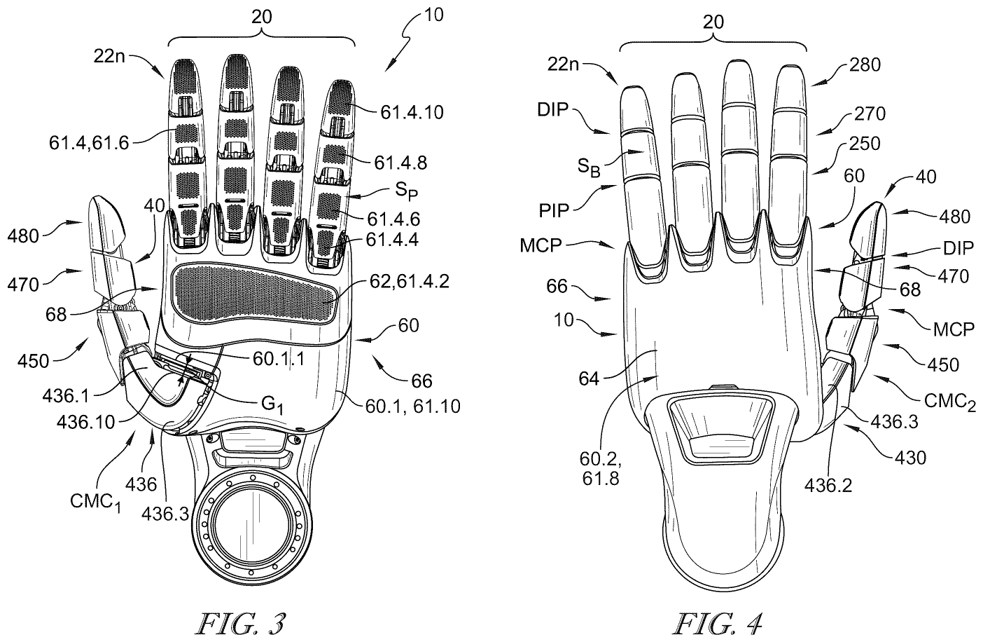

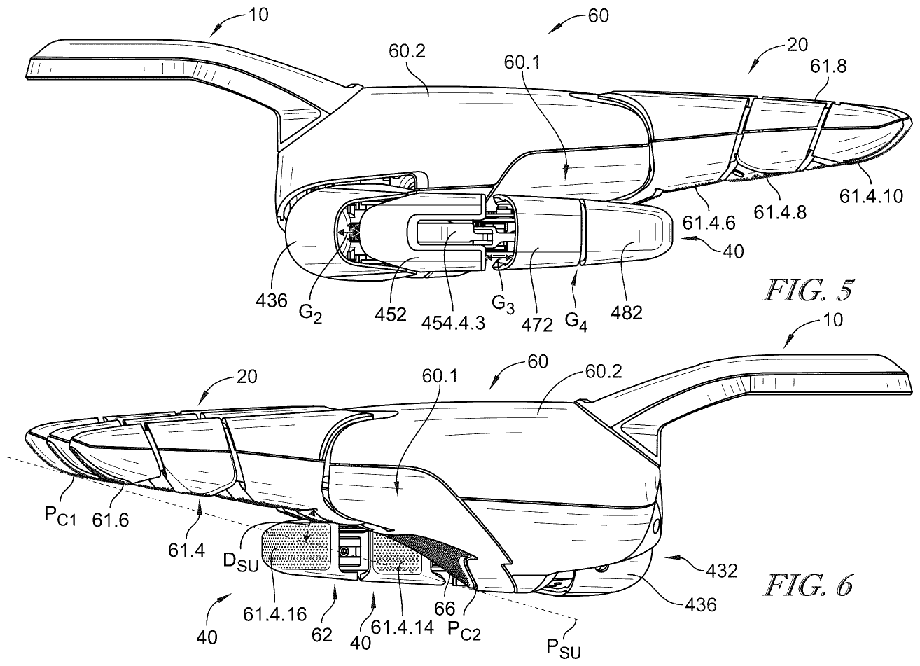

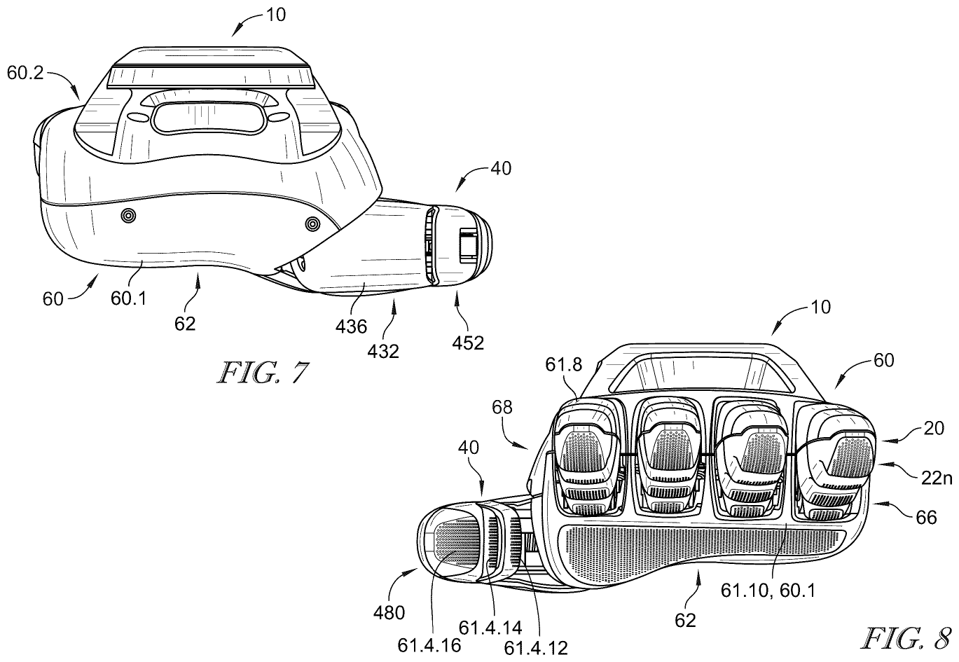

With reference, for example, to FIGS. 1A-12, the end effector 10 includes: (i) a set of finger assemblies 20 with at least one finger assembly 22n (as shown, the set of finger assemblies 20 includes four finger assemblies 22a, 22b, 22c, 22d), (ii) a thumb assembly 40, (iii) a housing assembly 60, and (iv) electronics 80 that are configured to control each finger assembly 22n of the set of finger assemblies 20 and the thumb assembly 40. As shown in the Figures, the housing assembly 60 is configured to: (i) encase and protect the electronics 80, and (ii) securely locate each of the finger assemblies 22a-22d and the thumb assembly 40 in a particular position relative to each other and the housing assembly 60. The housing assembly 60 may be covered by a glove and can have: (i) a palm region 62, (ii) a back region 64, (iii) left and right sides 66, 68, and (iv) a front region 70. Additionally. as discussed in great detail below, said housing assembly 60 is comprised of: (i) a palm housing 60.1, (ii) a back housing 60.2, (iii) a base joint or carpometacarpal joint housing assembly 436, a proximal housing assembly 452, a medial housing assembly 472, and a distal housing assembly 482. It should be understood that the housing assembly 60 may include additional or fewer components or assemblies. It should further be understood that in alternative embodiments, the end effector 10 may include a single finger, two fingers, three fingers, or five fingers. In a further alternative, the end effector 10 may not include a single finger assembly 22a-22d, but instead may include a plurality of thumb assemblies 40.

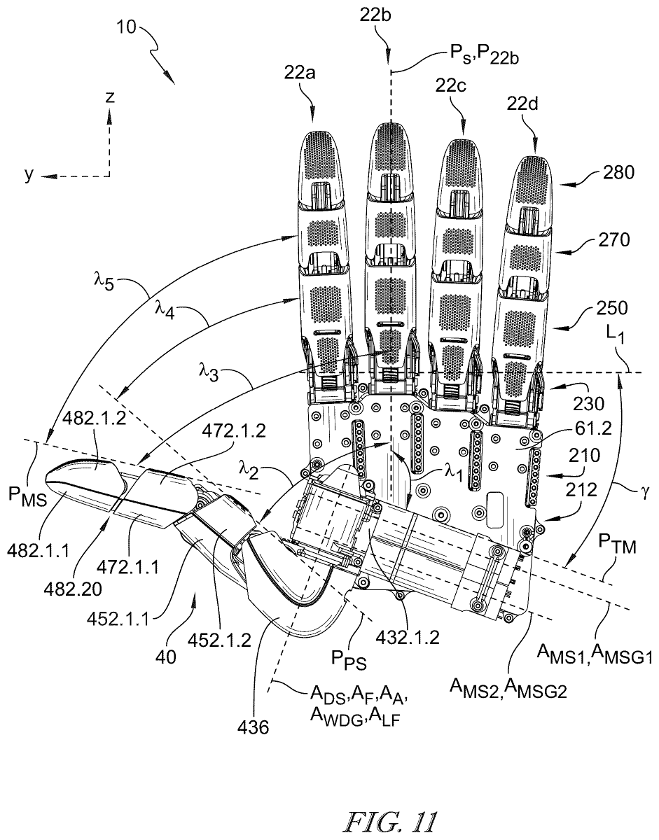

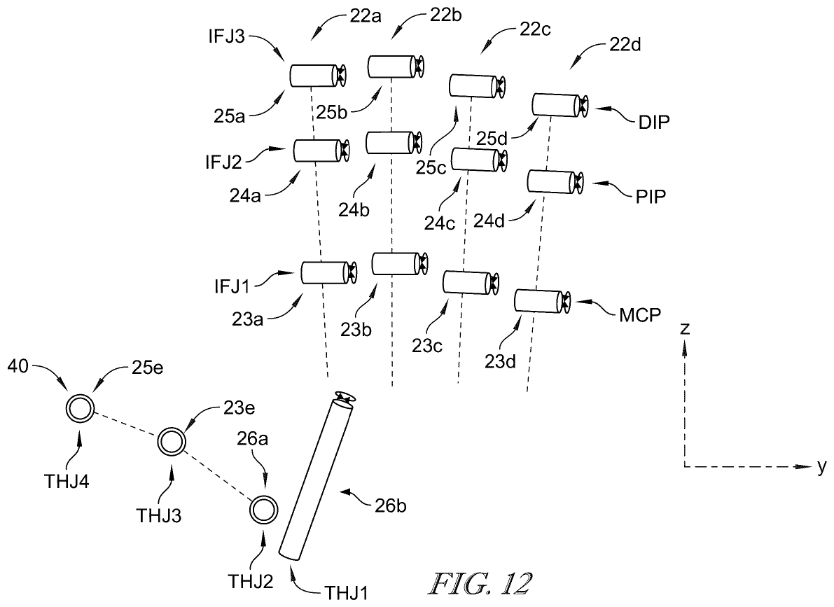

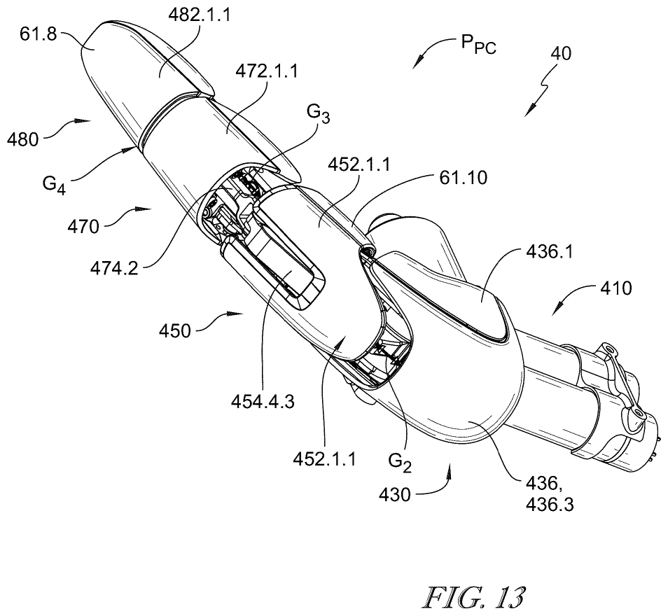

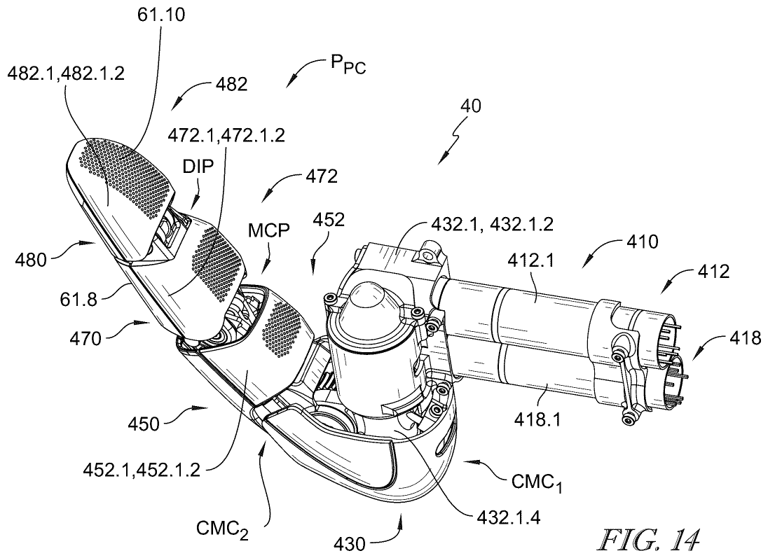

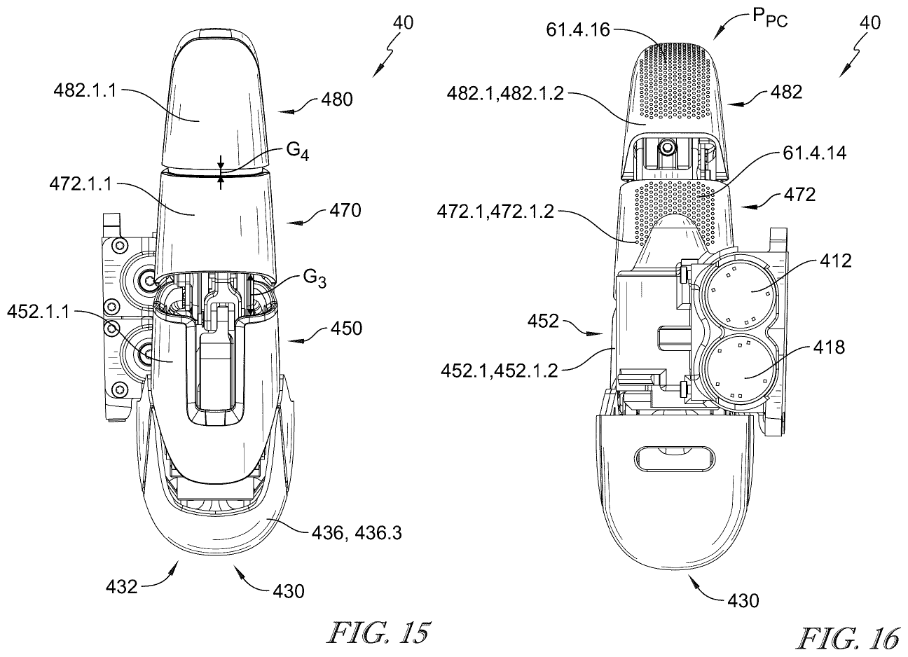

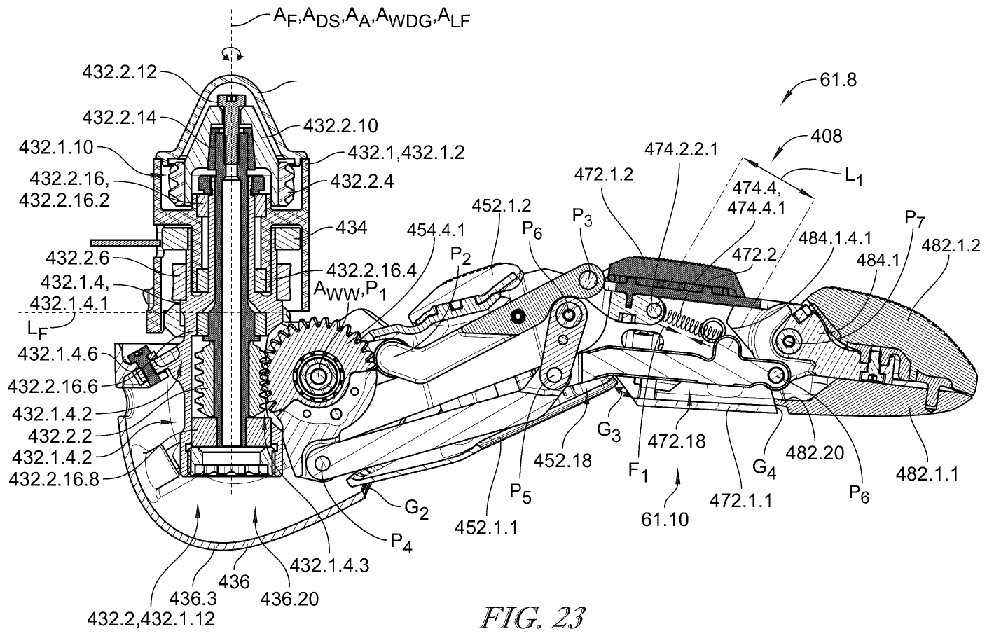

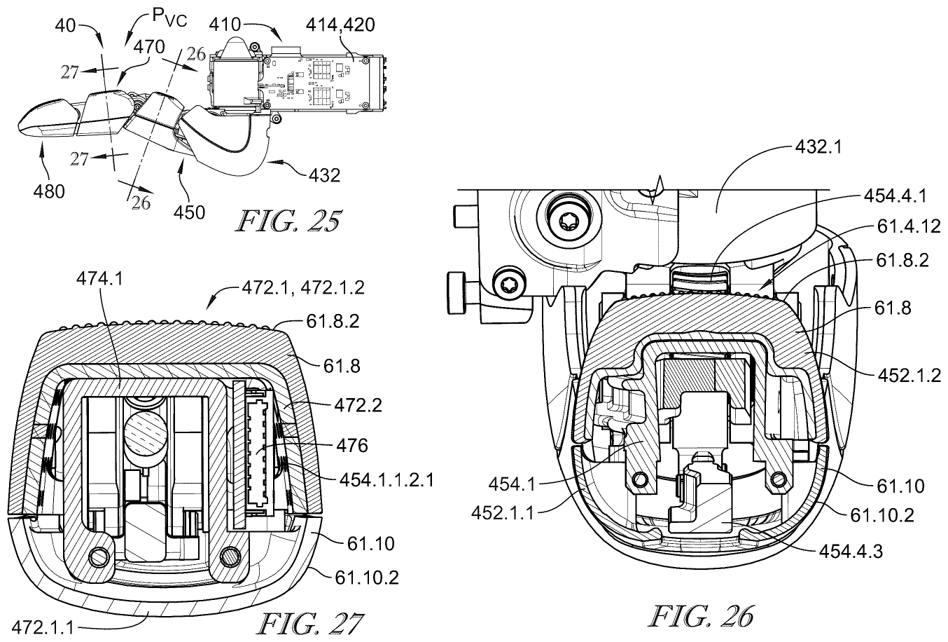

As shown in FIGS. 12-26 and 29, said housing assembly 60 may include multiple components that are made from different materials, may include multiple layers that are made from different materials, and/or may be made from materials that have different rigidities, densities, C/D ratios, durabilities, fabrication methods, and the like. As such, the housing assembly 60 may incorporate a gradient of materials with varying rigidities, densities, and durabilities from the interior to the exterior. In some aspects, the end effector frame 61.2 may be made from a first material with a first rigidity, the exterior top housing 61.8 may be made from a second material with a second rigidity, the interior bottom housing 61.10 may be made from a third material with a third rigidity, and wherein said first rigidity may be greater than the second rigidity, and the second rigidity may be greater than the third rigidity. For example, the end effector frame 61.2 may be made from rigid metal, the exterior top housing 61.8 may be made from rigid plastic, and the interior bottom housing 61.10 may be made from deformable silicon or soft plastic. In another example, the innermost layer could be made of a rigid metal alloy, transitioning to increasingly flexible polymer composites in the middle layers, and ending with a soft, impact-absorbing elastomer on the outermost layer. This gradient structure may provide enhanced protection for internal components while maintaining flexibility and grip on the exterior. It should be understood that these are examples of possible materials and configurations and are not intended to be limiting in any manner. In some cases, the exterior or skin of the end effector 10 may be as rigid as the internal link assemblies of the housing assembly 60, wherein the housing and the internal link assemblies may both be made from a durable and hard plastic. In other embodiments, the exterior or skin of the end effector 10 may be more rigid than the internal link assemblies of the housing assembly 60.

As described above in an alternative embodiment and as shown in FIG. 29, the interior bottom housing 61.10 may include a plurality of layers 61.20, wherein a first interior layer 61.20.2 is made from a first material having a first rigidity and a second exterior layer 61.20.4 is made from a second material having a second rigidity. In this example, the first material may be rigid plastic or metal, while the second material is deformable silicon, soft plastic, or deformable textile or fabric. As such, the thumb assembly 40 is configured to be covered by a textile covering (e.g., glove). In other examples, the plurality of layers 61.20 may have three layers, wherein the first layer 61.20.2 is rigid to provide protection for the internal components, a second layer 61.20.4 is less rigid than the first layer 61.20.2 to enable the end effector 10 to pick up delicate items, and a third layer 61.20.6 is designed to protect the second layer 61.20.4. In this example, the first layer 61.20.2 may be made from durable plastic or metal, the second layer 61.20.4 may be made from deformable thermoplastic, and the third layer 61.20.6 may be made from textile, cloth, or fabric (e.g., glove). In other embodiments, the third layer 61.20.6 may be a thin, replaceable grip layer that is comprised of high-friction materials like silicone or specialized polymers, and could be easily swapped out when worn or for different applications.

In some embodiments, the last or third layer 61.20.6 may be replaceably coupled to the end effector 10 using: magnetic fasteners, hook-and-loop fasteners (e.g., Velcro), interlocking tabs and slots molded into the layer, spring-loaded ball detents that snap into corresponding recesses, dovetail joints allowing the layer to slide on and off, a friction fit when the layer is pressed on, bayonet mounts with tabs that twist and lock into place, clasps or latches, snaps, buttons, removable fasteners, or push-pins. The coupling mechanism may be designed to allow replacement of individual sections or panels of the layer, rather than the entire layer at once. This modular approach may enable replacing only worn or damaged areas. The layer may incorporate alignment features such as pins, notches or asymmetric shapes, or self-aligning connectors or pogo pins to simplify electrical connections between layers. In some aspects, the layer may include embedded RFID tags or QR codes to allow automated verification of proper installation and tracking of replacement history. Some embodiments may use a combination of mechanical and electrical coupling methods to provide both structural attachment and data/power transfer between layers. This replaceable or modular nature is particularly beneficial in industrial or high-use settings where the end effector 10 may be subjected to frequent wear and tear. It allows for quick and cost-effective refurbishment of the end effector's surface without the need to replace the entire housing 61.10. This can be especially useful in adapting the end effector 10 for different tasks or environments by swapping out the outer layer for one with different properties (e.g., higher friction, chemical resistance, or electrostatic discharge protection). For example, the replaceable layers may be designed to be replaced when damaged or at pre-defined intervals (e.g., 1 week, 1 month, 6 months, 1 year, 5 years, or any interval between 1 day and 10 years).

In certain configurations and as discussed below, the plurality of layers 61.20 may have any number of layers, wherein layer 61.20.8 represents layer number four through the nth layer. The concept of extending this layered approach to include additional layers (up to an nth layer) suggests the potential for even more specialized designs. These could incorporate features such as embedded sensors for improved tactile feedback, layers with specific thermal properties for handling temperature-sensitive objects, or layers with electromagnetic shielding for use in sensitive electronic environments. The housing assembly 60 may incorporate smart materials that can change their rigidity or other properties in response to external stimuli. For example, the exterior housing could use shape memory polymers that become more flexible when heated above a certain temperature, allowing for improved adaptability in different operating environments. Alternatively, magnetorheological materials could be used in specific areas to allow for real-time adjustments in rigidity based on applied magnetic fields. The layered structure may include integrated cooling channels or heat-dissipating materials to manage thermal loads during operation. This could involve the use of phase-change materials or microfluidic channels embedded within specific layers to regulate temperature and prevent overheating of sensitive components. However, in other embodiments, the end effector 10 may lack some, if not all, of the above described embedded sensors.

Examples of materials that may be used in the end effector 10 include, but are not limited to, metal (e.g., aluminum, stainless steel, titanium alloys, magnesium alloys, copper alloys, nickel-based alloys), carbon fiber composites, glass fiber composites, basalt fiber composites, Kevlar® composites, polycarbonate, acrylic (PMMA), acrylonitrile butadiene styrene (ABS), nylon, polyoxymethylene (POM), polyether ether ketone (PEEK), polyetherimide (PEI), polyphenylene sulfide (PPS), polytetrafluoroethylene (PTFE), polypropylene (PP), polyethylene (PE), high-density polyethylene (HDPE), thermoplastic polyurethane (TPU), polyamide-imide (PAI), other plastic (e.g., may include a polymer composition), rubber (e.g., nitrile rubber, EPDM), silicone, polyurethane elastomers, ceramic materials (e.g., alumina, zirconia), a combination of these materials, and/or any other suitable material.

The housing assembly 60 and other components of the end effector 10 can be manufactured using a range of advanced fabrication techniques designed to optimize performance, durability, and functionality across various robotic applications. Techniques such as injection molding, additive manufacturing (3D printing), subtractive manufacturing (e.g., CNC machining), overmolding, compression molding, investment casting, powder metallurgy, electroforming, or a combination thereof. These manufacturing techniques enable the integration of advanced internal features that enhance the end effector's overall performance. For instance, internal channels can be incorporated for wiring or cooling purposes, improving thermal management and electrical routing within the housing. Weight reduction can be achieved through optimized internal structures, such as lattices or honeycomb patterns, which maintain structural integrity while minimizing mass. Sensors or electronic components can be embedded directly into the housing during fabrication, eliminating the need for additional assembly steps and improving the end effector's responsiveness. Additionally, self-lubricating surfaces or wear-resistant coatings can be integrated to reduce friction and extend the component's lifespan. Vibration-damping structures or materials can be included to improve stability during operation, particularly in high-precision tasks. The incorporation of living hinges or flexible sections within otherwise rigid components can further enhance the device's adaptability and longevity. Beyond structural enhancements, these manufacturing methods can support the integration of features that improve the end effector's resistance to environmental factors. Internal shielding for electromagnetic interference (EMI) protection can be added to safeguard sensitive electronics, while advanced cooling solutions or heat-dissipating materials can be used to manage temperature fluctuations. The use of smart materials or shape memory alloys can enable adaptive responses to environmental changes, enhancing the end effector's functionality in dynamic settings. Weight reduction, strength, and durability can be further optimized through the use of tailored material properties, such as composites or lightweight metals.

FIG. 6 shows a finger side view of the end effector 10, wherein a surface plane P_{SU} has been added to illustrate contact points between the palm side of the housing assembly 60 and a flat or planar surface. For example, the surface plane P_{SU} may represent the outermost surface formed by a tote designed to carry parts or components of a car. As shown in this Figure, two main contact points may be formed between the surface and the end effector 10, wherein a first contact point P_{C1} may be formed near the tip of the middle finger 22b and a second contact point P_{C2} may be formed near the base of the palm. The greatest distance D_{SU} between said surface plane P_{SU} and the housing assembly 60 formed near the knuckle assembly may be less than 10 mm, and in some cases may be less than 5 mm or even less than 1 mm. As shown in this Figure, having the palm or inner surface of the end effector 10 is slightly concave. In other embodiments, the palm or inner surface of the end effector 10 may be flat or nearly flat. This may help maximize the contact surface area between the end effector 10 and the surface plane P_{SU}. This design may simplify approach angles and reduce the need to perform complex grasping movements with the wrist. In some aspects, the flat or nearly flat palm surface 61.2.2 may allow for more stable and secure grasping of objects. Additionally, this configuration may enable the end effector 10 to more easily slide objects along flat surfaces during manipulation tasks.

As best shown in FIGS. 3-4, 9, and 11, the housing assembly 60 includes a substantially smooth top or back surface 61.2.4 or S_{B} and a rough or non-smooth bottom or palm surface 61.2.2 or S_{P}. The rough or non-smooth palm surface 61.2.2 or S_{P} is created by adding a plurality of contact areas 61.4. In other words, the entire palm surface 61.2.2 or S_{P} is not rough or non-smooth. Said plurality of contact areas 61.4 is designed to increase the end effector's 10 ability to grasp and hold an object. Specifically, the plurality of contact areas 61.4 are comprised of distinct regions 61.4.2-61.4.16 that include multiple bumps or projections 61.6. Said regions 61.4.2-61.4.16 are formed on the palm 62, each assembly (i.e., proximal, medial, and distal) contained within each thumb assembly 40, and each assembly (i.e., proximal 450, medial 470, and distal 480) contained within the thumb assembly 40. For example, the palm 62 may have one large contact region 61.4.2, the proximal assemblies of the fingers 22a-22d may include two contact regions 61.4.4, 61.4.6, the medial assemblies of the fingers 22a-22d may include one contact region 61.4.8, the distal assemblies of the fingers 22a-22d may also include one contact region 61.4.10, the proximal assembly 450 of the thumb 40 may include one contact region 61.4.12; the medial assembly 470 of the thumb 40 may include one contact region 61.4.14, the distal assembly 480 of the thumb 40 may also include one contact region 61.4.16. It should be understood that in other embodiments, the plurality of contact areas 61.4 may be omitted, or the number of regions contained in the plurality of contact areas 61.4 may be increased (e.g., between 18 and 100) or decreased (e.g., between 1 and 16).

In alternative embodiments, the number or density of bumps or projections 61.6 within each region may be increased or decreased. For example, areas that experience more frequent contact during grasping could have a higher density of projections compared to less-used areas. Further, the bumps or projections 61.6 may have different shapes within a single region or area or may be different between regions or areas. For example, said bumps or projections 61.6 could be conical, pyramidal, hemispherical, or have more complex geometries or be arranged in specific patterns, such as concentric circles or spirals, to optimize gripping for particular object shapes or sizes commonly encountered in the robot's intended applications to enhance gripping capabilities. The height of the bumps or projections 61.6 may be 0.01 mm to 2 mm, and preferably between 0.25 mm and 0.75 mm. Also, the height of the projections 61.6 may vary within a single contact region, creating a gradient effect that can adapt to objects of different sizes and textures. Moreover, the contact areas may incorporate: (i) active elements such as micro-pneumatic or micro-hydraulic systems that can dynamically adjust the height or stiffness of the projections based on feedback during grasping, or electroadhesive materials to allow for electrically-controlled adhesion to supplement mechanical gripping.

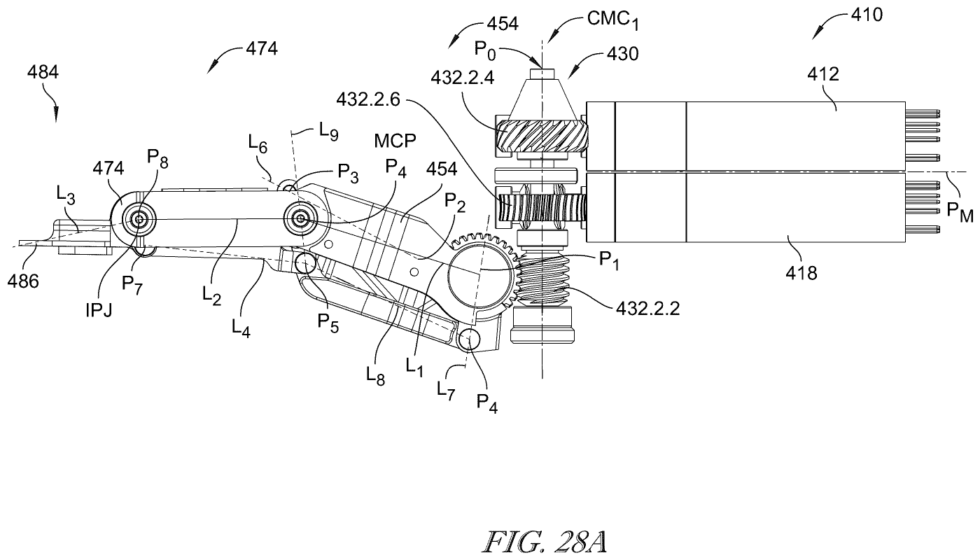

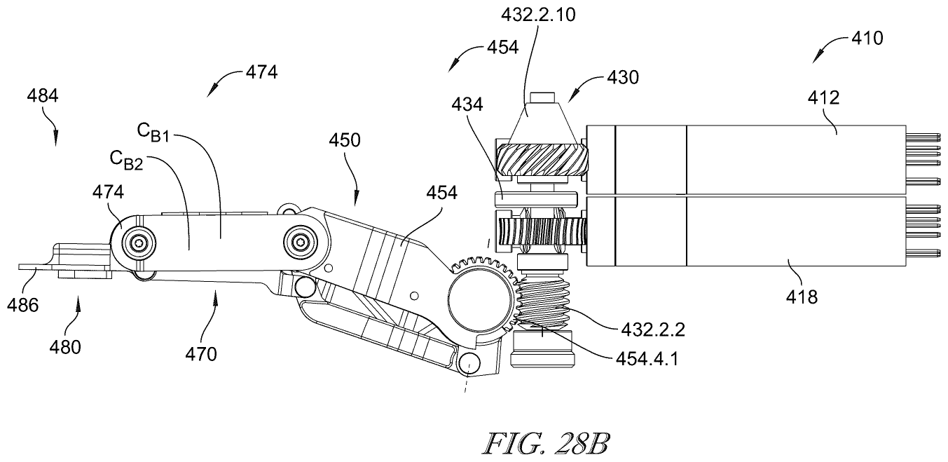

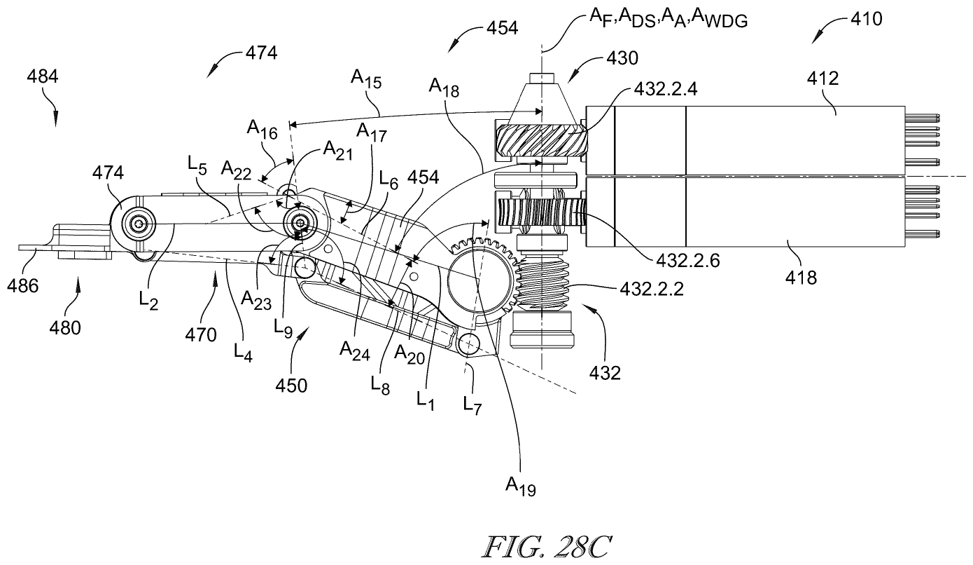

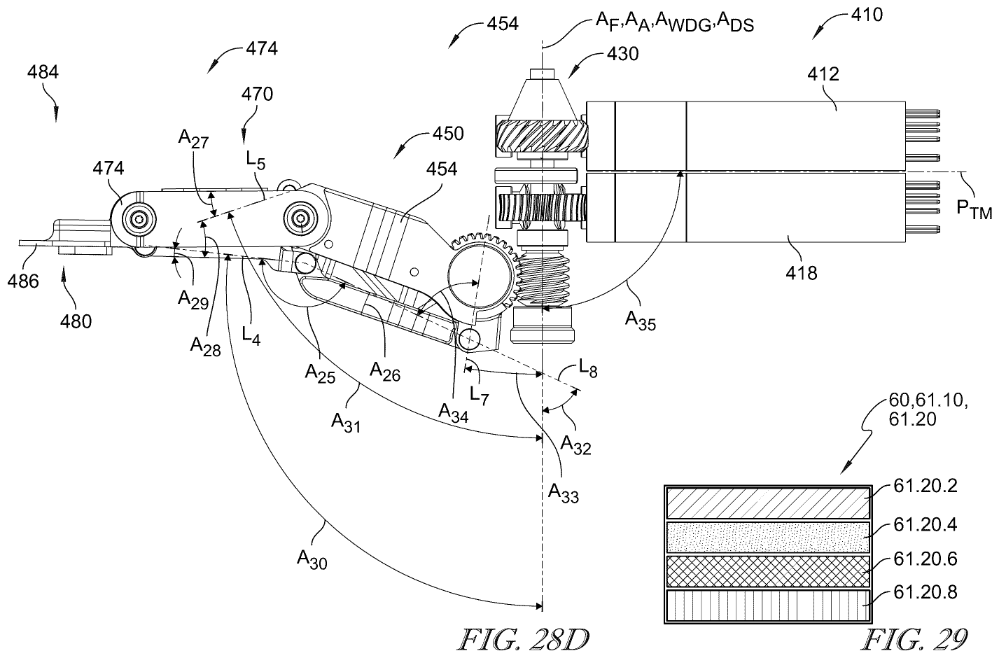

As best shown in FIGS. 27 and 28, the housing assembly 60 of the thumb assembly 40 features a unique cross-sectional shape resembling an obround or discorectangle. This design choice for the outer surfaces 61.8.2, 61.10.2 of the exterior top housing 61.8 and interior bottom housing 61.10 serves dual purposes. The rounded edges minimize the risk of unintended contact with surrounding objects, enhancing the thumb assembly's 40 ability to navigate complex environments. Simultaneously, the substantially flat surfaces optimize the thumb assembly's 40 grasping capabilities by maximizing the contact area with objects. When compared to the finger assemblies 22a-22d, the thumb assembly 40 exhibits distinct characteristics that enhance its functionality. It possesses a larger contact surface with a predominantly flat configuration, interrupted only by strategically placed bumps or projections 61.6. These features contribute to improved grip and tactile sensitivity. Additionally, the thumb assembly's 40 proportions differ from those of the fingers 22a-22d, with its width more closely approximating its height. This results in a more rounded profile for the thumb assembly 40, contrasting with the more elongated, oval shape of the fingers 22a-22d. While alternative configurations could theoretically be implemented by swapping the designs of the thumb assembly 40 and finger assemblies 22a-22d, such modifications could compromise the thumb assembly's 40 effectiveness. The current design maximizes the thumb assembly's contact surface area, which is helpful for its role in grasping and manipulating objects. Reducing this surface area by adopting a more finger-like configuration may diminish the thumb assembly's 40 utility in performing precise and powerful grips.

With reference, for example, to FIGS. 1A-13, the end effector 10 comprises a thumb assembly 40. The thumb assembly 40 is removably connected to the palm surface 61.2.2 of the end effector frame 61.2 using elongated fasteners and is replaceable (and in some embodiments, it may be hot-swappable with a replacement thumb assembly 40). The replaceable aspect of the thumb assembly 40 eliminates the need for various structural elements, such as synthetic tendons, mechanical or articulation cables, pulleys, pneumatic or hydraulic cables, and other components that extend from the lower arm or wrist to the medial 470 or distal 480 sections of the thumb assembly 40. This configuration ensures that at least a majority, if not all, of the components such as linkages, motors, PCBs, encoders, and other elements required to actuate the thumb assembly 40 are self-contained within the palm region 62 and/or the thumb assembly 40 and are not spread throughout the robot system. This setup is advantageous as it enhances serviceability, consequently reducing the overall cost of ownership and usage.

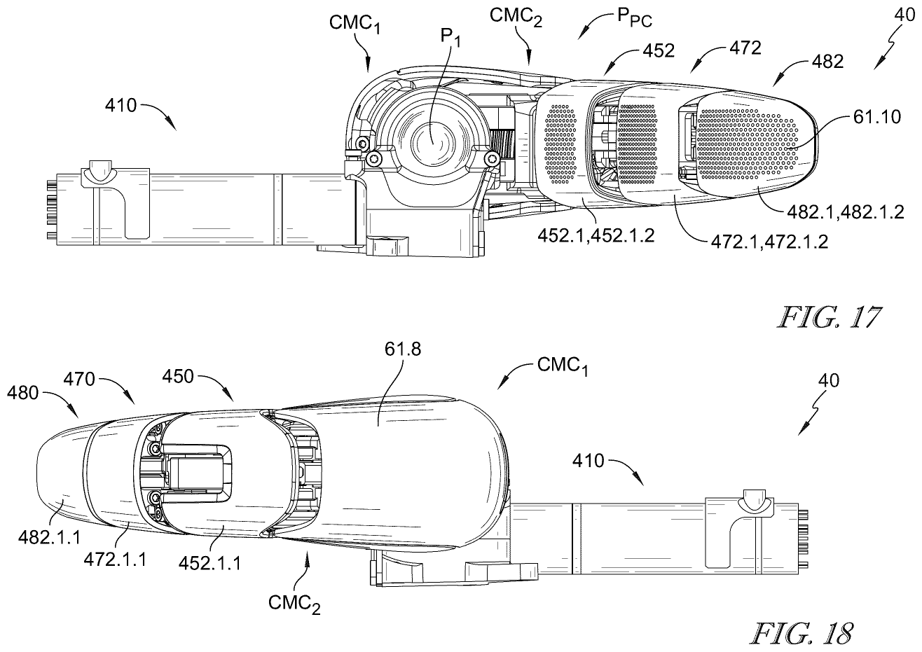

As shown in FIGS. 12 and 18, the thumb motor plane P_{TM} is offset by an angle gamma γ from line L₁, wherein: (i) line L₁ is perpendicular to the sagittal plane P_{S} or the middle finger plane P_{22b} and intersects with the center point of the knuckle assembly of the middle finger 22b, and (ii) the angle gamma γ is usually at least 1 degree, preferably between 2 degrees and 12 degrees, and most preferably between 4 degrees and 6 degrees, and likely less than 16 degrees. In light of this configuration, the first and second motor shaft axes A_{MS1}, A_{MS2} are also offset by an angle gamma γ from line L₁, wherein: (i) line L₁ is perpendicular to the sagittal plane P_{S} or the middle finger plane P_{22b} and intersects with the center point of the knuckle assembly of the middle finger 22b, and (ii) the angle gamma y is usually at least 1 degree, preferably between 2 degrees and 12 degrees, and most preferably between 4 degrees and 6 degrees, and likely less than 16 degrees. Thus, the first and second motor shaft axes A_{MS1}, A_{MS2} are non-parallel with the sagittal plane P_{S}; thus, the first motor shaft axes A_{MS1} is oriented at a first acute angle relative to the sagittal plane P_{S}, and the second motor shaft axes A_{MS2} is oriented at a second acute angle relative to the sagittal plane P_{S}, and wherein the first acute angle is approximately equal to the second acute angle.

With reference, for example, to FIGS. 1A, 3, 4, 9, 11, the end effector 10 comprises four finger assemblies 22a-22d that are removably connected to the back surface 61.2.4 of the end effector frame 61.2 using elongated fasteners and are configured to operate independent of one another. As shown in the figures, each finger assembly 22a-22d of the plurality of finger assemblies 22a-22d includes a single finger motor assembly 210 and a metacarpophalangeal joint MCP, a proximal finger interphalangeal joint PIP, and a distal finger interphalangeal joint DIP. Additionally, each finger assembly 22a-22d includes a proximal assembly 250, a medial assembly 270, and a distal assembly 280. In some embodiments, the end effector 10 may include more or fewer than four finger assemblies. The finger assemblies 22a-22d may be configured identically, which may allow for reducing the number of distinct components used to manufacture the finger assemblies 22a-22d, and may enhance modularity, potentially reducing expense. The modular nature of the finger assemblies 22a-22d may enable them to be easily replaceable and may enable hot-swapping of the finger assemblies in some cases. The modular and replaceable aspect of the finger assemblies 22a-22d may eliminate the use of various structural elements, such as synthetic tendons or articulation cables, pulleys, pneumatic or hydraulic cables, and other components that extend from the lower arm or wrist to the medial or distal sections of the finger assemblies 20. This configuration may allow components such as linkages, motors, PCBs, encoders, and other elements used to actuate each finger assembly 22a-22d to be self-contained within the palm 62 and/or within each finger assembly 22a-22d and not spread throughout the robot system. This setup may enhance serviceability, potentially reducing the overall cost of ownership and usage.

In other embodiments, it should be understood that finger assemblies 22a-22d may not be identical. Instead, there may be two pairs of finger assemblies, wherein the finger assemblies contained in said pairs of finger assemblies are identical. In other words, there may be two unique types of finger assemblies contained in said end effector 10, wherein there are two finger assemblies of a first type and two finger assemblies of a second type. For example, the pointer finger 22a and the small finger 22d may be the first type, while the middle finger 22b and the ring finger 22c may be the second type (while the middle and ring 22b, 22c are different from the pointer and small 22a, 22d). In another example, the pointer finger 22a and the middle finger 22b may be the first type, while the ring finger 22c and the small finger 22d may be the second type (while the ring and small 22c, 22d are different from the pointer and middle 22a, 22b). In an additional embodiment, there may be two unique types of finger assemblies contained in said end effector 10, wherein there are three finger assemblies of a first type and one finger assembly of a second type. For example, the pointer, middle, and ring fingers 22a-22c may be of the first type and the small finger 22d may be of the second type. In another embodiment, there may be three unique types of finger assemblies contained in said end effector 10, wherein there are two finger assemblies of a first type, one finger assembly of a second type, and one finger assembly of a third type. For example, the middle and ring fingers 22b, 22c may be the first type, the pointer finger 22a may be of the second type to allow for abduction, and the small finger may be of the third type 22d due to its size. In a further embodiment, all finger assemblies 22a-22d may be unique. Finally, it should be understood that other combinations of finger assembly types are contemplated by this application, and the above examples are not intended to be limiting.

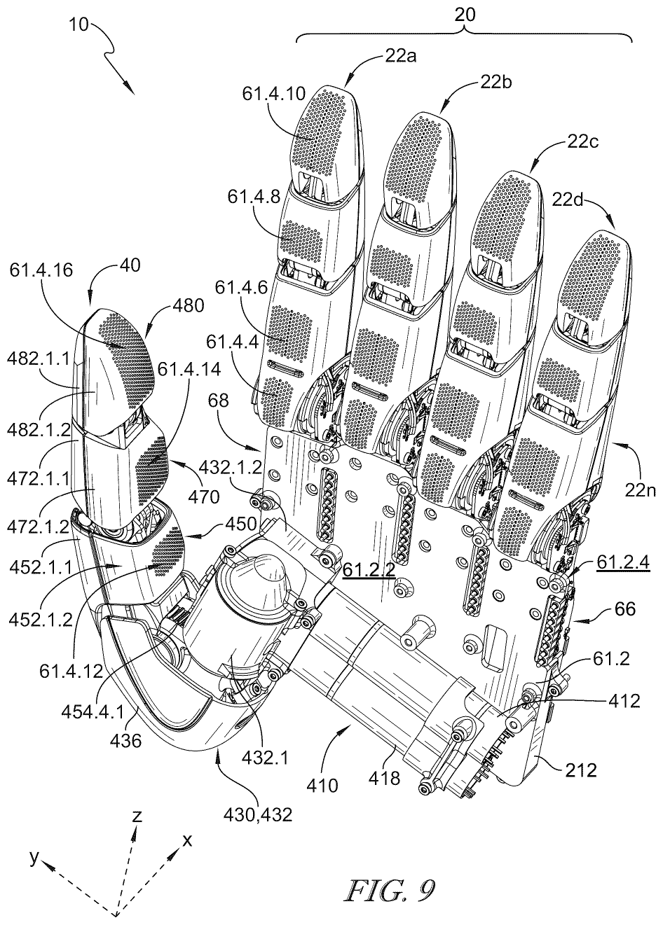

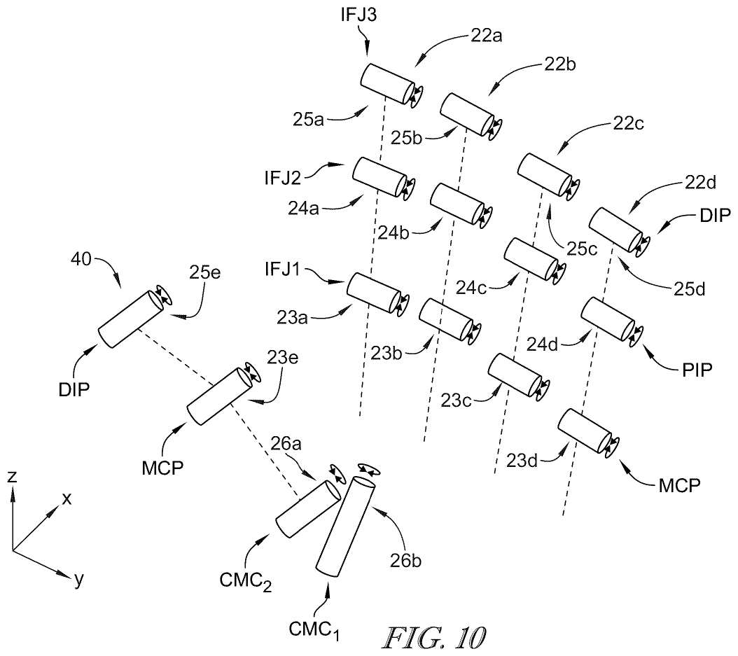

With reference, for example, to FIGS. 9-10, each finger assembly 22a-22d may be connected to the back surface 61.2.4 of the end effector frame 61.2. Thus, the overall location of the finger assemblies 22a-22d cannot move in the Y-Z plane relative to the frame 61.2. Also, the finger assemblies 22a-22d may be connected to the end effector frame 61.2 in a manner that ensures that their tips are not aligned with one another. In other words, each finger assembly 22a-22d is: (i) angularly offset and horizontally offset to at least one other finger assembly 22a-22d in the X-Y plane, and (ii) vertically offset to at least one other finger assembly 22a-22d in the X-Z plane. This configuration of finger assemblies 22a-22d enables each finger assembly 22n of the four finger assemblies 22a-22d to be angularly offset along the X-Y plane and within the Y-Z plane with respect to every other finger assembly 22n of the four finger assemblies 22a-22d. The fixed position of the finger assemblies 22a-22d may reduce the complexities of building, using, maintaining, and repairing the end effector 10.

As shown in FIG. 12, the middle or third finger assembly 22b is positioned such that its sagittal plane P_{S} is oriented vertically on the page. Based on the position of the middle or third finger assembly 22b, it can be seen that the center (i.e., C₂₂ₐ, C_{22c}, C_{22d}) of a knuckle assembly 230 of each of the pointer, ring, and small fingers 22a, 22c, and 22d are positioned: (i) slightly rearward from the line L₁ and the center C_{22b} of the knuckle assembly 230 of the middle finger 22b (see FIG. 12), and (ii) are angled relative to the center C22b of the knuckle assembly 230 of the middle finger 22b (see FIG. 10). This configuration also causes the fasteners (e.g., 61.30a-61.30d, if these are the fasteners) that removably connect the finger assemblies 22a-22d at respective points to the end effector frame 61.2 to be not co-linear. At best, two of the respective connection points may be co-linear, but all four points are not co-linear. However, all four respective connection points are aligned in the same Y-Z plane.

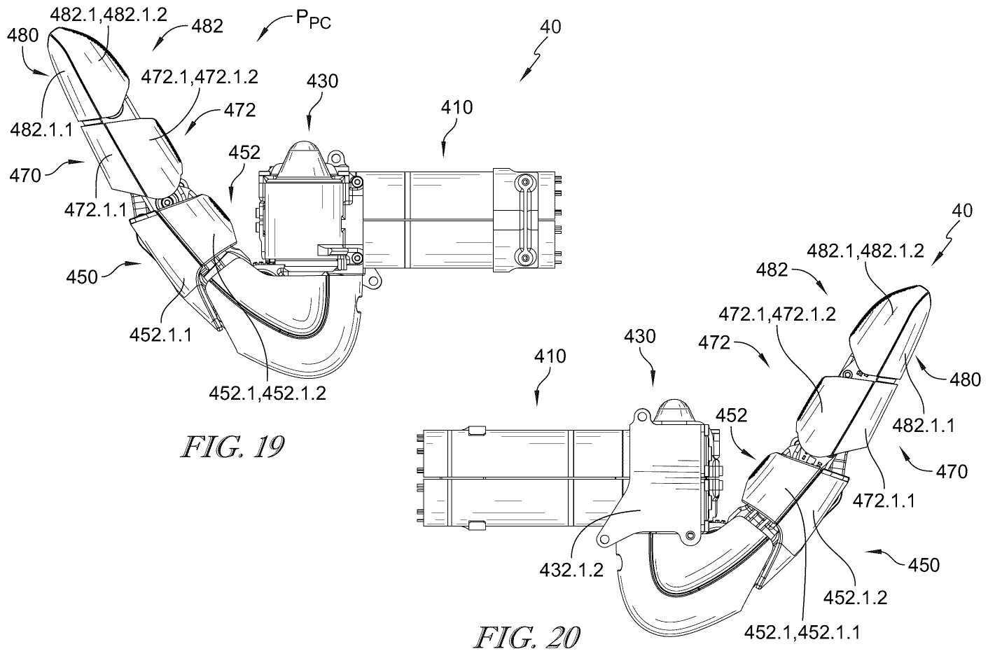

Exemplary positional relationships between components of a thumb assembly 40 shown in FIG. 20 are listed in Table 1. It should be understood that the dimensions, angles, ratios, and other values that can be derived therefrom that are disclosed in the figures and Tables 1-3 are important to ensure that the end effector 10 can move, grasp objects, and be used in the desired robot system. As such, the structures, features, dimensions, angles, ratios, and other values that can be derived therefrom of non-end effectors for robots and non-linkage based end effectors cannot be simply adopted or implemented into an end effector 10 without careful analysis and verification of the complex realities of designing, testing, manufacturing, training, and using the robot system with an end effector 10. Theoretical designs that attempt to implement such modifications from non-end effectors for robots and non-linkage based end effectors are insufficient (and in some instances, woefully insufficient) because they amount to mere design exercises that are not tethered to the complex realities of successfully designing, testing, manufacturing, training, and using the robot system with an end effector 10.

### C. Thumb Assembly

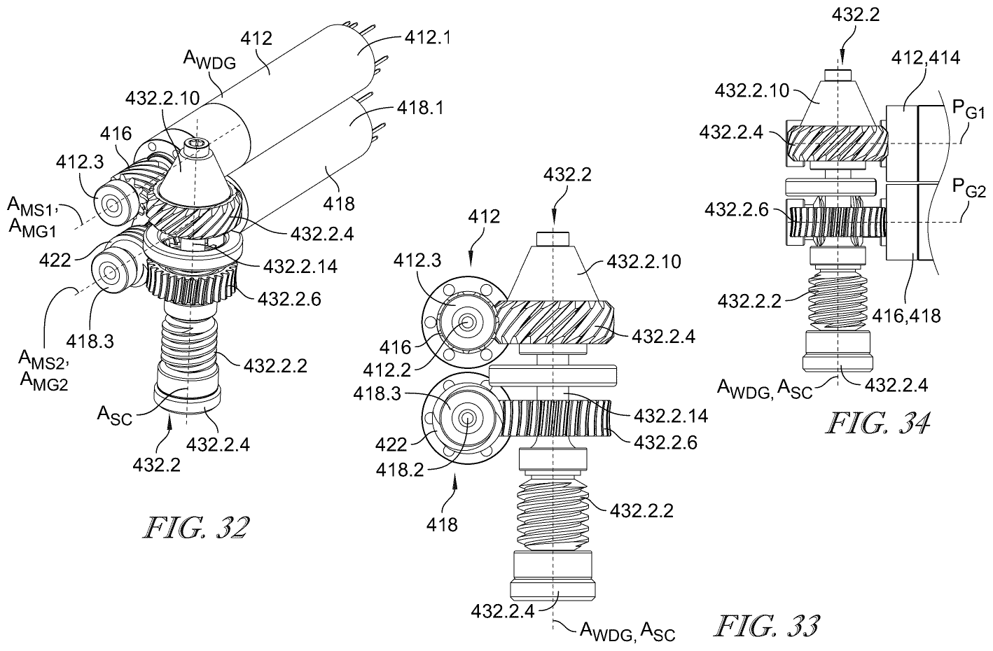

With reference, for example, to FIGS. 3-33, the thumb assembly 40 of the end effector 10 is comprised of: (i) a motor assembly 410, (ii) a base joint assembly 430, (iii) a proximal assembly 450, (iv) a medial assembly 470, and (v) a distal assembly 480. Each of the base joint assembly 430, the proximal assembly 450, the medial assembly 470, and the distal assembly 480 includes internal linkages (in combination, an internal linkage assembly) that can operate together to move the thumb assembly 40. Each of these assemblies will be discussed in great detail below; however, additional information about said assemblies may be contained within U.S. Provisional Patent Applications Nos. 63/614,499, 63/617,762, 63/561,315, 63/573,226, 63/615,766, 63/620,633, all of which are incorporated herein by reference for any purpose.

a. Motor Assembly

As illustrated in FIGS. 9, 10, 12, and 25, the motor assembly 410 is designed to be releasably coupled to the palm surface 61.2.2 of the housing end effector frame 61.2. This modular design allows for case of maintenance, replacement, and customization of the motor assembly 410 based on specific application requirements. The motor assembly 410 comprises the following components: (i) a first motor 412, (ii) a first controller 414, (iii) a first motor gear 416, (iv) a second motor 418, (v) a second controller 420, and (vi) a second motor gear 422. The first motor 412 and the second motor 418 are responsible for driving various degrees of freedom within the end effector 10, enabling precise and dynamic control of the robotic hand's movements. These motors can be selected from a variety of types, including but not limited to: slotless brushless direct current (BLDC) motors, brushed DC motors, stepper motors, switched reluctance motors, permanent magnet synchronous motors, and servo motors. Each type of motor offers distinct advantages based on application needs, such as high torque output, precise positioning, or energy efficiency. It should be noted that the first motor 412 and the second motor 418 may either be identical in type and specifications or differ based on the specific functional requirements of the end effector 10. In an example where the motors are different, the first motor 412 controlling flexion/extension could be a high-torque brushless DC motor, while the second motor 418 for abduction/adduction could be a stepper motor for precise positioning. Variations between the motors can include, but are not limited to, different torque outputs, transmission ratios, gear types, end stop configurations, or other operational characteristics. This flexibility allows for a highly customizable motor assembly 410 capable of accommodating a wide range of tasks and environments. The inclusion of first and second controllers, 414 and 420 respectively, ensures that the motors can be individually managed and optimized for performance. These controllers are configured to handle motor feedback, control signals, and power distribution, thereby enhancing the overall responsiveness and efficiency of the motor assembly 410. Furthermore, the integration of the motor gears 416 and 422 allows for appropriate torque conversion and mechanical advantage, ensuring that the end effector 10 operates smoothly and with the necessary precision.

As illustrated in FIGS. 9-18 and 28A-31B, the motor assembly 410 for the thumb assembly 40 is specifically designed to include only two motors, namely the first motor 412 and the second motor 418. By restricting the number of motors to two, the end effector 10 adopts an underactuated configuration. In practical terms, this means that the thumb assembly 40 comprises four joints or degrees of freedom (DoF), with each of these four joints being controlled by only two motors. Breaking down the motor functionality further, the first motor 412 is responsible for controlling three degrees of freedom associated with flexion and extension of the thumb assembly 40. Meanwhile, the second motor 418 is dedicated to managing one degree of freedom associated with abduction and adduction of the thumb assembly 40. The decision to limit the thumb assembly 40 to two motors yields multiple advantages. Firstly, it simplifies the overall manufacturing process by reducing the number of components required, which in turn leads to fewer assembly steps and reduced production time. Secondly, the reduced motor count increases the durability of the end effector 10 by minimizing potential failure points, thereby enhancing the reliability of the thumb assembly 40 in various operational environments. Thirdly, this design approach enables the thumb assembly 40 to be modular, allowing for easier replacements, upgrades, or reconfigurations without the need for extensive redesigns. Lastly, the reduction in the number of motors significantly decreases both the cost and complexity of the control systems required to operate the thumb assembly 40, making the end effector 10 more cost-effective and efficient for a wide range of applications. By optimizing the control of four joints with just two motors, the design achieves a robust yet simplified solution that meets the performance requirements of advanced robotic systems while minimizing unnecessary complexity.

The motor assembly 410 is an integral component of the thumb assembly 40 and is positioned directly within the hand structure of the robotic system, rather than being remotely located in another part of the robot. This design choice has several important implications for the overall functionality and performance of the thumb assembly 40. While it may impose certain constraints on the size and dimensions of the robotic hand, particularly in terms of how compact the hand can be, it offers numerous advantages that enhance the utility and effectiveness of the end effector 10. By incorporating the motor assembly 410 within the thumb assembly 40, the need for extensive linkage mechanisms is significantly reduced. This simplification leads to fewer mechanical parts, which not only minimizes potential points of failure but also streamlines the manufacturing process and reduces maintenance requirements. The reduction in linkages also increases the modularity of the thumb assembly 40, making it easier to swap out or upgrade individual components without requiring extensive modifications to the overall system. This modular design enhances the versatility of the thumb assembly 40, allowing for greater adaptability across various tasks and environments. Additionally, with fewer external linkages and a more self-contained structure, the thumb assembly 40 can operate more effectively in confined spaces and interact more directly with objects in its surroundings. The integration of the motor assembly 410 within the thumb assembly 40 also contributes to the overall reliability of the system by reducing the number of external components and connections, the likelihood of mechanical failures or misalignments is minimized.

This reliability is further enhanced by the inclusion of the first controller 414, which is specifically designed to manage the movements of the thumb assembly 40. The first controller 414 is equipped with electronic controls that can be programmed to limit the rotation and movement of the thumb assembly 40, ensuring that it operates within predefined parameters to avoid overextension or damage. The first controller 414 may also incorporate advanced feedback mechanisms, such as position sensors or torque sensors, to provide real-time data on the thumb's movements. This data can be used to optimize the thumb's performance, enabling precise and adaptive control based on the task at hand. Furthermore, the controller 414 can be configured to implement safety protocols, such as emergency stop functions or collision detection, to prevent accidental damage to the robot or its surroundings.

i. First Motor

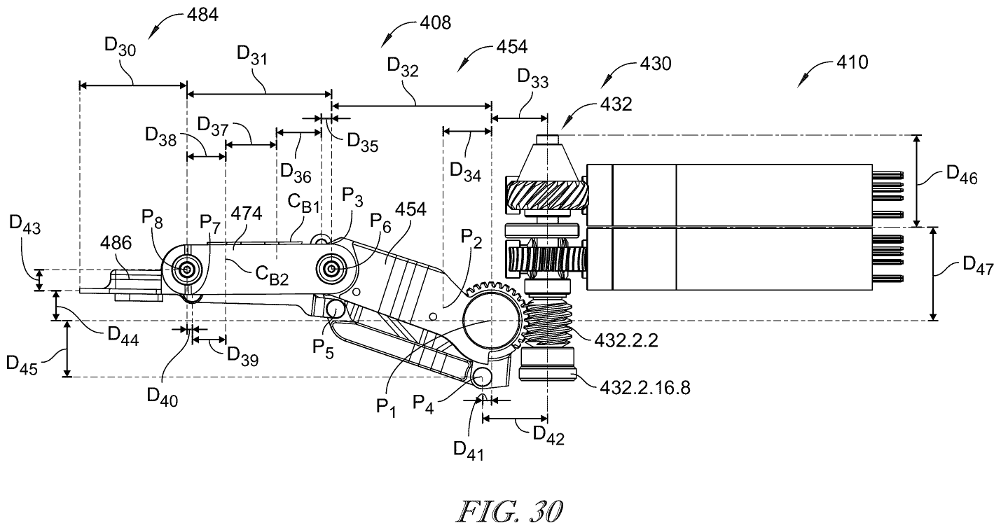

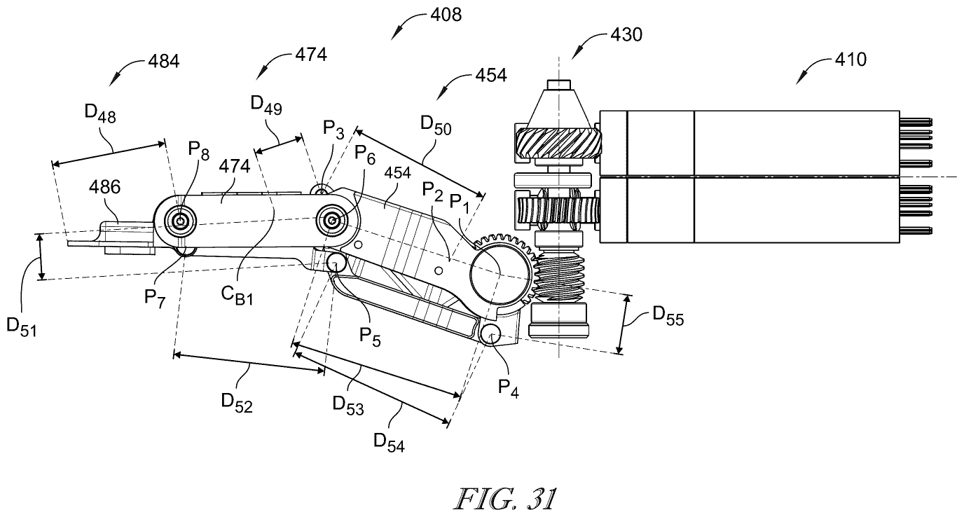

As shown in FIGS. 30-31B, the first motor 412 includes: (i) internal components (not shown), (ii) a digit or first motor housing 412.1, (iii) a digit or first motor shaft 412.2, and (iv) a motor gear bearing 412.3. The internal components of the first motor 412 are designed to rotate the first motor shaft 412.2 about a first motor shaft axis A_{MS1}. To help ensure that the first motor shaft 412.2 rotates about the first motor shaft axis A_{MS1} at the desired speed, the internal components of the first motor 412 may include a transmission, gear reduction, or other components. Said transmission, gear reduction, or other component may include: a planetary gear system, a strain wave gear (e.g., harmonic drive), a cycloidal drive, a clutch mechanism, and/or an electromagnetic brake. In addition to altering the speed of the first motor shaft 412.2, the transmission, gear reduction, or other component may prevent the first motor shaft 412.2 from making full revolutions (i.e., 360 degrees) around the first motor shaft axis A_{MS1}. This may be accomplished using mechanical hard stops that could be integrated into the gearbox. In some cases, it may be beneficial to physically limit the rotational movement of the first motor shaft 412.2 (as opposed to electronically limiting said rotation using programming or control methodologies) because it helps ensure that the thumb assembly 40 cannot be over-rotated. However, in other embodiments, the transmission, gear reduction, or other component may not prevent the first motor shaft 412.2 from making full revolutions (i.e., 360 degrees) around the first motor shaft axis A_{MS1}. In this embodiment, electronically limiting said rotation using programming or control methodologies may be used to help ensure that the thumb assembly 40 is not over-rotated. Alternatively, it may be desirable to allow the first motor shaft 412.2 to make full revolutions (i.e., 360 degrees) based on the gearing ratio.

The first motor gear 416 extends past a frontal portion of the first motor housing 412.1 and: (i) includes an extent that is designed to receive the first motor shaft 412.2 to enable said first motor gear 416 to be coupled to the first motor shaft 412.2, and (ii) has helical or screw-like threads. Coupling said first motor gear 416 to the first motor shaft 412.2 enables the internal components of the first motor 412 to rotate the first motor shaft 412.2 around the first motor shaft axis A_{MS1}, wherein said rotation of the first motor shaft 412.2 around the first motor shaft axis A_{MS1} causes the first motor gear 416 to rotate about a first motor gear axis A_{MSG1}. The first motor shaft axis A_{MS1} and the first motor gear axis A_{MSG1} may be parallel, aligned, and coaxial. This coaxial arrangement may be achieved through precise machining and alignment of the motor shaft 412.2 and motor gear 416 during assembly. The motor housing 412.1 may include precision-machined bearing surfaces to support the motor shaft 412.2 and maintain its alignment. Additionally, the motor gear 416 may be manufactured with a precision-bored central opening that closely matches the diameter of the motor shaft 412.2, allowing for a tight, coaxial fit when assembled. In some aspects, additional alignment features such as keyways or splines may be incorporated on the shaft 412.2 and gear 416 to ensure proper rotational alignment. The use of high-precision bearings at the interface between the motor shaft 412.2 and housing 412.1 may further contribute to maintaining the coaxial relationship between the shaft and gear axes. This configuration may also cause the first motor shaft axis A_{MS1} and the first motor gear axis A_{MSG1} to be parallel with (and potentially, coaxial with) the thumb motor plane P_{TM}. In some cases, the first motor shaft axis A_{MS1}, the first motor gear axis A_{MSG1}, and thumb motor plane P_{TM} may not be parallel, aligned, and/or coaxial. Instead, the first motor shaft axis A_{MS1} and the first motor gear axis A_{MSG1} may be perpendicular to one another, while the thumb motor plane P_{TM} may be parallel with the first motor shaft axis A_{MS1}.

As described above, the motor assembly 410 also includes a first motor gear bearing 412.3 that is designed to support the distal, rotating end of the first motor gear 416. In alternative embodiments, the first motor gear bearing 412.3 may be omitted or integrally formed with the first motor gear 416. It may also be understood that in alternative embodiments, the first motor shaft 412.2 and the first motor gear 416 may be integrally formed and/or sealed. As shown in FIGS. 30-31B and discussed below, the first motor gear 416 is designed to be in geared engagement with an extent of the base joint assembly 430, wherein this geared engagement enables the rotation of the first motor gear 416 to cause the thumb assembly 40 to move or curl.

ii. Second Motor

As shown in FIGS. 30-31B, the second motor 418 includes: (i) internal components (not shown), (ii) a second or digit motor housing 418.1, (iii) a second or digit motor shaft 418.2, and (iv) a motor gear bearing 418.3. The internal components of the second motor 418 are designed to rotate the second motor shaft 418.2 about a second motor shaft axis A_{MS2}. To help ensure that the second motor shaft 418.2 rotates about the second motor shaft axis A_{MS2} at the desired speed, the internal components of the second motor 418 may include a transmission, gear reduction, or other components. This transmission, gear reduction, or other component may include: a planetary gear system, a strain wave gear (e.g., harmonic drive), a cycloidal drive, a clutch mechanism, and/or an electromagnetic brake. In addition to altering the speed of the second motor shaft 418.2, the transmission, gear reduction, or other component may prevent the second motor shaft 418.2 from making full revolutions (i.e., 360 degrees) around the second motor shaft axis A_{MS2}. This may be accomplished using mechanical hard stops that could be integrated into the gearbox. In some cases, it may be beneficial to physically limit the rotational movement of the second motor shaft 418.2 (as opposed to electronically limiting said rotation using programming or control methodologies) because it helps ensure that the thumb assembly 40 cannot be over-rotated. However, in other embodiments, the transmission, gear reduction, or other component may not prevent the second motor shaft 418.2 from making full revolutions (i.e., 360 degrees) around the second motor shaft axis A_{MS2}. In this embodiment, electronically limiting said rotation using programming or control methodologies may be used to help ensure that the thumb assembly 40 is not over-rotated. Alternatively, it may be desirable to allow the second motor shaft 418.2 to make full revolutions (i.e., 360 degrees) based on the gearing ratio.

As shown in the FIGS. 30-31B, the second motor gear 422 extends past a frontal portion of the second motor housing 418.1 and: (i) includes an extent that is designed to receive the second motor shaft 418.2 to enable said second motor gear 422 to be coupled to the second motor shaft 418.2, and (ii) has helical or screw-like threads. Coupling said second motor gear 422 to the second motor shaft 418.2 enables the internal components of the second motor 418 to rotate the second motor shaft 418.2 around the second motor shaft axis A_{MS2}, wherein said rotation of the second motor shaft 418.2 around the second motor shaft axis A_{MS2} causes the second motor gear 422 to rotate about a second motor gear axis A_{MSG2}. The second motor shaft axis A_{MS2} and the second motor gear axis A_{MSG2} may be parallel, aligned, and coaxial. This coaxial arrangement may be achieved through precise machining and alignment of the motor shaft 418.2 and motor gear 422 during assembly. The motor housing 418.1 may include precision-machined bearing surfaces to support the motor shaft 418.2 and maintain its alignment. Additionally, the motor gear 422 may be manufactured with a precision-bored central opening that closely matches the diameter of the motor shaft 418.2, allowing for a tight, coaxial fit when assembled. In some aspects, additional alignment features such as keyways or splines may be incorporated on the shaft 418.2 and gear 422 to ensure proper rotational alignment. The use of high-precision bearings at the interface between the motor shaft 418.2 and housing 418.1 may further contribute to maintaining the coaxial relationship between the shaft and gear axes. This configuration also causes the second motor shaft axis A_{MS2} and the second motor gear axis A_{MSG2} to be parallel with (and potentially, coaxial with) the thumb motor plane P_{TM}. In some cases, the second motor shaft axis A_{MS2}, the second motor gear axis A_{MSG2}, and thumb motor plane P_{TM} may not be parallel, aligned, and coaxial. Instead, the second motor shaft axis A_{MS2} and the second motor gear axis A_{MSG2} may be perpendicular to one another, while the finger motor plane P_{FM} may be parallel with the second motor shaft axis A_{MS2}.

Also, as shown in FIGS. 30-31B, the first motor shaft axis A_{MS1} is parallel, aligned, and positioned within the first motor gear plane P_{G1}, while the second motor shaft axis A_{MS2} is parallel, aligned, and positioned within the second motor gear plane P_{G2}. The first motor shaft axis A_{MS1} is parallel with the second motor shaft axis A_{MS2}, which causes the first motor gear plane P_{G1} to be parallel with the second motor gear plane P_{G2}. Likewise, the first motor gear axis A_{MSG1} is parallel, aligned, and positioned within the first motor gear plane P_{G1}, while the second motor gear axis A_{MSG2} is parallel, aligned, and positioned within the second motor gear plane P_{G2}. Also, the first motor shaft axis A_{MS1} and the first motor gear axis A_{MSG1} are vertically aligned in a plane that is parallel with the Y-Z plane.

As described above, the motor assembly 410 also includes a second motor gear bearing 418.3 that is designed to support the distal, rotating end of the second motor gear 422. In alternative embodiments, the second motor gear bearing 418.3 may be omitted or integrally formed with the second motor gear 422. It may also be understood that in alternative embodiments, the second motor shaft 418.2 and the second motor gear 422 may be integrally formed and/or sealed. As shown in FIGS. 30-31B and discussed below, the second motor gear 422 is designed to be in geared engagement with an extent of the base joint assembly 430, wherein said geared engagement causes the thumb assembly 40 to move or rotate towards or away from the palm 62.

b. Base Joint Assembly

The base joint assembly 430 is positioned forward of a majority of the motor assembly 410 and is configured to allow the thumb assembly 40 to move from: (i) the open, uncurled, or neutral position to the curled position, and (ii) the open, unrotated, or neutral position to the rotated position. In said curled and rotated position, an acute interior angle is formed between: (i) the right side 68 and an interior surface of the thumb assembly 40, and (ii) the palm 62 and an interior surface of the thumb assembly 40. The base joint assembly 430 is best shown in FIGS. 20-24, 28A-28D, 30, and 31A-31B and includes: (i) a carpometacarpal joint assembly 432, (ii) carpometacarpal electronics 434, and (iii) a carpometacarpal or base joint housing 436.

i. Carpometacarpal Joint Assembly

The carpometacarpal joint assembly 432 includes: (i) a frame 432.1, and (ii) a thumb drive assembly 432.2, and wherein said carpometacarpal joint assembly 432 includes a first or vertical carpometacarpal joint assembly CMC₁. The frame 432.1 and the thumb drive assembly 432.2 are complex and important components of the thumb assembly 40, whereby said assemblies 432.1, 432.2 translate the movement of the motor assembly 410 to movements of the base joint assembly 430 and the digit assembly 408. It should be understood that other assemblies, components, sub-components, and/or parts may be added, removed, combined into a fewer number of parts, or separated into additional parts. While some of the positional relationships are set forth below, it should be understood that additional relationships may be derived from the figures (as these assemblies, components, sub-components, and/or parts are shown as proportional to one another).

### 1. Thumb Frame

The thumb frame 432.1 includes two major components, wherein the first component is an upper frame member 432.1.2 and a second component is a lower frame member 432.1.4. The upper frame member 432.1.2 is affixed to the end effector frame 61.2 and does not rotate, or move relative to the end effector frame 61.2. The structure and affixed relationship of the upper frame member 432.1.2 and the end effector frame 61.2 enables said upper frame member 432.1.2 to secure the remaining components of the thumb assembly 40 within the end effector 10. As such, the upper frame member 432.1.2 is made from a material with sufficient rigidity. Stated another way, the thumb frame 432.1 may be made from any material disclosed herein or known in the art that can achieve the desired task of supporting and securing components of the thumb assembly 40 to the frame 61.2, including the same material as the frame 61.2. In other embodiments, the thumb frame 432.1 may be integrally formed with other components (e.g., palm housing 60.1) and as such be made from the same material as the other component.

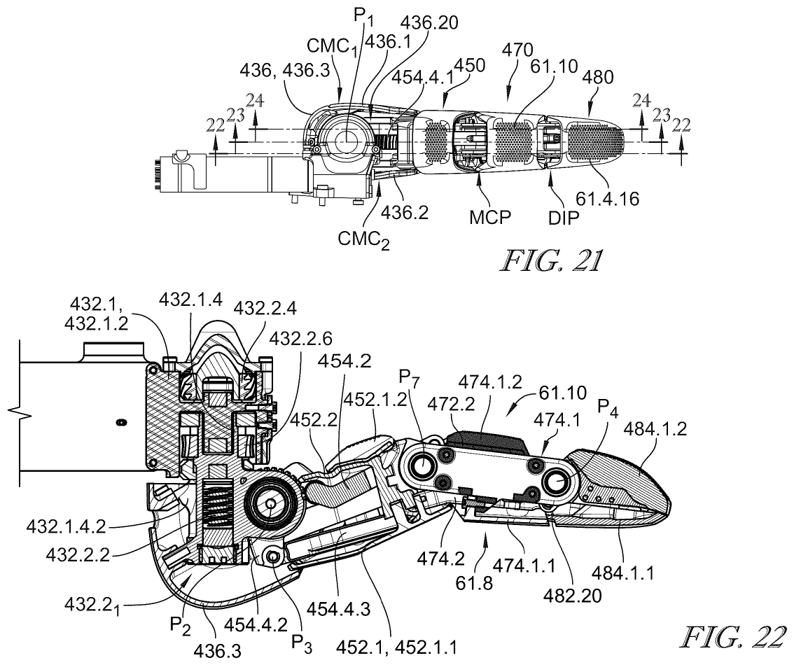

As shown in FIG. 21, the upper frame member 432.1.2 includes an upper opening 432.1.10 and a lower opening 432.1.12. These openings allow for the insertion of the lower frame member 432.1.4 and the thumb drive assembly 432.2. Additionally and as shown in the Figures, the upper frame member 432.1.2 is not a simple tube or cylinder, but instead includes internal walls that are configured to support and allow the lower frame member 432.1.4 and the thumb drive assembly 432.2 to rotate within said upper frame member 432.1.2. It should be understood that the configuration and design of these internal walls may be changed or altered to accompany and/or support the lower frame member 432.1.4 and other components of the thumb assembly 40.

The lower frame member 432.1.4 has a complex geometry that includes a first or upper portion 432.1.4.1 that is positioned above line L_{F} and a lower portion 432.1.4.2 that is positioned below line L_{F}, wherein line L_{F} is co-linear with a lower surface of the upper frame member 432.1.2. This complex geometry of the lower frame member 432.1.4: (i) allows it to interact with the carpometacarpal electronics 434, (ii) includes the upper portion 432.1.4.1 to rotate within the internal walls of the upper frame member 432.1.2, (iii) provides for carpometacarpal or base joint housing coupling points 432.1.4.6, (iv) has a proximal link aperture 432.1.4.3 formed therein to allow for an interaction between a worm drive gear 432.2.2 and the worm wheel 454.4.1, and (v) is designed to receive a bearing 432.2.16.8. While one embodiment of said lower frame member 432.1.4 is shown in the Figures, it should be understood that other embodiments are contemplated by this disclosure.

### 2. Thumb Drive Assembly

As best shown in FIGS. 20-26, the thumb drive assembly 432.2 is configured to translate the rotational motion from the motor assembly 410 to the carpometacarpal joint assembly 432 and the digit assembly 408. Specifically, the thumb drive assembly 432.2 is in geared engagement with the first and second motor gears 416, 422 and the worm wheel 454.4.1. To do this, the gear assembly 432.3 is comprised of: (i) a worm drive gear 432.2.2, (ii) a flexion gear 432.2.4, (iii) an interposition gear 432.2.6, (iv) a middle, digit adaptor, or flexion gear adaptor 432.2.10, (v) a flexion gear coupler 432.2.12, (vi) a drive shaft or flexion shaft 432.2.14, and (vii) a flexion bearing assembly 432.2.16 that includes a plurality of bearings 432.2.16.2-432.2.16.8. As discussed above and throughout this application, it should be understood that some of these components may be omitted, modified, replaced, and/or other parts may be added.

The flexion gear 432.2.4 is a toothed gear that is designed to be in geared engagement with the first motor gear 416, such that it rotates in response to the rotation of the first motor 412 and generates a zero pivot point P₀. Specifically, the rotation of the first or digit motor shaft 412.2 rotates the first motor gear 416, and wherein the rotation of the first motor gear 416 rotates the flexion gear 432.2.4 about a flexion axis A_{F}. While the flexion axis A_{F} does not intersect the first motor shaft axis A_{MS1} or the first motor gear axis A_{MSG1}, said flexion axis A_{F} is perpendicular to both the first motor shaft axis A_{MS1} and the first motor gear axis A_{MSG1}. Based on this configuration, the center of the teeth of the flexion gear 432.2.4, the first motor shaft axis A_{MS1} and the first motor gear axis A_{MSG1} are all positioned within the first motor gear plane P_{G1}. It should be understood that in an alternative embodiment, the flexion axis A_{F} may be parallel with the first motor shaft axis A_{MS1} and/or the first motor gear axis A_{MSG1}.

The flexion gear adaptor 432.2.10 is designed to couple the flexion gear 432.2.4 to the drive shaft or flexion shaft 432.2.14. To accomplish this, the flexion gear adaptor 432.2.10 has a cone shaped configuration, wherein an outer extent of the cone is designed to be coupled to the flexion gear 432.2.4 and an inner extent of the cone is designed to receive an extent of the drive shaft or flexion shaft 432.2.14. Once said drive shaft or flexion shaft 432.2.14 is positioned within the flexion gear adaptor 432.2.10, the flexion coupler 432.2.12 is utilized to secure said flexion gear adaptor 432.2.10 to the drive shaft or flexion shaft 432.2.14. As such, the flexion gear 432.2.4 is in geared engagement with the first motor gear 416; the worm drive gear 432.2.2 is in geared engagement with the worm wheel 454.4.1; and the drive shaft 432.2.14 is coupled to both the flexion gear 432.2.4 and the worm drive gear 432.2.2 via the flexion gear adaptor 432.2.10 and flexion gear coupler 432.2.12.

The above described positional relationship allows for the rotation of the first motor shaft 412.2 about a first motor shaft axis A_{MS1} to cause the first motor gear 416 to rotate around the first motor gear axis A_{MSG1}, the rotation of the first motor gear 416 causes the flexion gear 432.2.4 to rotate about the flexion axis A_{F}, the rotation of the flexion gear 432.2.4 causes the flexion gear adaptor 432.2.10 to rotate, the rotation of the flexion gear adaptor 432.2.10 causes the flexion gear coupler 432.2.12 to rotate, and the rotation of the flexion gear coupler 432.2.12 causes the drive shaft or flexion shaft 432.2.14 to rotate about the drive shaft axis A_{DS}. The drive shaft axis A_{DS} is parallel, aligned, and coaxial with the flexion axis A_{F}. As such, the drive shaft axis A_{DS} does not intersect the first motor shaft axis A_{MS1} or the first motor gear axis A_{MSG1}, said drive shaft axis A_{DS} is perpendicular to both the first motor shaft axis A_{MS1} and the first motor gear axis A_{MSG1}. Based on this configuration, the drive shaft axis A_{DS} is also perpendicular to each of the following: (i) the flexion axis A_{F}, (ii) the first motor shaft axis A_{MS1}, (iii) the first motor gear axis A_{MSG1}, and (iv) the first motor gear plane P_{G1}.

To allow the drive shaft or flexion shaft 432.2.14 to rotate within the thumb frame 432.1, the thumb drive assembly 432.2 utilizes a first portion of the flexion bearing assembly 432.2.16. In particular, internal bearings 432.2.16.6, 432.2.16.8 that are positioned between the internal wall of the lower frame member 432.1.4 and the drive shaft or flexion shaft 432.2.14 permit said drive shaft or flexion shaft 432.2.14 to rotate within said thumb frame 432.1. Without this ability to rotate the drive shaft or flexion shaft 432.2.14 without rotating the thumb frame 432.1 is important because otherwise the movement of the first motor 412 would cause the digit assembly 408 to rotate towards or away from the palm. This is not desirable because it would significantly complicate the proper positioning of the thumb assembly 40 and would likely make certain positions impossible to reach or achieve. As such, this limitation would likely cause the end effector 10 to lack the human dexterity that is needed to complete fine and delicate tasks. Nevertheless, an alternative embodiment may couple the drive shaft or flexion shaft 432.2.14 to an extent of the thumb frame 432.1, and wherein said coupling may be biased in a certain position (e.g., open). In this alternative embodiment, the second motor 418 may be omitted and the first motor 412 may drive the digit assembly 408 inward until it reaches a resistance point. Once said resistance point has been reached, the motor 412 may continue driving the drive shaft or flexion shaft 432.2.14 until the digit assembly 408 is fully curled around the object.

As described above, the rotation of the drive shaft or flexion shaft 432.2.14 to rotate about the drive shaft axis A_{DS}, causes the worm drive gear 432.2.2 to rotate about the worm drive gear axis A_{WDG}. The worm drive gear axis A_{WDG} is parallel, aligned, and coaxial with the flexion axis A_{F} and drive shaft axis A_{DS}. As such, the worm drive gear axis A_{WDG} does not intersect the first motor shaft axis A_{MS1} or the first motor gear axis A_{MSG1}, and the worm drive gear axis A_{WDG} is perpendicular to both the first motor shaft axis A_{MS1} and the first motor gear axis A_{MSG1}. Based on this configuration, the worm drive gear axis A_{WDG} is also perpendicular to the first motor gear plane P_{G1}. As will be discussed in greater detail below, the rotation of the worm drive gear 432.2.2 about the worm drive gear axis A_{WDG} causes the thumb assembly 40 to move about a second carpometacarpal joint axis A_{FC} (e.g., curl or uncurl).

Similar to how the rotation of the flexion gear 432.2.4 causes the digit assembly 408 to move (e.g., curl or uncurl), the rotation of the interposition gear 432.2.6 causes the base joint assembly 432 cause the base joint assembly 432 to rotate the digit assembly 408 towards or away from the palm region 62 and about a first carpometacarpal joint axis A_{SC}. To enable this rotational movement of the digit assembly 408, the interposition gear 432.2.6 is affixed to the lower frame member 432.1.4 of the thumb frame 432.1. Thus, the rotation of the interposition gear 432.2.6 about the interposition gear axis A_{A} causes the lower frame member 432.1.4 to rotate about a lower frame axis A_{LF}. The lower frame axis A_{LF} is parallel, aligned, and coaxial with the flexion axis A_{F}, drive shaft axis A_{DS}, and worm drive gear axis A_{WDG}. As such, the lower frame axis A_{LF} does not intersect the first motor shaft axis A_{MS1} or the first motor gear axis A_{MSG1}, and said lower frame axis A_{LF} is perpendicular to both the first motor shaft axis A_{MS1} and the first motor gear axis A_{MSG1}. Based on this configuration, the lower frame axis A_{LF} is also perpendicular to the first motor gear plane P_{G1}.

To further enable the smooth movement of the lower frame member 432.1.4 within the upper frame member 432.1.2, the thumb drive assembly 432.2 utilizes a second portion of the flexion bearing assembly 432.2.16. In particular, external bearings 432.2.16.2, 432.2.16.4 are positioned between the internal wall of the upper frame member 432.1.2 and the internal walls of the lower frame member 432.1.4. This ability to rotate the lower frame member 432.1.4 without curling/uncurling the digit assembly 408 is important because otherwise the movement of the second motor 418 would cause the digit assembly 408 to move/curl towards or away from the palm. This is not desirable because it would significantly complicate the proper positioning of the thumb assembly 40 and would likely make certain positions impossible to reach or achieve. As such, this limitation would likely cause the end effector 10 to lack the human dexterity that is needed to complete fine and delicate tasks.

In summary, the first motor 412 causes: (i) the first motor shaft 412.2 to rotate about a first motor shaft axis A_{MS1}, (ii) the rotation of the first motor shaft 412.2 causes the first motor gear 416 to rotate around the first motor gear axis A_{MSG1}, (iii) the rotation of the first motor gear 416 causes the flexion gear 432.2.4 to rotate about the flexion axis A_{F}, (iv) the rotation of the flexion gear 432.2.4 causes the flexion gear adaptor 432.2.10 to rotate, (v) the rotation of the flexion gear adaptor 432.2.10 causes the flexion gear coupler 432.2.12 to rotate, (vi) the rotation of the flexion gear coupler 432.2.12 causes the drive shaft or flexion shaft 432.2.14 to rotate about the drive shaft axis A_{DS}, (vii) the rotation of the drive shaft or flexion shaft 432.2.14 causes the worm drive gear 432.2.2 to rotate, (viii) the rotation of the worm drive gear 432.2.2 causes the worm wheel 454.4.1 to rotate, and (ix) the rotation of the worm wheel 454.4.1 causes the digit assembly 408 to curl/uncurl towards or away from the palm 62.

Likewise, the second motor 418 causes: (i) the second motor shaft 418.2 to rotate about a second motor shaft axis A_{MS2}, (ii) the rotation of the second motor shaft 418.2 causes the second motor gear 422 to rotate around the second motor gear axis A_{MSG2}, (iii) the rotation of the second motor gear 422 causes the interposition gear 432.2.6 to rotate about the interposition gear axis A_{A}, (iv) the rotation of the interposition gear 432.2.6 causes the lower frame member 432.1.4 to rotate, (v) the rotation of the lower frame member 432.1.4 causes the digit assembly 408 to rotate towards or away from the palm region 62. It should be understood that alternative embodiments are contemplated herein, wherein said alternatives include changing the position of the motors 412, 418 (switching them, rotating them to be parallel or substantially parallel with the finger motors, placing them on the same side of the frame 61.2 as the finger motors, etc.).

ii. Carpometacarpal Electronics and Housing

The carpometacarpal electronics 434 may comprise a carpometacarpal encoder employing various sensing technologies, such as magnetic, optical, capacitive, or resistive systems, strategically positioned near the first carpometacarpal joint CMC₁. This encoder is configured to capture data related to the rotational movement of the joint CMC₁. Such data may be utilized by the robot system to generate a vector representation, such as a spatial embedding, that reflects the current state of the digit assembly 408 or the surrounding environment. In certain embodiments, the carpometacarpal electronics 434 may acquire data either upon receiving a specific command from the robot system or at regular intervals, ranging from high-frequency sampling (e.g., 500 times per second) to periodic updates (e.g., once per minute). The data provided by the carpometacarpal encoder may include precise information about the position and movement of the first carpometacarpal joint CMC₁, enabling fine-tuned control of the thumb assembly 40.

In some implementations, the carpometacarpal encoder may integrate multiple sensing modalities, such as a combination of magnetic and optical sensing, to enhance redundancy and accuracy in detecting joint position. This multi-modal approach may enable reliable operation under diverse environmental conditions, such as variations in lighting, temperature, or magnetic interference. Furthermore, the carpometacarpal encoder may incorporate machine learning algorithms to facilitate adaptive calibration, improving accuracy over time by analyzing usage patterns. This adaptive capability may also allow the system to compensate for wear or minor misalignments that develop during prolonged operation. In addition to rotational data, the encoder may detect small translational movements or vibrations of the joint CMC₁. These additional data points could be used to identify early signs of mechanical wear or looseness in the joint assembly, enabling predictive maintenance and extended system longevity. For enhanced precision, the encoder may employ a high-resolution absolute encoding scheme, which provides accurate positional data immediately after power-up without necessitating a homing sequence. This feature could significantly reduce initialization time for the thumb assembly 40.

To optimize data handling, the carpometacarpal electronics 434 may incorporate local data buffering and preprocessing functionalities. This design may allow high-frequency sampling and real-time filtering of joint position data, transmitting only significant state changes to the primary robot control system. Such an approach could reduce communication bandwidth requirements while maintaining system responsiveness. Additionally, the encoder system may be engineered for ultra-low power consumption, with the potential to harvest energy from the mechanical movements of the joint itself. This energy-efficient design could extend operational duration and decrease dependence on external power sources, enhancing the overall autonomy of the sensing system.

The base joint or carpometacarpal joint housing assembly 436 is designed to protect a lower extent of the thumb assembly 40 and enable a substantially smooth transition from the interior bottom housing 61.10 of the palm housing 60.1. Thus, a base gap G₁ is formed between a bottom edge 60.1.1 of the palm housing 60.1 and an upper edge 436.10 of the base joint or carpometacarpal joint housing assembly 436. Said design of the palm housing 60.1 and the base joint or carpometacarpal joint housing assembly 436 minimizes the base gap G₁ that is formed between these two structures 60.1, 436.10. Said minimization of the base gap G₁ provides a substantial benefit over conventional end effectors 10 that include a large gap between the palm and the thumb because it: (i) minimizes the chance or probability that a glove or external covering can be caught or pinched between these housings/assemblies, (ii) provides better protection of the internal components of the thumb assembly 40, and (iii) helps seal the interworking of the thumb assembly 40 from the environment.

Additionally, the configuration of the base joint or carpometacarpal joint housing assembly 436 is significantly different from a conventional boot or flexible member, which are typically stretched between the thumb assembly 40 and the inner palm surface S_{P} of the palm housing 60.1. The differences include the following key factors: (i) the housing assembly 436 is not engineered to be substantially flexible; rather, it is designed to be substantially rigid, providing enhanced stability and durability, (ii) the entire housing 436 is intended to rotate in coordination with the thumb assembly 40, (iii) a portion of the housing 436 is not directly coupled to the palm housing 60.1, allowing for improved articulation and independent movement of the housing assembly 436, and (iv) while the base gap G₁ is minimized, said base gap G₁ remains between the palm housing 60.1 and the housing 436, which accommodates the necessary movement without causing friction or restricting motion. These distinctive features afford the housing 436 substantial advantages over a conventional boot design. Specifically, the disclosed housing 436 design: (i) does not obstruct or interfere with the contact between the end effector 10 and the object with which the end effector 10 is interacting, ensuring optimal performance and precision, (ii) is resistant to tearing or rapid degradation, even when the end effector 10 encounters sharp objects such as sheet metal, and (iii) additional benefits, which will be apparent to those skilled in the art, can be derived from these design elements as disclosed herein.

The base joint or carpometacarpal joint housing assembly 436 has an overall shape that is similar to a checkmark or tick and includes: (i) an interior, upper member 436.1, (ii) an exterior, upper member 436.2, and (iii) a lower member 436.3. Each of the members 436.1, 436.2, 436.3 include interior mounting projections 436.10 that extend inward and are designed to be coupled to the thumb frame 432.1 (and specifically, the carpometacarpal or base joint housing coupling points 432.1.4.6) using elongated mechanical fasteners. It should be understood that alternative coupling means are contemplated by this disclosure, including snaps, press-fit, other mechanical interacting structures, and/or any other known method of mechanical coupling. Further, it should be understood that the number of members contained within the housing assembly 436 may increase or decrease depending on the needs and configuration of said thumb drive assembly 432.2.

As shown in FIGS. 20-24, the base joint or carpometacarpal joint housing assembly 436 is configured to surround or at least substantially surround a portion of: (i) the lower frame member 432.1.4, (ii) the worm drive gear 432.2.2, and (iii) the proximal link assembly 454. To surround or at least substantially surround the above components, the base joint or carpometacarpal joint housing assembly 436 forms a base joint receiver 432.20. The base joint receiver 432.20 is designed to receive: (i) an extent of the proximal assembly 450 (namely, a rear extent of the proximal housing assembly 452), when the thumb assembly 40 is in the open, uncurled, or neutral position, and (ii) a lesser extent of, or none of, the proximal assembly 450 (namely, the rear extent of the proximal housing assembly 452), when the thumb assembly 40 is in the closed, curled, or inwardly rotated position. In other words, the base joint housing assembly 436 overlies: (i) an extent of the proximal housing assembly 452 when the thumb assembly 40 is in the open, uncurled, or neutral position, and (ii) none of the proximal housing assembly 452 when the thumb assembly 40 is in the closed, curled, or inwardly rotated position. Stated another way, the percentage of the proximal housing assembly 452 (namely, the rear extent of the proximal housing assembly 452) that is positioned within the base joint housing assembly 436 is reduced when the thumb assembly 40 moves from the open, uncurled, or neutral position to the closed, curled, or inwardly rotated position. By enabling at least a minimal extent of the proximal housing assembly 452 to be positioned within or adjacent to the base joint housing assembly 436, the gap G₂ formed between the assemblies 436 and 452 is minimized, and wherein said minimization of said gap G₂ is beneficial because it minimizes the chance or probability that a glove or external covering can be caught or pinched between these assemblies.

a. Proximal Assembly

The proximal assembly 450 is positioned between the base joint assembly 430 and the medial assembly 470 and is the first portion of the thumb assembly 40 that is configured to move relative to the housing frame 61.2 and the palm 62 in response to actuation of the first motor 412 and worm drive gear 432.2.2. The proximal assembly 450 includes: (i) a proximal housing assembly 452, (ii) a proximal link assembly 454, and (iii) the worm wheel interface 456.

i. Proximal Housing Assembly

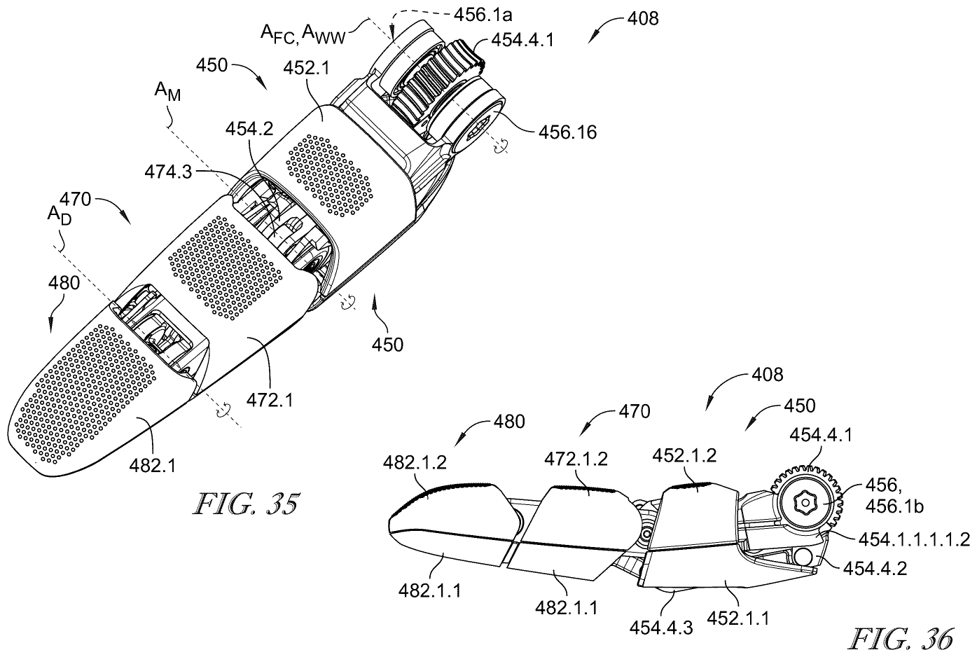

As shown in FIGS. 20-24 and 35-37, the proximal housing assembly 452 is designed to substantially surround a majority of the other components of the proximal assembly 450. To achieve this, the proximal housing assembly 452 forms an internal proximal recess 452.18. Unlike the finger assemblies 22a-22d, the internal proximal recess 452.18 is not designed to receive an extent of the medial assembly 470 (namely, the medial tongue) when the thumb assembly 40 is in the open, uncurled, or neutral position. Instead, an extent of said proximal housing assembly 452 is designed to be positioned near or adjacent to the medial housing 472. This configuration helps ensure that the gap G₃ formed between the assemblies 450 and 470 is minimized, and wherein said minimization of said gap G₃ is beneficial because it minimizes the chance or probability that a glove or external covering can be caught or pinched between these assemblies 450, 470.

In an alternative embodiment, the proximal housing assembly 452 may be configured to overlie: (i) a substantial extent of a medial tongue when the thumb assembly 40 is in the open, uncurled, or neutral position, and (ii) a minor extent of, or none of, the medial tongue when the thumb assembly 40 is in the closed, curled, or inwardly rotated position. Stated another way, the percentage of the medial assembly 470 (namely, the medial tongue) that is positioned within the proximal housing assembly 452 is reduced when the thumb assembly 40 moves from the open, uncurled, or neutral position to the closed, curled, or inwardly rotated position. This configuration may further minimize the size of gap G₃, which may further minimize the chance or probability that a glove or external covering can be caught or pinched between these assemblies 450, 470.

As shown in FIGS. 20-24 and 35-37, the proximal housing assembly 452 specifically includes: (i) a proximal jacket assembly 452.1 with a top member 452.1.1 and a bottom member 452.1.2, and (ii) a proximal bottom casing assembly 452.2. While the bottom member 452.1.2 is in direct contact with and underlies the proximal bottom casing assembly 452.2, the thumb assembly 40 lacks a proximal top casing assembly that is in direct contact with the top member 452.1.1. This design is advantageous because the proximal bottom casing assembly 452.2 provides the bottom member 452.1.2 with additional rigidity, which enables said bottom member 452.1.2 to be made from a softer, easier-to-form, and potentially less durable material, thereby increasing the gripping capability of the end effector 10. In contrast, the top member 452.1.1 does not need to include a softer, easier-to-form, and potentially less durable material because said top member 452.1.1 is not designed to come into regular contact with objects. Additionally, even if the materials of the proximal bottom casing assembly 452.2 and the bottom member 452.1.2 are the same, it may be desirable to form these components as two separate components to facilitate replaceability without exposing an inner extent of the thumb assembly 40. Another way of describing this beneficial configuration includes the fact that the proximal jacket assembly 452.1 is configured to provide the primary external shape of the thumb assembly 40, while the proximal casing assembly 452.2 is configured to protect the internal workings of said thumb assembly 40. Nevertheless, it should be understood that in an alternative embodiment, the bottom member 452.1.2 and the proximal bottom casing assembly 452.2 may be integrally formed as a single structure.

As best shown in FIGS. 11-12, 20-24, and 35-37, the top member 452.1.1 of the proximal jacket assembly 452.1 includes an exterior surface back with a curvilinear extent in a first direction (namely, across the width of the thumb assembly 40), and the bottom member 452.1.2 of the proximal jacket assembly 452.1 includes an exterior palm surface 61.2.2 with a curvilinear extent in the first direction (namely, across the width of the thumb assembly 40) and a second direction (namely, across the length of the thumb assembly 40). The curvilinear extent in the first direction helps ensure that the thumb assembly 40 has rounded edges to help with grasping objects, while the curvilinear extent in the second direction helps ensure that the thumb assembly 40 can curl inward. As discussed above, the proximal housing assembly 452 may be: (i) made from the same materials as the housing assembly 60, (ii) made from material that differs from the materials used in the housing assembly 60, and/or (iii) may include silicon, plastic (e.g., may include a polymer composition), carbon composite, or metal, a combination of these materials, any other material disclosed herein, and/or any other suitable material. Alternatively, the proximal housing assembly 452 may include additional components or layers (e.g., between three and an nth layer).

iii. Proximal Link Assembly

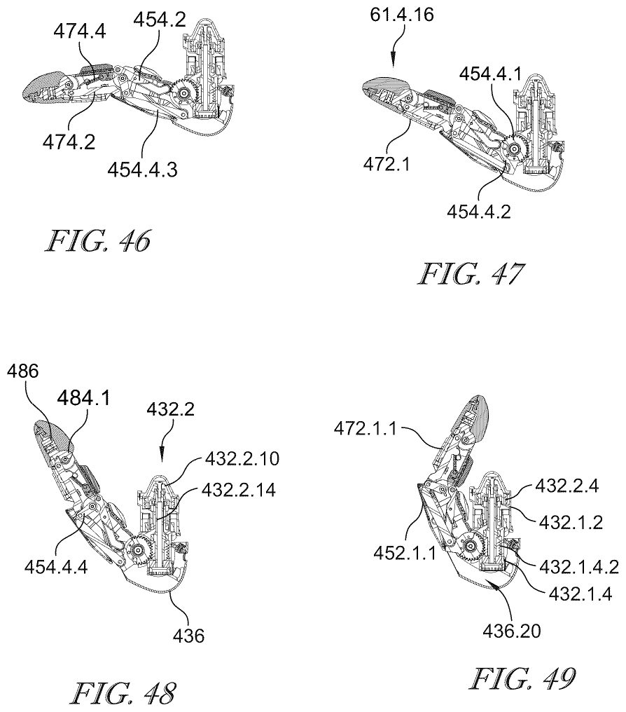

As shown in FIGS. 20-24 and 35-54, the proximal link assembly 454 includes: (i) a primary or main proximal link or first bar 454.1, (ii) a coupling link 454.2, (iii) a medial assembly coupler 454.3, and (iv) a proximal drive link assembly 454.4. The proximal link assembly 454 is involved with all movements of the thumb assembly 40, wherein its angular position can be altered based on the curling of an extent of the assembly 40 and its rotational position can be altered based on rotating the assembly 40. In other words, at least one aspect of the proximal link assembly 454 must move in some aspect to cause any portion of the thumb assembly 40 to move. As discussed above, this disclosure is in contrast to conventional end effectors and/or conventional fingers. This configuration is beneficial because it reduces complexities, components, cost, and weight, while increasing reliability.

### 1. Main Proximal Link

The primary or main proximal link or first bar 454.1 is best shown in FIGS. 20-24, 34-40, and 48-50. The main proximal link 454.1 includes: (i) first and second frame members 454.1.1a, 454.1.1b, (ii) a proximal link bridge 454.1.2, and (iii) a proximal link recess 454.1.3. The first and second frame members 454.1.1a, 454.1.1b are comprised of: (i) a first proximal link segment 454.1.1.1a, 454.1.1.1b that extends from a rearmost extent of the main proximal link 454.1 to a first proximal link plane P_{L1}, (ii) a second proximal link segment 454.1.1.2a, 454.1.1.2b that extends from the first proximal link plane P_{L1} to a second proximal link plane P_{L2}, and (iii) a third proximal link segment 454.1.1.3a, 454.1.1.3b that extends forward from the second proximal link plane P_{L2} to the forward most extent of the main proximal link 454.1.

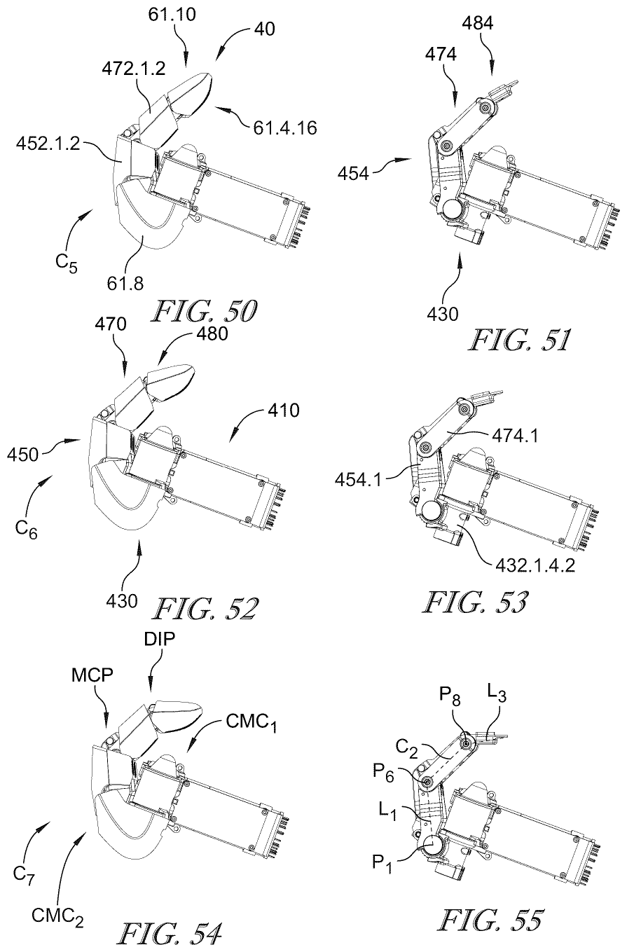

As shown in FIG. 50, the second left and right segments 454.1.1.2a, 454.1.1.2b taper inward as they extend from plane P_{L1} to plane P_{L2}, which reduces the overall width of the link 454.1. The reduction in width is beneficial because it allows for a reduction in the width of the thumb assembly 40 to aid in gripping objects. It should be understood that in other embodiments, the taper may be more significant or may be eliminated. Also, as shown in FIG. 54, first right and left segments 454.1.1.1a, 454.1.1.1b are substantially parallel with one another, but are not aligned with the third right and left segments 454.1.1.3a, 454.1.1.3b. In other embodiments, said first and third left and right segments 454.1.1.1a, 454.1.1.1b, 454.1.1.3a, 454.1.1.3b may not be substantially parallel with one another and/or may be substantially aligned with other components of the main proximal link 454.1.

As shown in FIGS. 48-51, the first proximal link segment 454.1.1.1 includes a second joint or carpometacarpal joint CMC₂ with a carpometacarpal joint coupler 454.1.1.1.1 having an axle aperture 454.1.1.1.1.1 and a stopping projection 454.1.1.1.1.2. The axle aperture 454.1.1.1.1.1 of the carpometacarpal joint coupler 454.1.1.1.1 is circular and is designed to receive an extent of the worm wheel assembly 456 (which will be discussed later). It should be understood that non-circular configurations of the axle aperture 454.1.1.1.1.1 are contemplated by this disclosure (e.g., tear-drop). Referring to FIG. 51, the stopping projection 454.1.1.1.1.2 is positioned in a lower extent of the first proximal link segment 454.1.1.1. When the proximal assembly 450 is in the curled position, a second limiting interface region 454.1.1.1.1.2.1 of the stopping projection 454.1.1.1.1.2 is designed to interact with an extent of the joint frame member 432.1. It should be understood that the above described interface region 454.1.1.1.1.2.1 may not make contact with the described adjacent structures. Instead, a gap may be present between these structures regardless of the state of the thumb assembly 40.

As shown in FIGS. 48-51, the second proximal link segment 454.1.1.2 is not aligned with either the first or third segments 454.1.1.1, 454.1.1.3 and includes: (i) elongated ribs 454.1.1.2.1 that extend from a side of the proximal frame member 454.1.1a, 454.1.1b, (ii) a second set of housing mounting projections 454.1.1.2.2, wherein the first set of housing mounting projections 454.1.1.1.2 were a component of the first proximal link segment 454.1.1.1. The housing mounting projections 454.1.1.1.2, 454.1.1.2.2 are configured to couple the proximal jacket assembly 452.1 to the proximal link assembly 454. Other methods of coupling said assemblies 452.1, 454 to one another are contemplated by this disclosure, including clips, press- fits, or other mechanical coupling means.

Like the frame members 454.1.1a, 454.1.1b of the first segment 454.1.1.1, the frame members 454.1.1a, 454.1.1b of the third segment 454.1.1.3 are substantially parallel to one another. Additionally, the third proximal link segment 454.1.1.3 also includes: (i) a medial assembly opening 454.1.1.3.1 configured to receive a securement means that couples the main proximal link 454.1 to the jumper 454.4.4 of the proximal drive link assembly 454.4 to form a fourth pivot point P₄, and (ii) a medial assembly recess 454.1.1.3.2 to ensure that the securement means does not interfere with the movement of any of the links contained within the thumb assembly 40. It should be understood that the securement means is contemplated by this disclosure, including any mechanical coupler (e.g., pin and clip). Also, the medial assembly recess 454.1.1.3.2 may be omitted or the nesting of components may be altered in other embodiments.

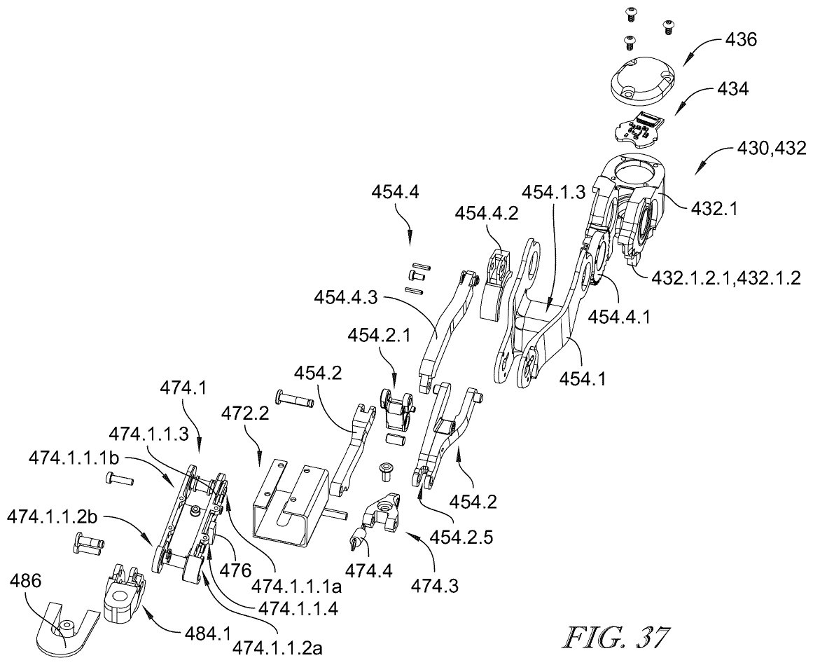

As shown in FIGS. 37, 38, 40, 49, and 50, the proximal bridge 454.1.2 extends between an extent of the first and second proximal frame members 454.1.1a, 454.1.1b. Thus, a U-shaped member with a proximal link recess 454.1.3 is formed from the combination of the proximal bridge 454.1.2 and the proximal frame members 454.1.1a, 454.1.1b. This proximal link recess 454.1.3 is designed to receive different extents of the coupling link 454.2 and proximal drive link assembly 454.4 depending on the position of the thumb assembly 40. The proximal bridge 454.1.2 also includes a third limiting interface region 454.1.2.1 designed to interact with the first limiting interface region 432.1.2.1 of the upper frame member 432.1.2 when the thumb assembly 40 is fully curled. Modifications to the location and configuration of the interface regions 432.1.2.1, 454.1.2.1 are contemplated by this disclosure.

### 2. Coupling Link

As shown in FIGS. 37, 38, and 52-54, the coupling link or fourth bar 454.2 secures the frame 432.1 of the base joint assembly 430 to the biasing assembly 474.4 of the medial link assembly 474. As such, the coupling link or fourth bar 454.2 includes a first end that is pivotally coupled at a second pivot point P₂ to said thumb frame 432.1 and a second end that is pivotally coupled at a third pivot point P₃ to said Y-link 474.3. Thus, the second and third pivot points are P₂, P₃. The coupling link 454.2 is comprised of left and right portions 454.2.1a, 454.2.1b, which when assembled allow the coupling link 454.2 to include: (i) frame projections 454.2.2a, 454.2.2b that are configured to be received by an extent of the frame 432.1, (ii) a link assembly recess 454.2.3, which is configured to receive an extent of the proximal drive link assembly 454.4 when said thumb assembly 40 is in the curled position, (iii) a Y-link opening 454.2.4 and a Y-link recess 454.2.5, both of which are configured to allow said coupling link 454.2 to interact with the Y-link 474.3 of the medial link assembly 474. This configuration also ensures that the coupling link or fourth bar 454.2 is supported on two sides of a plane that bisects the length of the thumb assembly 40. It should be understood that in other embodiments, the coupling link 454.2 may be combined with other links or may be omitted.

### 3. Proximal Drive Link Assembly

As shown in FIGS. 34-47, the proximal drive link assembly 454.4 includes: (i) a worm wheel 454.4.1, (ii) a worm wheel coupler 454.4.2, (iii) a worm drive link or second bar 454.4.3, and (iv) a jumper or third bar 454.4.4. The worm wheel 454.4.1 is a semi-circular toothed gear that is designed to be in geared engagement with the worm drive gear 432.2.2 and is configured to facilitate the movement of the thumb assembly 40 from an uncurled position to a curled position. In particular, the worm wheel 454.4.1 includes: (i) a toothed section that includes 18 teeth that encircle 220 degrees of the worm wheel 454.4.1, (ii) a recessed portion 454.4.1.1 that is designed to receive an extent of the worm wheel coupler 454.4.2, and (iii) a central bearing opening 454.4.1.2 that is designed to receive first and second worm bearings 456.2a, 456.2b (as discussed below). The worm wheel 454.4.1 is designed to rotate about a worm wheel axis A_{ww}, wherein the worm wheel axis A_{ww} is located at the center of the central bearing opening 454.4.1.2 and the first pivot point P₁. It should be understood that in other embodiments, the worm wheel 454.4.1 may include additional teeth (e.g., between 19 and 50) or fewer teeth (e.g., between 5 and 17). Additionally, the toothed section 454.4.1 may span more than 220 degrees (e.g., between 221 and 300 degrees) or span less than 220 degrees (e.g., between 100 and 119 degrees).

The worm wheel coupler 454.4.2 includes a worm drive link opening 454.4.2.2 that is designed to couple said worm wheel 454.4.1, via the worm wheel coupler 454.4.2, to the worm drive link or second bar 454.4.3. Further, the worm wheel coupler 454.4.2 includes other features that permit the transfer of energy from the worm wheel 454.4.1 to the assemblies 480, 470 of the thumb assembly 40. For example, said worm wheel 454.4.1 includes a recess that is positioned adjacent to the worm wheel interface region 454.4.1.3 and is configured to ensure that a coupler does not interfere with the movement of the worm wheel assembly 456. However, it should be understood that the recess may be omitted in other embodiments and/or said worm wheel 454.4.1 may be sealed within the motor assembly 410.

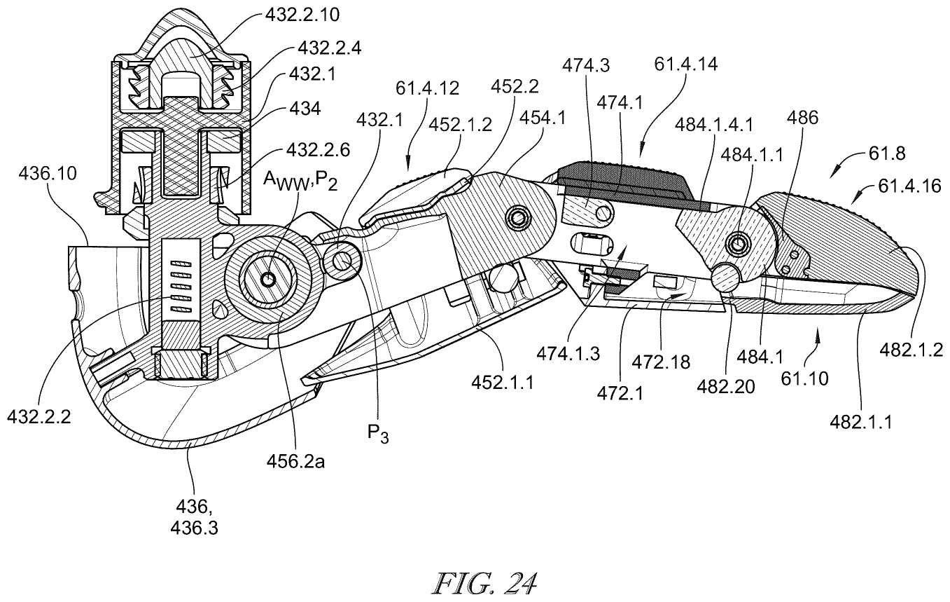

The worm drive link 454.4.3 includes: (i) a wheel coupler opening 454.4.3.1 that is configured to receive a coupler designed to pivotally secure said worm drive link 454.4.3 to the worm wheel coupler 454.4.2 at the fourth pivot point P₄, and (ii) a proximal drive link opening 454.4.3.2 that is configured to receive a coupler designed to pivotally secure said worm drive link 454.4.3 to the jumper 454.4.4 and the medial drive link 474.2 at the fifth pivot point P₅. Duc to the worm drive link's 454.4.3 design and as shown in FIGS. 21 and 24, an extent of the link is designed to move from outside of the primary or main proximal link or first bar 454.1 to within said primary or main proximal link or first bar 454.1. As such, the fourth and fifth pivot points P₄, P₅ are not fixed and thus are configured to move in response to the movement of the digit assembly 408.

Said jumper 454.4.4 includes: (i) a proximal drive link opening 454.4.4.1 that is configured to receive a coupler designed to secure said jumper 454.4.4 to the worm drive link 454.4.3 and the medial drive link 474.2 (at pivot point P5), and (ii) a main link opening 454.4.4.2 that is configured to receive a coupler designed to secure said jumper 454.4.4 to the main proximal link 454.1. The combination of these links (worm wheel coupler 454.4.2, worm drive link 454.4.3, jumper 454.4.4) enables the transfer of the movement from the worm wheel 454.4.1 to the medial assembly 470. Due to this transfer of movement, the angles formed between the following links change depending on the position of the digit assembly 408: (i) the worm wheel coupler 454.4.2 and the worm drive link 454.4.3, (ii) the worm drive link 454.4.3 and jumper 454.4.4, (iii) the jumper 454.4.4 and the medial drive link 474.2, and (iv) the worm drive link 454.4.3 and the medial drive link 474.2.

iv. Worm Wheel Assembly

The worm wheel assembly 456 includes first and second worm locking members 456.1a, 456.1b, along with first and second worm bearings 456.2a, 456.2b. The worm wheel assembly 456 utilizes the configuration of the locking members 456.1a, 456.1b and bearings 456.2a, 456.2b to allow the main proximal link 454.1 to remain in a fixed position once it has come into contact with a resistance point/surface, while the motor assembly 410 continues to drive the proximal drive link assembly 454.4 (causing movement of the medial and distal assemblies 470, 480). In other words, the bearings 456.2a, 456.2b allow the main proximal link 454.1 to stop rotating even when the worm wheel 454.4.1 continues to rotate. This continued rotation of the worm wheel 454.4.1 enables the thumb assembly 40 to move the biasing member 474.4.1 from the first or collapsed position to a second or extended position, which enables the medial and distal assemblies 470, 480 to continue curling about said object. It should be understood that without this slippage between the main proximal link 454.1 and the worm wheel 454.4.1, the thumb assembly 40 could not rotate the medial and distal assemblies 470, 480 once the proximal assembly 450 came into contact with a resistance point/surface.

b. Medial Assembly

The medial assembly 470 is positioned between the proximal assembly 450 and the distal assembly 480 and is the second portion of the thumb assembly 40 configured to move relative to the palm 62. The medial assembly 470 includes: (i) a medial housing assembly 472, and (ii) a medial link assembly 474.

i. Medial Housing Assembly

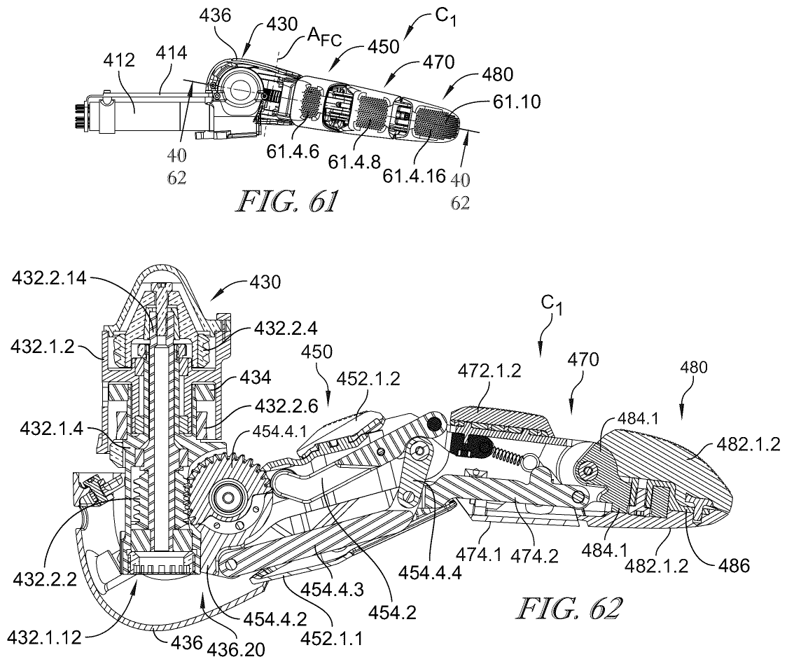

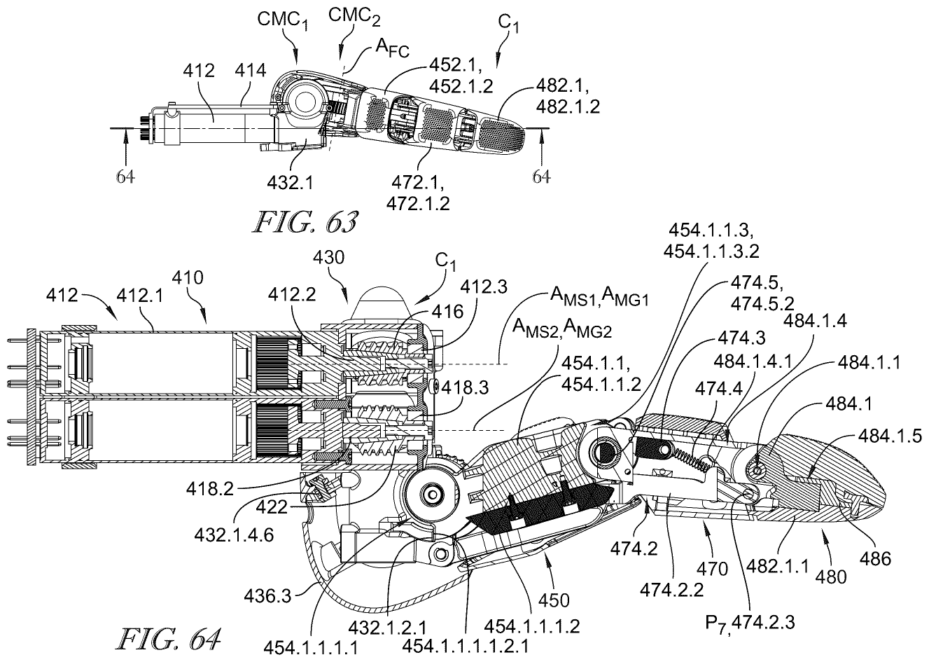

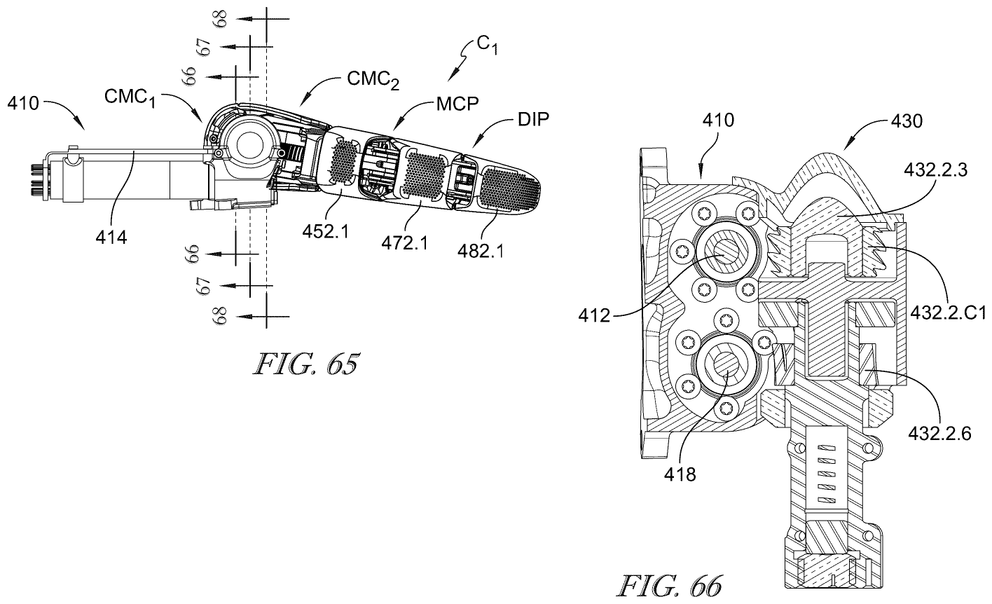

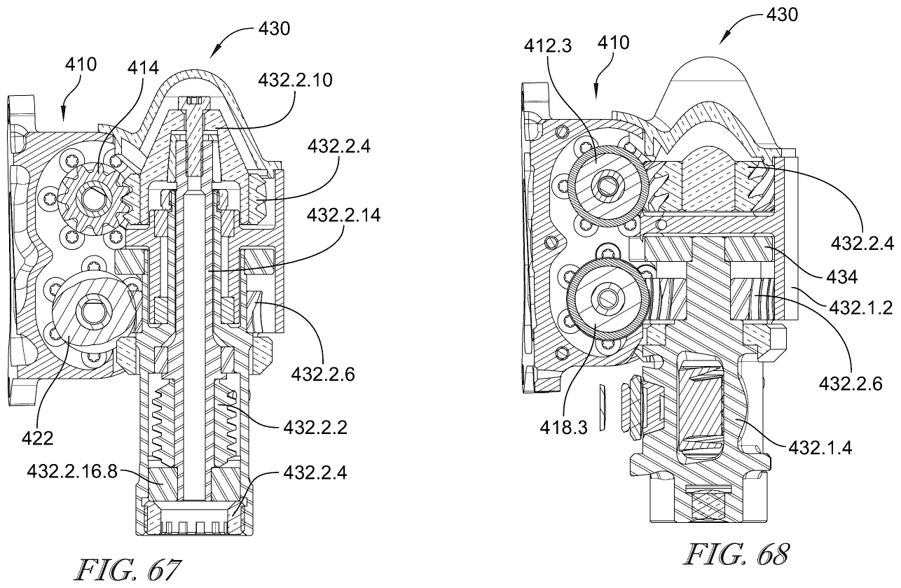

As shown in FIGS. 20-24 and 55-67, the medial housing assembly 472 is designed to substantially surround a majority of the other components of the medial assembly 470. To achieve this, the medial housing assembly 472 forms an internal medial recess 472.18. The internal medial recess 472.18 is designed not only to surround components of the medial assembly 470, but is also designed to receive: (i) an extent of the distal assembly 480 (namely, a distal tongue 482.20), when the thumb assembly 40 is in the open, uncurled, or neutral position, and (ii) a lesser extent of, or none of, the distal assembly 480 (namely, the distal tongue 482.20), when the thumb assembly 40 is in the closed, curled, or inwardly rotated position. In other words, the medial housing assembly 472 overlies: (i) a substantial extent of the distal tongue 482.20 when the thumb assembly 40 is in the open, uncurled, or neutral position, and (ii) a minor extent of, or none of, the distal tongue 482.20 when the thumb assembly 40 is in the closed, curled, or inwardly rotated position. Stated another way, the percentage of the distal assembly 480 (namely, the distal tongue 482.20) that is positioned within the medial housing assembly 472 is reduced when the thumb assembly 40 moves from the open, uncurled, or neutral position to the closed, curled, or inwardly rotated position. By enabling at least a minimal extent of the distal assembly 480 (namely, the distal tongue 482.20) to be positioned within or adjacent to the medial assembly 470, the gap G₄ formed between the assemblies 470 and 480 is minimized, and wherein said minimization of said gap G₄ is beneficial because it minimizes the chance or probability that a glove or external covering can be caught or pinched between these assemblies.

As shown in FIGS. 20-24 and 55-57, the medial housing assembly 472 specifically includes: (i) a medial jacket assembly 472.1 with a top member 472.1.1 and a bottom member 472.1.2, and (ii) a medial bottom casing assembly 472.2. While the bottom member 472.1.2 is in direct contact with and underlies the medial bottom casing assembly 472.2, the thumb assembly 40 lacks a medial top casing assembly that is in direct contact with the top member 472.1.1. This design is advantageous because the medial bottom casing assembly 472.2 provides the bottom member 472.1.2 with additional rigidity, which enables said bottom member 472.1.2 to be made from a softer, easier-to-form, and potentially less durable material, thereby increasing the gripping capability of the end effector 10. In contrast, the top member 472.1.1 does not need to include a softer, easier-to-form, and potentially less durable material because said top member 472.1.1 is not designed to come into regular contact with objects. Additionally, even if the materials of the medial bottom casing assembly 472.2 and the bottom member 472.1.2 are the same, it may be desirable to form these components as two separate components to facilitate replaceability without exposing an inner extent of the thumb assembly 40. Another way of describing this beneficial configuration includes the fact that the medial jacket assembly 472.1 is configured to provide the primary external shape of the thumb assembly 40, while the medial casing assembly 472.2 is configured to protect the medial PCB 476 and provide a spacer between the medial link assembly 474 and the medial jacket assembly 472.1. Nevertheless, it should be understood that in an alternative embodiment, the bottom member 472.1.2 and the medial bottom casing assembly 472.2 may be integrally formed as a single structure.

As best shown in FIGS. 20-24, the top member 472.1.1 of the medial jacket assembly 472. 1 includes an exterior surface back with a curvilinear extent in a first direction (namely, across the width of the thumb assembly 40), and the bottom member 472.1.2 of the medial jacket assembly 472.1 includes an exterior palm surface that has a curvilinear extent in the first direction (namely, across the width of the thumb assembly 40) and a second direction (namely, across the length of the thumb assembly 40). The curvilinear extent in the first direction helps ensure that the thumb assembly 40 has rounded edges to help with grasping objects, while the curvilinear extent in the second direction helps ensure that the finger can curl inward.

As discussed above, the medial housing assembly 472 may be: (i) made from the same materials as the housing assembly 60, (ii) made from materials that differ from the materials used in the housing assembly 60, and/or (iii) may include silicon, plastic (e.g., may include a polymer composition), carbon composite, or metal, a combination of these materials, and/or any other known material used in robot systems. Alternatively, the medial housing assembly 472 may include additional components or layers (e.g., between three and an nth layer). It should also be understood that in alternative embodiments the medial jacket assembly 472.1 and the medial casing assembly 472.2 may be combined into a single component and/or additional exterior members may be added to the end effector 10/thumb assembly 40.

ii. Medial PCB

The medial PCB 476 may include a first thumb encoder (e.g., magnetic, optical, capacitive, resistive, etc.) that is positioned adjacent to the first interphalangeal joint and configured to collect first interphalangeal joint data and a second thumb encoder (e.g., magnetic, optical, capacitive, resistive, etc.) that is positioned adjacent to the second interphalangeal joint and configured to collect second interphalangeal joint data. The first interphalangeal joint data and the second interphalangeal joint data are a part of curl data. This curl data may be used by the robot system to generate a vector representation (e.g., a spatial embedding) indicating the state of the proximal, medial, and distal assemblies 450, 470, 480 or the environment around these assemblies 450, 470, 480. The encoder of the medial PCB 476 may collect data upon a specific command from the robot system or periodically (e.g., between 500 times per second to once every minute). It should be understood that the robot system's knowledge of the position of the proximal, medial, and distal assemblies 450, 470, 480 is highly desirable because said robot system may lack other sensors that a conventional robot system utilizes and/or relies on to grasp or manipulate objects. In particular, said end effector 10 (including the finger assemblies 22a-22d and the thumb assembly 40) may lack pressure sensors that are heavily relied upon in conventional end effectors and instead merely rely on determining the size and position of objects and the knowledge of the position of components contained in the end effector 10.

In some implementations, the first and second thumb encoders may integrate multiple sensing modalities, such as a combination of magnetic and optical sensing, to enhance redundancy and accuracy in detecting joint position. This multi-modal approach may enable reliable operation under diverse environmental conditions, such as variations in lighting, temperature, or magnetic interference. Furthermore, the first and second thumb encoders may incorporate machine learning algorithms to facilitate adaptive calibration, improving accuracy over time by analyzing usage patterns. This adaptive capability may also allow the system to compensate for wear or minor misalignments that develop during prolonged operation. In addition to rotational data, the first and second thumb encoders may detect small translational movements or vibrations of the joint. These additional data points could be used to identify early signs of mechanical wear or looseness in the joint assembly, enabling predictive maintenance and extended system longevity. For enhanced precision, the first and second thumb encoders may employ a high-resolution absolute encoding scheme, which provides accurate positional data immediately after power-up without necessitating a homing sequence. This feature could significantly reduce initialization time for the thumb assembly 40.

To optimize data handling, the first and second thumb encoders may incorporate local data buffering and preprocessing functionalities. This design may allow high-frequency sampling and real-time filtering of joint position data, transmitting only significant state changes to the primary robot control system. Such an approach could reduce communication bandwidth requirements while maintaining system responsiveness. Additionally, the first and second thumb encoders may be engineered for ultra-low power consumption, with the potential to harvest energy from the mechanical movements of the joint itself. This energy-efficient design could extend operational duration and decrease dependence on external power sources, enhancing the overall autonomy of the sensing system.

iii. Medial Link Assembly

As shown in FIGS. 58-67, the medial link assembly 474 includes: (i) a primary or main medial link or fifth bar 474.1, (ii) a medial drive link or sixth bar 474.2, (iii) a Y-link or seventh bar 474.3, and (iv) a biasing assembly 474.4. The medial link assembly 474 is involved with a majority of the movements of the thumb assembly 40. While the proximal assembly 450 could move without causing a positional change between said proximal assembly 450 and the medial assembly 470, the distal assembly 480 cannot move without causing a positional change between said distal assembly 480 and the medial assembly 470. Because most movements of the end effector 10 involve movement of the medial assembly 470 relative to the proximal assembly 450 and/or distal assembly 480, said medial assembly 470 is involved with a majority of the movements of the thumb assembly 40. As discussed above, this is in contrast to conventional end effectors and/or conventional fingers and is beneficial because it reduces complexities, reduces components, and increases reliability. many other benefits are obvious to one of skill in the art.

### 1. Main Medial Link

The primary or main medial link or fifth bar 474.1 is best shown in FIGS. 58-64. The main medial link 474.1 includes: (i) left and right medial frame members 474.1.1a, 474.1.1b, (ii) a medial link bridge 474.1.2, and (iii) a medial link recess 474.1.3. The left and right medial frame members 474.1.1a, 474.1.1b include: (i) first interphalangeal joint openings 474.1.1.1a, 474.1.1.1b, (ii) second interphalangeal joint openings 474.1.1.2a, 474.1.1.2b, (iii) PCB projections 474.1.1.3 configured to allow the PCB 476 to be offset from the frame member 474.1.1b, and (iv) housing mounting projections 474.1.1.4 that are configured to couple the medial housing assembly 472 to the main medial link 474.1. As shown in the Figures, the first end of the primary or main medial link or fifth bar 474.1 is pivotally coupled to the primary or main proximal link or first bar 454.1 at the sixth pivot point P₆ and at the first interphalangeal joint FIP or MCP. A second end of the primary or main medial link or fifth bar 474.1 is pivotally coupled to the primary or main distal link or eighth bar 484.1 at the seventh pivot point P₇ and at the second interphalangeal joint SIP or DIP. It should be understood that the first end of the primary or main medial link or fifth bar 474.1 includes the first interphalangeal joint openings 474.1.1.1a, 474.1.1.1b, while the second end of the primary or main medial link or fifth bar 474.1 includes the second interphalangeal joint openings 474.1.1.2a, 474.1.1.2b. It should be understood that this disclosure contemplates omitting one or more of these components or altering their configuration.

The left and right medial frame members 474.1.1a, 474.1.1b are coupled to one another via a medial link bridge 474.1.2. The combination of the left and right medial frame members 474.1.1a, 474.1.1b and the medial link bridge 474.1.2 forms a U-shaped member. the U-shaped member includes a medial link recess 474.1.3. This medial link recess 474.1.3 is configured to receive an extent of the medial link assembly 474, wherein the position of various components in the medial link assembly 474 may move or shift when the position of the thumb assembly 40 is altered. It should be understood that in other embodiments the medial link bridge 474.1.2 may be omitted, and the frame members 474.1.1a, 474.1.1b may be connected via a first interphalangeal joint assembly 474.5 and a second interphalangeal joint assembly 474.6. Additionally, as shown in the Figures, an extent of the main proximal link 454.1 is positioned within the main medial link 474.1. Specifically, the main medial link 474.1 overlies the medial assembly recess 474.1.1.3.2 of the first and second proximal frame members 454.1.1a, 454.1.1b. This interlocking nature of the disclosed end effector 10 increases the reliability of said robot system.

A bushing 474.5.1, an axle 474.5.2, and a washer 474.5.3 form the first interphalangeal joint assembly 474.5 and wherein an extent of said first interphalangeal joint assembly 474.5 is positioned within the first interphalangeal joint openings 474.1.1.1a, 474.1.1.1b and extends between the first and second medial frame members 474.1.1a, 474.1.1b. Meanwhile, a bushing 474.6.1, an axle 474.6.2, and a washer 474.6.3 form the second interphalangeal joint assembly 474.6 and wherein an extent of said second interphalangeal joint assembly 474.6 is positioned within the second interphalangeal joint openings 474.1.1.2a, 474.1.1.2b and extends between the first and second medial frame members 474.1.1a, 474.1.1b. The combination of the first interphalangeal joint assembly 474.5 and the first interphalangeal joint openings 474.1.1.1a, 474.1.1.1b forms the sixth pivot point P₆, while the combination of the second interphalangeal joint assembly 474.6 and the second interphalangeal joint openings 474.1.1.2a, 474.1.1.2b forms the seventh pivot point P₇.

### 2. Medial Drive Link and Biasing Assembly

The medial drive link, or sixth bar 474.2, is best shown in FIGS. 20-24, 58-59, and 65-67. The medial drive link 474.2 includes: (i) a proximal drive link yoke 474.2.1, (ii) an elongated segment 474.2.2, and (iii) a distal link opening 474.2.3. The proximal drive link yoke 474.2.1 is designed to receive an extent of both: (i) the worm drive link 454.4.3, and (ii) the jumper 454.4.4. After the yoke 474.2.1 receives both the worm drive link 454.4.3 and the jumper 454.4.4, a securement means is inserted into an extent of the proximal drive link opening 454.4.4.1 of the jumper, the main link opening 454.4.4.2 of the jumper, and the proximal drive link opening 454.4.3.2 of the worm drive link 454.4.3. The coupling of these three linkages: medial drive link 474.2, worm drive link 454.4.3, and jumper 454.4.4 creates a fifth pivot point P₅ after a securement means is inserted into each of these openings. Additionally, the coupling of the distal assembly 480 to the medial drive link 474.2 by inserting a securement means within the distal link opening 474.2.3 forms an eighth pivot point P₈.

It should be understood that both of the disclosed securement means should be sufficiently rigid to withstand the movement and torque of the motors 412, 418. However, in other embodiments, the disclosed interlocking or nesting of these components may be omitted and/or the coupling of three separate bars at a single central point may be altered. For example, the medial drive link 474.2 may be coupled to one extent of the jumper 454.4.4 on a single side, and the jumper 454.4.4 may be coupled to the worm drive link 454.4.3 on the opposite side of the jumper 454.4.4 at an alternative location that is different from the location where the medial drive link 474.2 is coupled.

A biasing projection 474.2.2.1 extends outward and depends from the elongated segment 474.2.2 of medial drive link 474.2 and is designed to receive an extent of the biasing assembly 474.4. It should be understood that said biasing projection 474.2.2.1 may be coupled to other members (e.g., main medial link 474.1) in other embodiments. Said biasing assembly 474.4 is best shown in FIGS. 21, 24, 57, 60, and 66-67, wherein the biasing assembly 474.4 includes the biasing member 474.4.1 and a biasing coupler 474.4.2. The biasing coupler 474.4.2 is configured to be positioned within a biasing assembly opening 474.3.3 of the Y-link 474.3, which enables said biasing member 474.4.1 to be positioned within a biasing assembly receiver 474.3.4 of said Y-link 474.3. The biasing member 474.4.1 may be a spring or any other known member (e.g., magnet, torsion bar, elastically deformable members, leaf spring, shape memory alloys, etc.) that can provide a biasing force on an extent of the thumb assembly 40 to control the order of closure/collapse of the components contained in said thumb assembly 40. In particular, when the thumb assembly 40 moves from the open, uncurled, or neutral position to the curled position, the biasing member 474.4.1 moves from a first or collapsed position with a length L₁ to a second or extended position with a length L₂. In the first or collapsed position, the biasing member 474.4.1 exerts a first biasing force F₁ that is less than a second biasing force F₂ that is exerted in the second or extended position. The biasing member 474.4.1 is designed to prevent the medial or distal assemblies 470, 480 from curling before the proximal housing 452 has come into contact with a resistance point (e.g., an object). Once the proximal housing 452 has come into contact with a resistance point (e.g., an object), the main proximal link 454.1 and the proximal housing 452 stop moving. However, the motor assembly 410 can continue driving the worm drive gear 432.2.2 in a first direction, which turns the worm wheel 454.4.1, thereby causing the worm drive link 454.4.3 and the jumper 454.4.4 proximal drive link 454.4.3 to move into the proximal link recess 454.1.3 and rotation about the worm wheel axis A_{ww}. This forces the biasing member 474.4.1 to expand from its original state, and therefore forces the medial and distal assemblies 470, 480 to curl inwards. The thumb assembly 40 can uncurl or return to its original position if the motor assembly 410 drives the worm drive gear 432.2.2 in a second direction, which turns the worm wheel 454.4.1, thereby causing the worm drive link 454.4.3 and the jumper 454.4.4 to move out of the proximal link recess 454.1.3. This forces the medial and distal assemblies 470, 480 to uncurl, therefore allowing the biasing member 474.4.1 to return to its original state, and consequently allowing the main proximal link 454.1 and the proximal housing 452 to return to their original position. It should be understood that other biasing members, structures, assemblies, or components may be used instead of the spring shown in the figures, and in certain embodiments, the biasing assembly 474.4 may be eliminated.

### 3. Y-Link

As best shown in FIGS. 52-54, the Y-link or seventh bar 474.3 is primarily configured to be coupled to an extent of the biasing assembly 474.4 and the main medial link 474.1. To accomplish this, the Y-link 474.3 includes: (i) a coupling link opening 474.3.1, (ii) a securement opening 474.3.2, (iii) a biasing assembly opening 474.3.3, and (iv) a biasing assembly receiver 474.3.4. The coupling link opening 474.3.1 is designed to receive a securement member (e.g., pin) that extends through the Y-link opening 454.2.4 of the coupling link 454.2, thereby pivotally coupling said Y-link 474.3 to the coupling link 454.2 at the third pivot point P₃. While the third pivot point P₃ is formed at the center of the coupling link opening 474.3.1, a pivot point is not formed at the center of the securement opening 474.3.2. Instead, the securement opening 474.3.2 is configured to receive an extent of a fastener (e.g., screw) to couple said Y-link 474.3 to an extent of the main medial link 474.1. Based on this configuration, it should be understood that the Y-link 474.3 may be eliminated in certain embodiments. In these embodiments, the attributes of the Y-link 474.3 may be incorporated into the main medial link 474.1. As described in greater detail below, the frontal end of the Y-Link that includes the biasing assembly opening 474.3.3 is designed to receive an extent of the biasing member 474.4.1, and wherein said biasing member 474.4.1 is secured to the Y-Link via insertion of biasing coupler 474.4.2 through both an extent of the biasing member 474.4.1 and the biasing assembly receiver 474.3.4. It should be understood that in other embodiments, the biasing member 474.4.1 may be integrally formed with the Y-link 474.3, and thus, various structures described herein may be omitted or modified.

c. Distal Assembly

The distal assembly 480 is positioned forward of the medial assembly 470 and is the third portion of the thumb assembly 40 configured to move relative to the palm 62. The distal assembly 480 includes: (i) a distal housing assembly 482, and (ii) a distal link assembly 484.

i. Distal Housing Assembly

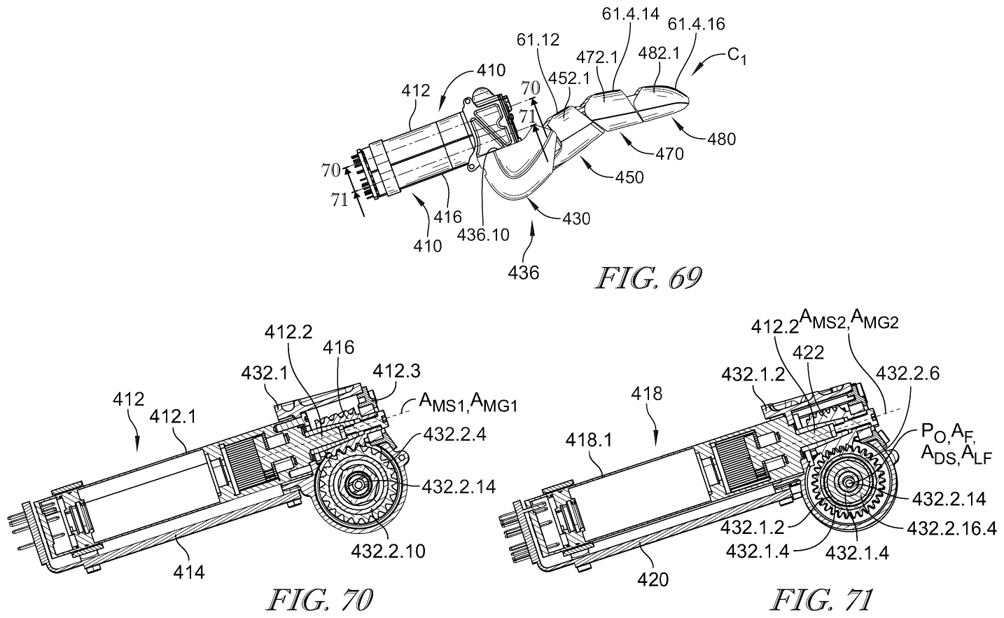

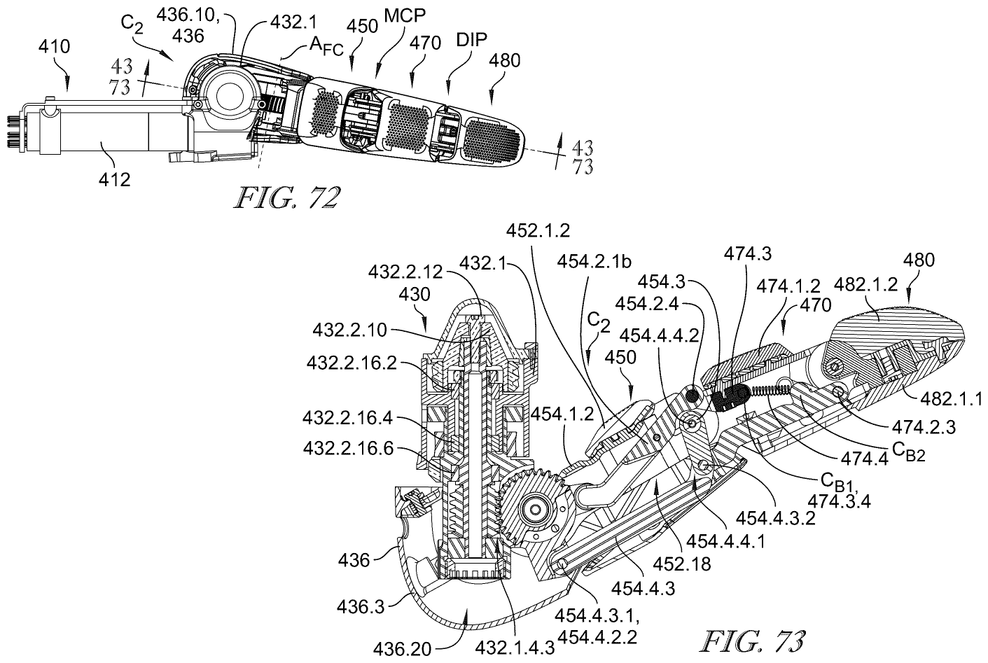

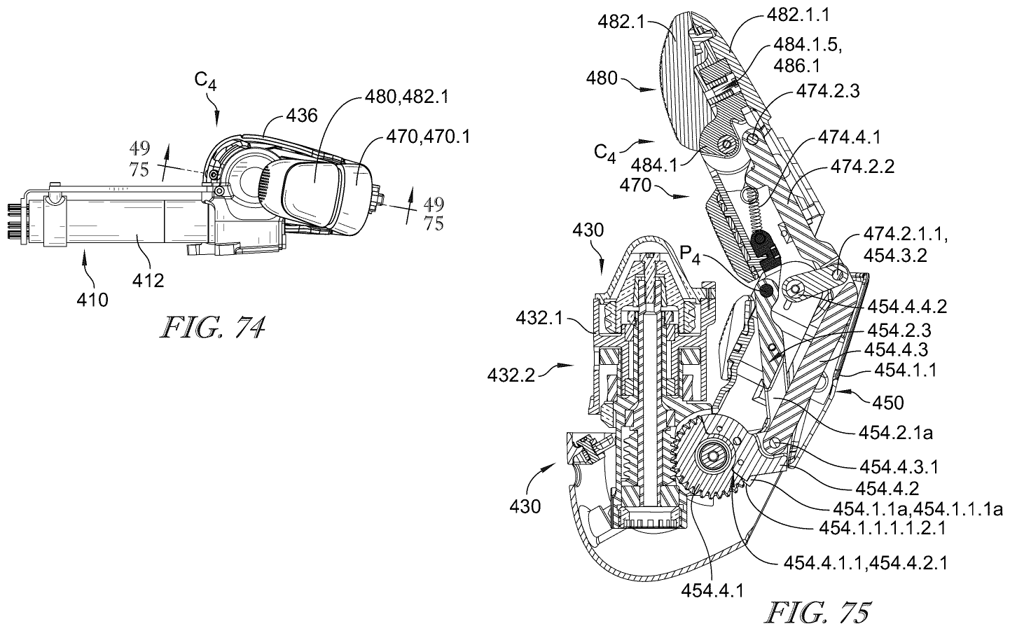

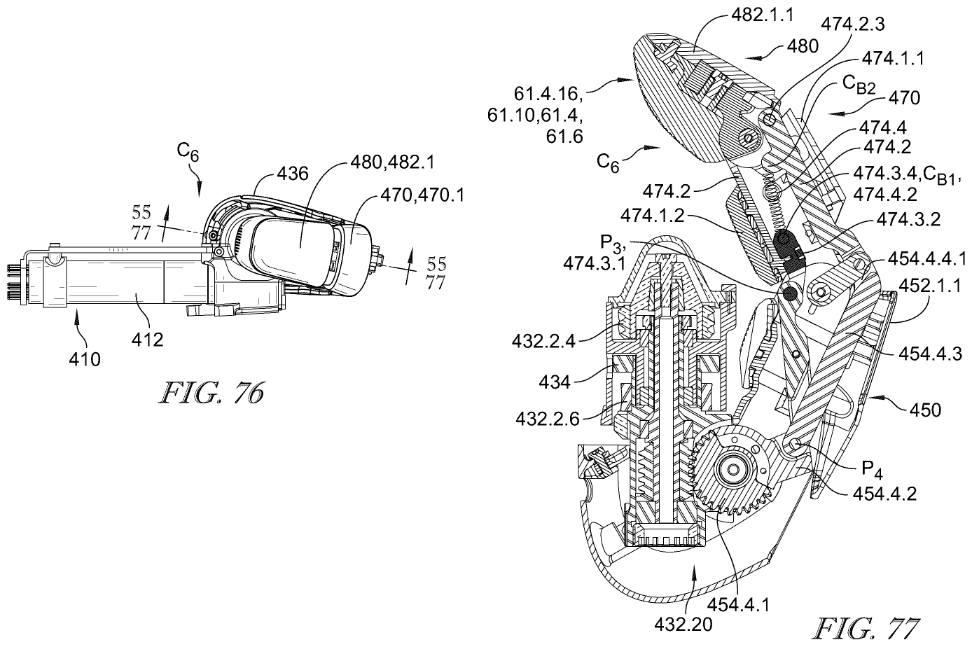

As shown in FIGS. 20-24 and 68-76, the distal housing assembly 482 is designed to substantially surround a majority of the other components of the distal assembly 480. To achieve this, the distal housing assembly 482 forms an internal distal recess 482.18 and specifically includes: (i) a distal jacket assembly 482.1 with a top member 482.1.1 and a bottom member 482.1.2, and (ii) a distal bottom casing assembly 482.2. While the bottom member 482.1.2 is in direct contact with and underlies the distal bottom casing assembly 482.2, the thumb assembly 40 lacks a distal top casing assembly that is in direct contact with the top member 482.1.1. This design is advantageous because the distal bottom casing assembly 482.2 provides the bottom member 482.1.2 with additional rigidity, which enables said bottom member 482.1.2 to be made from a softer, easier-to-form, and potentially less durable material, thereby increasing the gripping capability of the end effector 10. In contrast, the top member 482.1.1 does not need to include a softer, easier-to-form, and potentially less durable material because said top member 482.1.1 is not designed to come into regular contact with objects. Additionally, even if the materials of the distal bottom casing assembly 482.2 and the bottom member 482.1.2 are the same, it may be desirable to form these components as two separate components to facilitate replaceability without exposing an inner extent of the thumb assembly 40. Another way of describing this beneficial configuration includes the fact that the distal jacket assembly 482.1 is configured to provide the primary external shape of the thumb assembly 40, while the distal casing assembly 482.2 is configured to protect the distal link assembly 484. Nevertheless, it should be understood that in an alternative embodiment, the bottom member 482.1.2 and the distal bottom casing assembly 482.2 may be integrally formed as a single structure.

As best shown in FIGS. 20-24, the top member 482.1.1 of the distal jacket assembly 482.1 includes an exterior surface back with a curvilinear extent in a first direction (namely, across the width of the thumb assembly 40). the bottom member 482.1.2 of the distal jacket assembly 482.1 includes an exterior palm surface that has a curvilinear extent in the first direction (namely, across the width of the thumb assembly 40) and a second direction (namely, across the length of the thumb assembly 40). The curvilinear extent in the first direction helps ensure that the thumb assembly 40 has rounded edges to help with grasping objects, while the curvilinear extent in the second direction helps ensure that the finger can curl inward. Additionally and as discussed above, the top member 482.1.1 of the distal jacket assembly 482.1 includes a rearward extending distal tongue 482.20. The distal tongue 482.20 has an arched shape with a curvilinear rear surface 482.20.2, wherein the width of said distal tongue 482.20 is reduced from a first or front width to a second or rear width. As such, the distal tongue 482.20 includes curvilinear extents in at least two directions. As discussed above, the distal tongue 482.20 is designed to be positioned within or adjacent to the medial housing assembly 472 and configured to minimize the gap G₄ that is formed between assemblies 470 and 480. It should be understood that in an alternative embodiment, the distal tongue 482.20 may be omitted.

As discussed above, the distal housing assembly 482 may be: (i) made from the same materials as the housing assembly 60, (ii) made from materials that differ from the materials used in the housing assembly 60, and/or (iii) may include silicon, plastic (e.g., may include a polymer composition), carbon composite, or metal, a combination of these materials, and/or any other known material used in robot systems. Alternatively, the distal housing assembly 482 may include additional components or layers (e.g., between three and an nth layer). It should also be understood that in alternative embodiments the distal jacket assembly 482.1 and the distal casing assembly 482.2 may be combined into a single component and/or additional exterior members may be added to the end effector 10/thumb assembly 40.

v. Distal Link Assembly

As shown in FIGS. 20-24 and 68-76, the distal link assembly 484 includes a mounting tip 486 and a primary or main distal link or eighth bar 484.1 having: (i) an interphalangeal opening 484.1.1, (ii) a coupler recess 484.1.2, (iii) a medial drive link opening 484.1.3, (iv) limiting projections 484.1.4 with a fourth limiting interface region 484.1.4.1, and (v) a tip projection 484.1.5 with a tip opening 484.1.5.1. The distal link assembly 484 is involved in the least number of movements of the thumb assembly 40 compared to the number of movements involving the proximal and medial assemblies 450, 470. As discussed above, this is in contrast to conventional end effectors and/or conventional fingers and is beneficial because it reduces complexities, reduces components, and increases reliability. It may have other benefits that are obvious to one of skill in the art.

The interphalangeal opening 484.1.1 is configured to receive a securement means that couples said main distal link 484.1 to the main medial link 474.1 to form the seventh pivot point P₇. The coupler recess 484.1.2 is formed near the interphalangeal opening 484.1.1 and is designed to have the medial drive link opening 484.1.3 positioned therein to help ensure that the securement means that couples the medial drive link 474.2 to the main distal link 484.1 does not interfere with other parts or components of the thumb assembly 40. Finally, the limiting projections 484.1.4 with the fourth limiting interface region 484.1.4.1 are designed to interact with an extent of the main medial link 474.1 to help ensure that the distal assembly 480 does not over-curl or move backward (e.g., away from the palm 62).

### B. Kinematics of the End Effector

As best shown in FIGS. 9, 10 and 12, the disclosed end effector 10 includes: (i) at least one, and preferably five, metacarpophalangeal (MCP) joints 23a-23e, (ii) at least one, and preferably four, proximal interphalangeal (PIP) joints 24a-24d, (iii) at least one, and preferably five, distal interphalangeal (DIP) joints 25a-25e, and (iv) at least one, preferably two, carpometacarpal (CMC) joints 26a, 26b. As shown in these Figures, each finger assembly 22a-22d includes: (i) an MCP joint 23a-23d or a first joint (FFJ1, MFJ1, RFJ1, LFJ1), (ii) a PIP joint 24a-24d or a second joint (FFJ2, MFJ2, RFJ2, LFJ2), and (iii) a DIP joint 25a-25d or a third joint (FFJ3, MFJ3, RFJ3, LFJ3). The inclusion of these three joints 23a-23d, 24a-24d, 25a-25d allows each finger assembly 22a-22d to have three degrees of freedom, while being driven by a single integrated motor 212. As shown in these Figures, the thumb assembly 40 includes: (i) a second CMC joint 26a or a first joint (THJ1), (ii) a first CMC joint 26b or a second joint (THJ2), (iii) a FIP or MCP joint 23e or a third joint (THJ3), and (iv) a DIP joint 25e or a fourth joint (THJ4). The inclusion of these four joints, 26a, 26b, 23e, 25e allows the thumb assembly 40 to have four degrees of freedom, while being driven by two integrated motors 412, 418. As such, the disclosed end effector 10 has at least 12 degrees of freedom, and preferably 16 degrees of freedom, and utilizes at least four, and preferably six, integrated motors (four finger motors 212. two thumb motors 412. 418). Accordingly, the end effector 10 has approximately 2.66 (16 DoF/6 motors) degrees of freedom per motor.

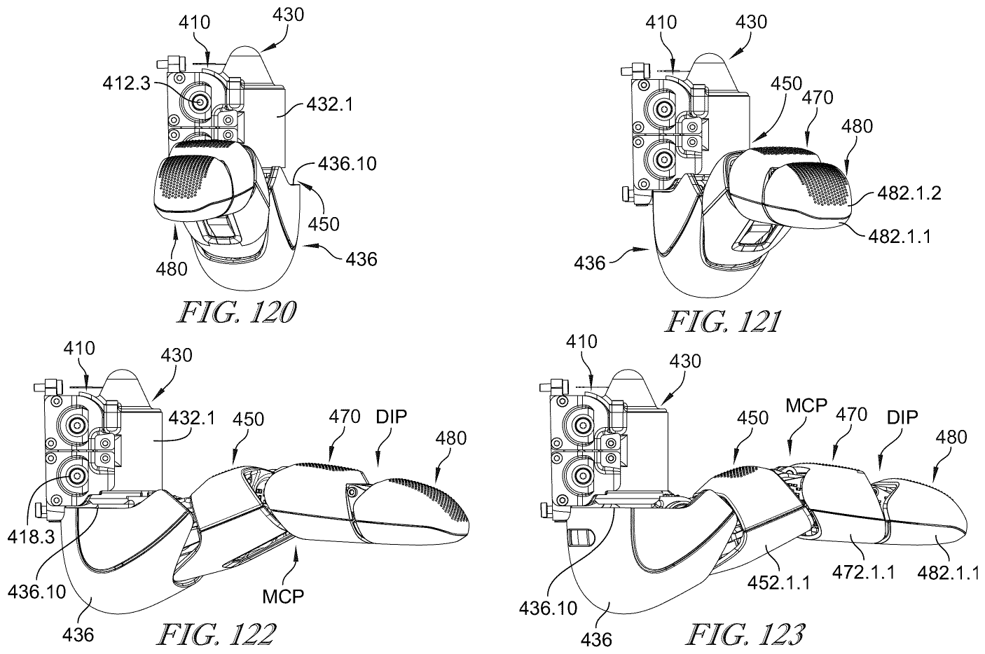

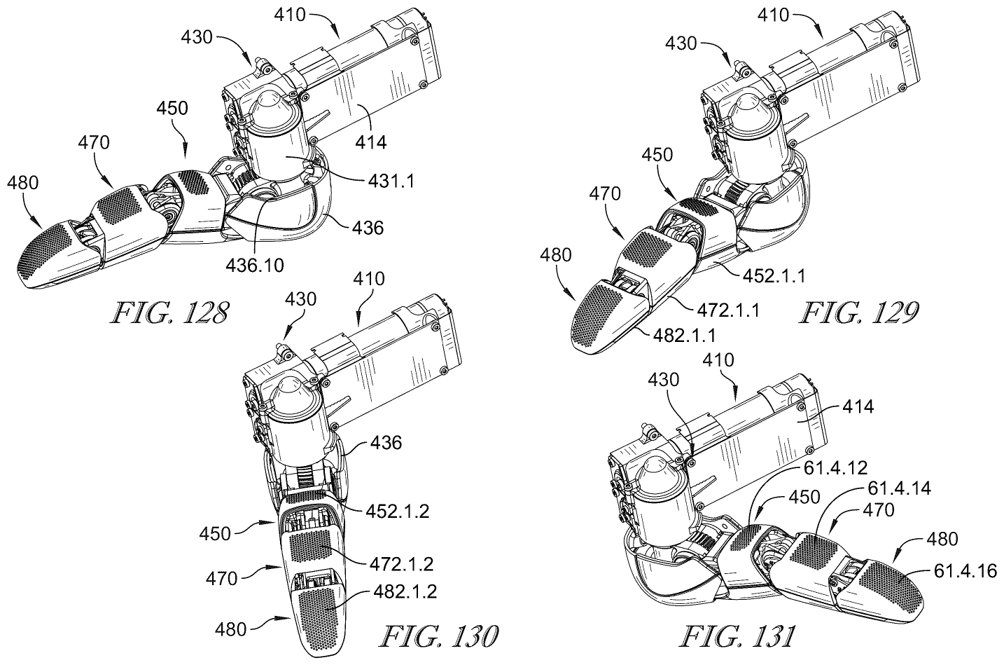

The first CMC₁ joint 26b is defined as having a rotational pivot point Po of the gear assembly 432.3 of the carpometacarpal joint assembly 432 (e.g. FIGS. 120-139), wherein the first CMC₁ joint 26b allows for adduction and abduction. The first CMC₁ joint 26b allows for rotation of the thumb assembly 40 in a plane, regardless of flexion position, and has a range of motion that is between 80° and 160°, preferably between 100° and 145°, and most preferably between 110° and 150°. To provide the range of motion associated with the first CMC₁ joint 26b, the internal angles range from 48° to 228°. The first CMC₁ joint 26b is: (i) positioned adjacent to the second CMC₂ joint 26a, (ii) has an axis A_{SC} that is substantially orthogonal to an axis A_{FC} of the second CMC₂ joint 26a.

The second CMC₂ joint 26a is defined between a lower extent of the motor assembly 410 and the First Link Plane L₁ (i.e., the plane that extends from the first pivot point P₁ to the sixth pivot point P₆) and has a range of motion that is between 35° and 65°, preferably between 40° and 60°, and most preferably between 45° and 55°. To provide the range of motion associated with the second CMC₂ joint 26a, the internal angles range from 12° in the first configuration C₁ to 78° in configurations C₄-C₇. It should be understood that the internal angle that extends from the lower extent of the motor assembly 410 to the contact pad/internal surface of the proximal assembly 450 ranges from 13° to 79°. As such, the internal angle has a range of motion that is between 37° and 60° and most preferably between 40° and 55°. The axis A_{FC} of the second CMC₂ joint 26a is orthogonal to the A_{SC} of the first CMC₁ joint 26b for movement of the proximal assembly 450 of the thumb assembly 40. The proximal assembly 450 can rotate about the second CMC₂ joint 26a such that movement is in the same plane as the medial and distal assemblies 470, 480 about the MCP and DIP joints 23e, 25e to flex or extend thumb assembly 40. The range of motion of the first CMC₁ joint 26b is greater than second CMC₂ joint 26a.

The MCP joint 23e is defined between the First Link Plane L₁ and the Second Link Plane L₂ (i.e., the plane that extends from the sixth pivot point Pe to the seventh pivot point P₇) and has a range of motion that is between 55° and 90°, preferably between 60° and 85°, and most preferably between 65° and 80°. To provide the range of motion associated with the MCP joint 23e, the internal angle ranges from 241° in the configuration C₁ 104° in configurations C₄-C₇. It should be understood that the contact pad/internal surface of the proximal assembly 450 to the contact pad/internal surface of the medial assembly 470 ranges from 106° to 246°. As such, the internal angle has a range of motion that is between 55° and 87° and most preferably between 60° and 80°.

The DIP joint 25e is defined between the Second Link Plane L₂ and the Third Link Plane L₃ (i.e., the plane that extends from the eighth pivot point P₈ to the forward most point of the finger FP) and has a range of motion that is between 35° and 57°, preferably between 40° and 55°, and most preferably between 43° and 52°. To provide the range of motion associated with the DIP joint 25e, the internal angles ranges from 231° in the first configuration C₁ 117° in the seventh configuration C₇. It should be understood that the contact pad/internal surface of the medial assembly 470 to the contact pad/internal surface of the distal assembly 480 ranges from 106° to 214°. As such, the internal angle has a range of motion that is between 35° and 55° and most preferably between 40° and 50°. In summary, the CMC₁ joint 26b has the largest range of motion, then the MCP joint 23e, then the CMC₂ joint 26a, and the DIP joint 25e has the smallest range of motion. Additionally, the largest angle is formed between the MCP joint 23e, then the DIP joint 25e, then the CMC₁ joint 26b, and the CMC₂ joint 26a has the smallest angle.

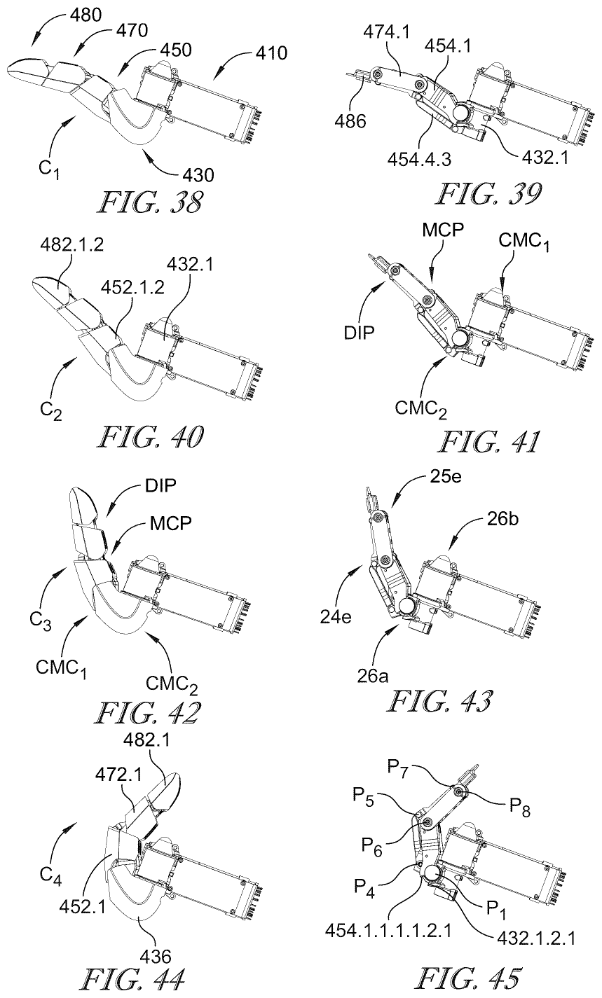

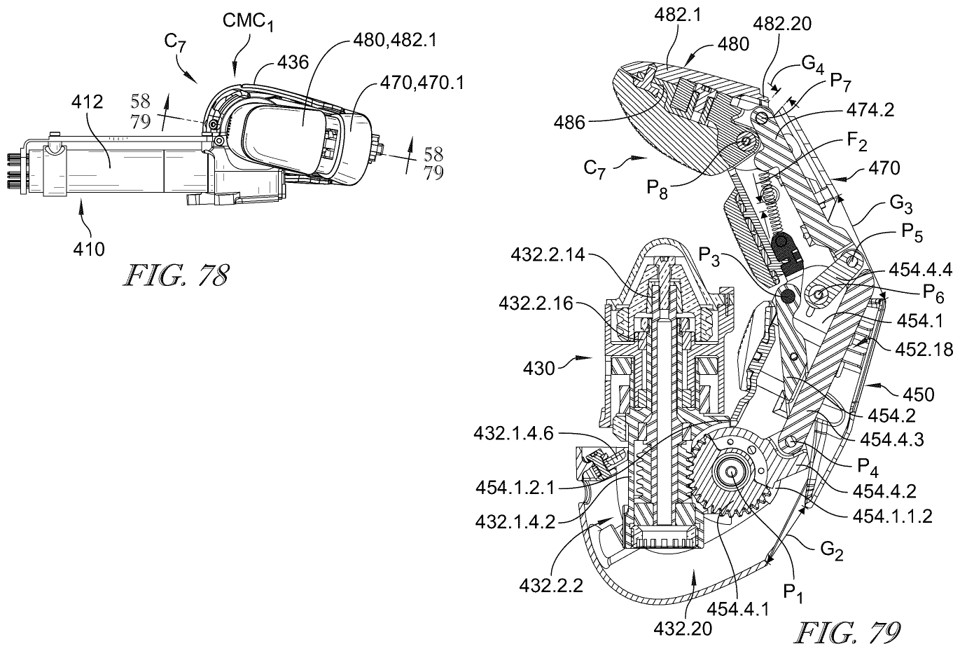

a. Scenario 1: FIGS. 38-79

The thumb assembly 40 moves from the first configuration C₁ until it reaches the seventh configuration C₇, for example as shown in FIGS. 38-58. During the movement between these configurations C₁-C₇, the thumb assembly 40 curls fully from an open, uncurled and unrotated, or neutral state without obstruction. In other words, the thumb assembly 40 is free to move, without being stopped or interrupted from: (i) the open, uncurled, hyperextended, or neutral state, to (ii) a point where the proximal, medial and distal assemblies are at a maximum flexion position or the thumb assembly 40 is in a fully curled or flexed state. In order for this movement to occur, the first motor 412 causes: (i) the first motor shaft 412.2 to rotate about a first motor shaft axis A_{MS1}, (ii) the rotation of the first motor shaft 412.2 causes the first motor gear 416 to rotate around the first motor gear axis A_{MSG1}, (iii) the rotation of the first motor gear 416 causes the flexion gear 432.2.4 to rotate about the flexion axis A_{F}, (iv) the rotation of the flexion gear 432.2.4 causes the flexion gear adaptor 432.2.10 to rotate, (v) the rotation of the flexion gear adaptor 432.2.10 causes the flexion gear coupler 432.2.12 to rotate, (vi) the rotation of the flexion gear coupler 432.2.12 causes the drive shaft or flexion shaft 432.2.14 to rotate about the drive shaft axis A_{DS}, (vii) the rotation of the drive shaft or flexion shaft 432.2.14 causes the worm drive gear 432.2.2 to rotate, (viii) the rotation of the worm drive gear 432.2.2 causes the worm wheel 454.4.1 to rotate about the worm wheel axis A_{ww}, and (ix) the rotation of the worm wheel 454.4.1 causes the worm wheel coupler 454.4.2 to rotate about the worm wheel axis A_{ww}. the rotation of the worm wheel coupler 454.4.2 causes the fourth pivot point P₄ to shift forward or towards the distal assembly 480. This forward shift causes the worm drive link or second bar 454.4.3 to shift forward or towards the distal assembly 480 and pivot about the fifth pivot point P₅, wherein this movement causes the medial drive link or sixth bar 474.2 to also shift forward or towards the distal assembly 480, pivot about the fifth pivot point Ps, and its other end forms P₈ with distal link. and can cause the biasing assembly 474.4 to deform. Finally, the movement of the medial drive link or sixth bar 474.2 causes the distal assembly 480 to rotate about the eighth pivot point P₈.

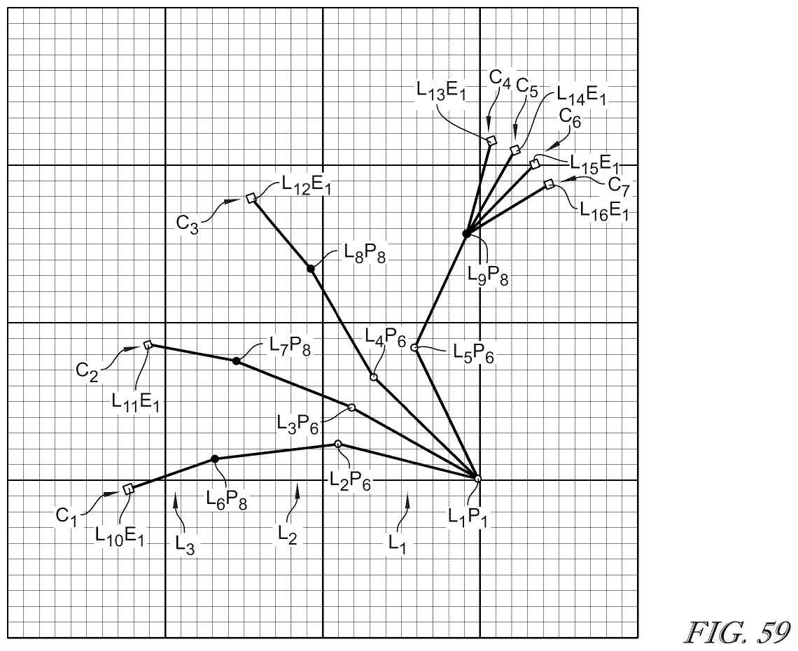

FIG. 59 is a schematic that shows the movement of the sixth pivot point P₆ (i.e., from the second location L_{2P6} to the fifth location L_{5P6}), the eighth pivot point P₈ sixth location L_{6P8} to the ninth location L_{9P8}), the end point of the thumb assembly 40 (i.e., from the tenth location L_{10PE1} to the sixteenth location L_{16P5}), the First Link Plane L₁, the Second Link Plane L₂, and the Third Link Plane L₃ caused by the movement of the thumb assembly 40 from the first configuration C₁ to the seventh configuration C₇. As shown in this schematic, movement of said thumb assembly 40 from the first configuration C₁ to the seventh configuration C₇ causes the sixth pivot point P₆ to move along a first curvilinear path CU₁, the eighth pivot point P₈ to move along a second curvilinear path CU₂, and the end point of the thumb assembly 40 to move along a third curvilinear path CU₃, wherein the first, second, or third curvilinear paths are not equal to one another. It can also be seen that the Second Link Plane L₂ and the Third Link Plane L₃ do not move relative to one another before the thumb assembly 40 moves to the fifth configuration C₅. Further, it can be seen that the First Link Plane L₁ and Second Link Plane L₂ do not move relative to one another after the thumb assembly 40 has reached the fourth configuration C₄.

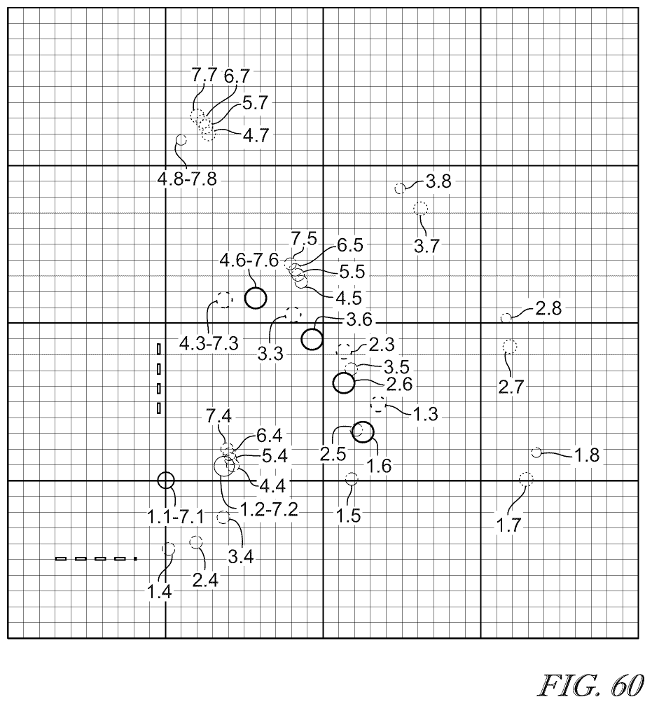

As will be discussed in greater detail below, FIG. 60 is a schematic that shows the movement of each of the eight pivot points that are caused by the movement of the thumb assembly 40 from the first configuration C₁ to the seventh configuration C₇. Each pivot point is labeled X.Y, wherein X is the configuration of the thumb assembly and Y is the number of the pivot point. For example, 4.2 indicates the location of the second pivot point P2 when the thumb assembly 40 is in the fourth configuration C₄. As shown in this schematic, movement of the thumb assembly 40 from the first configuration C₁ to the seventh configuration C₇ causes the seventh pivot point P₇ to rotate around the sixth pivot point P₆, all pivot points to rotate around the first pivot point P₁, and other information that is discernible by one of skill in the art based on their review of the figures in this application, including FIG. 60.

FIGS. 1-40 and 61-71 show the thumb assembly 40 in the first configuration C₁, wherein: (i) the proximal assembly 450 is offset from being parallel with the motor 412 by between 12° and 17°, and (ii) the proximal, medial, and distal assemblies 450, 470, 480 are in an open and original, uncurled and unrotated, or neutral state. In this first configuration C₁, the thumb assembly 40 is in the best position to start or begin to start the procedure for grasping an item due to the fact it is in hyperextension or near hyperextension.

FIGS. 41-43 and 72-73 show the thumb assembly 40 in a second configuration C₂, wherein: (i) the proximal assembly 450 is offset from being parallel with the motor 412 by between 24° and 36°, (ii) the medial assembly 470 is in a partially curled state, (iii) the distal assembly 480 is in the neutral state, and (iv) the contact pads of the medial assembly 470 and the distal assembly 480 are substantially aligned with one another. The movement of the proximal assembly 450 causes angular movement or change between the proximal and medial assemblies 450, 470. This is in contrast to the disclosed finger assemblies 22a-22d, wherein movement of the proximal assembly 250 does not cause angular movement or change between the proximal and medial assemblies 250, 270. Stated in another way, rotational movement of the proximal assembly 450 around pivot point P₁ changes the angle formed at the MCP joint 23e, and rotational movement of the proximal assembly 250 around its pivot point P₁ does not change the angle formed at the MCP joint 24a-24e. In comparing FIGS. 38-40 and FIGS. 41-43, the movement from the first configuration C₁ to the second configuration C₂ has caused the proximal assembly 450 to revolve around the first pivot point P₁ by approximately 12° to 19° and the medial assembly 470 to revolve around the sixth pivot point P₆ by approximately 11° to 16°.

FIGS. 44-46 show the thumb assembly 40 in a third configuration C₃, wherein: (i) the proximal assembly 450 is offset from being parallel with the motor 412 by between 36° and 54°, (ii) the medial assembly 470 is in a partially curled state, (iii) the distal assembly 480 is in the neutral state, and (iv) the contact pads of the medial assembly 470 and the distal assembly 480 are substantially aligned with one another. In comparing FIGS. 41-43 and FIGS. 44-46, the movement from the second configuration C₂ to the third configuration C₃ has caused the proximal assembly 450 to revolve around the first pivot point P₁ by approximately 12° to 18° and the medial assembly 470 to revolve around the sixth pivot point P₆ by approximately 18° to 28°. Movement from the second configuration C₂ to the third configuration C₃ illustrates that the medial assembly 470 may revolve around the sixth pivot point P₆ faster than the proximal assembly 450 revolves around the first pivot point Pt.

FIGS. 47-49 and 74-75 show the thumb assembly 40 in a fourth configuration C₄, wherein: (i) the proximal assembly 450 is offset from being parallel with the motor 412 by between 52° and 78°, (ii) the medial assembly 470 is in a partially curled state, (iii) the distal assembly 480 is in the neutral state, and (iv) the contact pads of the medial assembly 470 and the distal assembly 480 are substantially aligned with one another. As discussed below, the proximal and medial assemblies 450, 470 are at maximum flexion positions in configurations four through seven C₄-C₇. In comparing FIGS. 44-46 and FIGS. 47-49, the movement from the third configuration C₃ to the fourth configuration Ca has caused the proximal assembly 450 to revolve around the first pivot point P₁ by approximately 16° to 24° and the medial assembly 470 to revolve around the sixth pivot point P₆ by approximately 28° to 41°. At this fourth configuration C₄, the third limiting interface region 454.1.2.1 of the primary proximal link 454.1 has come into contact with the frame 432.1 of the carpometacarpal joint assembly 432, which in turn has limited the revolution of the proximal assembly 450 around the first pivot point P₁. Because of the interaction between an extent (i.e., third limiting interface region 454.1.2.1) of the proximal assembly 450 and the resistance surface/point (i.e., frame 432.1), movement beyond the fourth configuration C₄ will: (i) not allow the proximal or medial assemblies 450, 470 to curl or revolve inward, and (ii) cause engagement between the primary proximal link 454.1 and the worm bearings 456.2 to allow the thumb assembly 40 to continue bending or curling towards the palm 62. Without utilization of the worm bearings 456.2, the thumb assembly 40 could not continue bending or curling towards the palm 62 (i.e., the thumb assembly 40 would be locked out). It should be understood that in other embodiments, the frame assembly 432.1 may be modified to allow the proximal assembly 450 to: (i) further revolve around the first pivot point P₁ by another 10° to 40°, or (ii) revolve a smaller amount around said first pivot point P₁ by another 10° to 40°.

As discussed above, the movement from the fourth configuration C₄ to the fifth configuration C₅ causes: (i) the proximal housing assembly 452 and medial assembly 470 to remain frozen in its position, and (ii) the distal assembly 480 to start moving around an additional pivot point (i.e., eighth pivot point P₈). It should be understood from reviewing the Figures of this Application, that while the proximal and medial housing assemblies 452, 472 may be frozen in position, other components (e.g., biasing assembly 474.4, the proximal drive link assembly 454.4, medial link assembly 474) can continue to move or are not frozen. Without permitting the movement of these other components, the motor 412 could not continue driving the closure of the thumb assembly 40 once the proximal and medial assemblies 450, 470 come into contact with a resistant surface/point. It should be understood that additional or fewer components of the thumb assembly 40 may not be permitted to move once said thumb assembly 40 reaches the fourth configuration C₄.

FIGS. 50-52 show the thumb assembly 40 in a fifth configuration C₅, wherein: (i) the proximal and medial assemblies 450, 470 are in contact with a resistance point/surface, and (ii) the distal assembly 480 is in a partially curled state, wherein none of the assemblies 450, 470, 480 are substantially aligned. In said fifth configuration C₅, the proximal and medial assemblies 450, 470 are at a maximum flexion position and the distal assembly 480 is in a partially curled state. In comparing FIGS. 47-49 and FIGS. 50-52, the movement from the fourth configuration C₄ to the fifth configuration C₅ has caused the distal assembly 480 to revolve around the eighth pivot point P₈ by approximately 12° to 18°, which causes the fourth limiting interface region 484.1.4.1 to move from being in contact with a lower extent of the medial assembly 470.

FIGS. 53-55 and 76-77 show the thumb assembly 40 in a sixth configuration C₆, wherein: (i) the proximal assembly 450 is in contact with a resistance point/surface, and (ii) the proximal, medial, and distal assemblies 450, 470, 480 are in a second state, wherein none of the assemblies 450, 470, 480 are substantially aligned. In said sixth configuration C₆, the proximal and medial assemblies 450, 470 are at the maximum flexion position and the distal assembly 480 is in a partially curled state. In comparing FIGS. 50-52 and FIGS. 53-55, the movement from the fifth configuration C₅ to the sixth configuration C₆ has caused the distal assembly 480 to revolve around the eighth pivot point P₈ by approximately 12° to 18°.

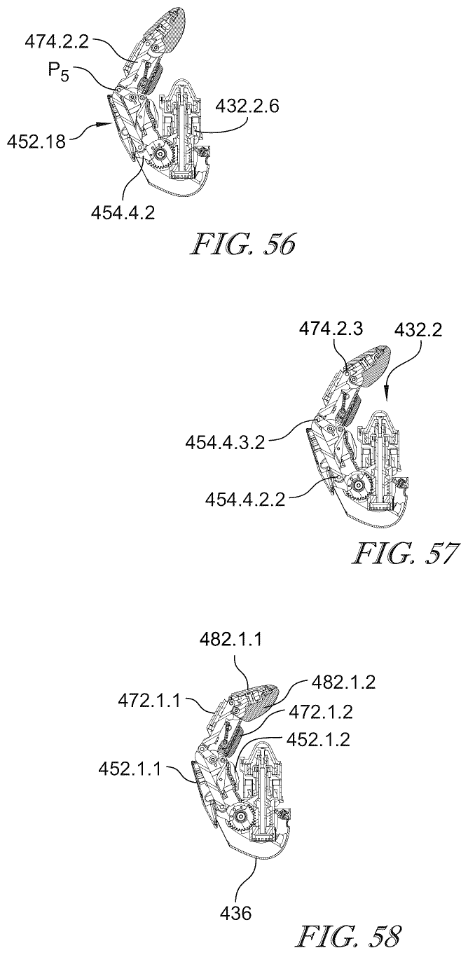

FIGS. 56-58 and 78-79 show the thumb assembly 40 in a seventh configuration C₇, wherein: (i) the proximal and medial assemblies 450, 470 are in contact with a resistance point/surface, (ii) the proximal, medial, and distal assemblies 450, 470, 480 are in a second state, wherein none of the assemblies 450, 470, 480 are substantially aligned, and (iii) the proximal, medial and distal assemblies are at maximum flexion position or the thumb assembly 40 is in a fully curled state. In comparing FIGS. 53-55 and FIGS. 56-58, the movement from the sixth configuration C₆ to the seventh configuration C₇ has caused the distal assembly 480 to further revolve around the eighth pivot point P₈ by approximately 12° to 18°. The revolution around the eighth pivot point P₈ is stopped when an upper extent of the limiting projections 484.1.4 comes into contact with an upper surface of the medial assembly 470. Overall, the quicker revolution of the medial assembly 470 around the sixth pivot point P6 in comparison to the revolution of the proximal assembly 450 around the first pivot point P₁ is desirable because the range of motion of the MCP joint 23e is larger than the range of motion of the DIP joint 25e.

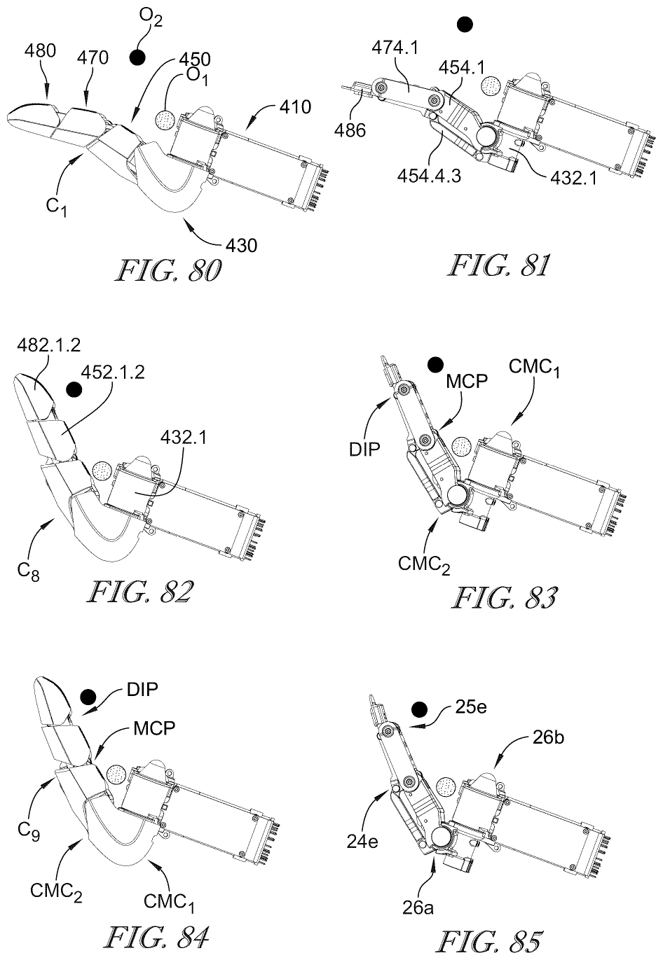

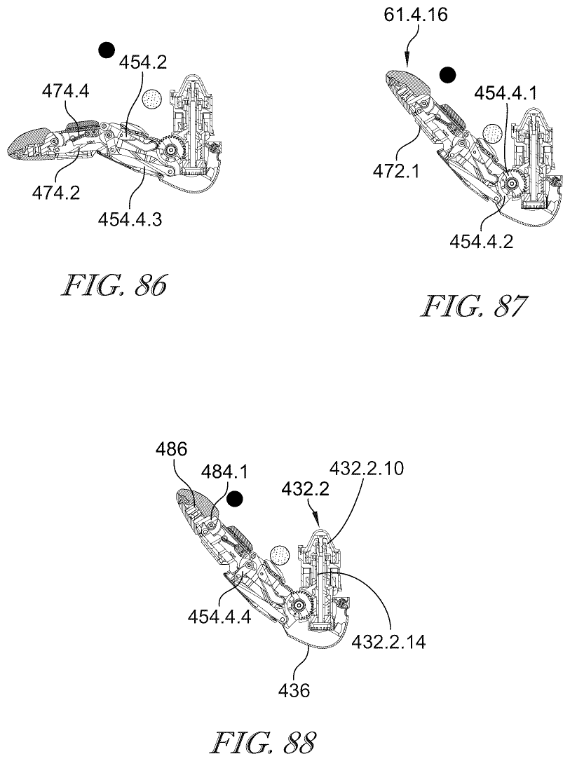

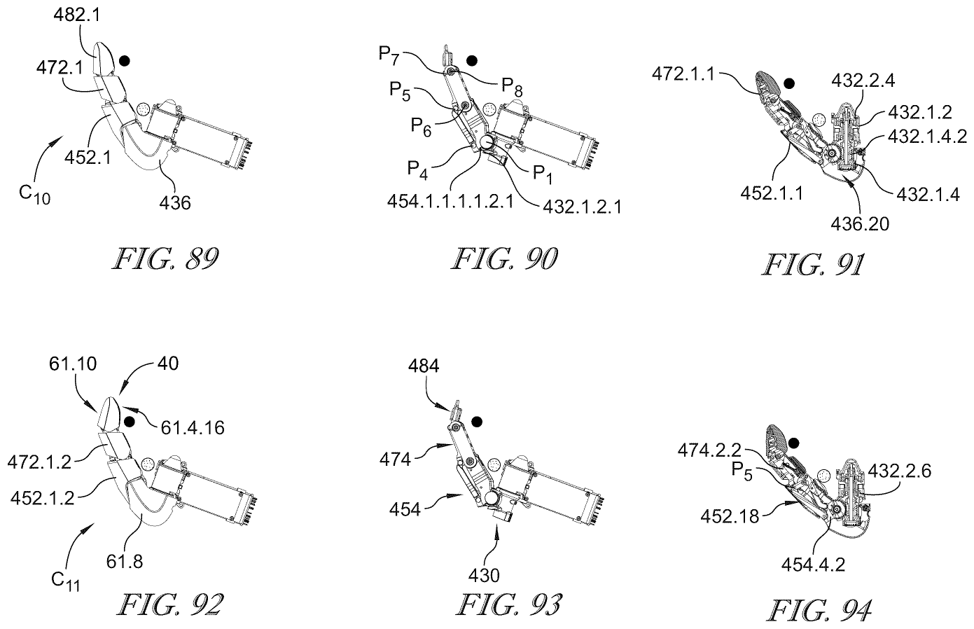

b. Scenario 2: FIGS. 80-98

The thumb assembly 40 moves from the first configuration C₁ to configurations eight through eleven (C₈-C₁₁). FIGS. 80-82 show the thumb assembly 40 in an open and original, uncurled and unrotated, or neutral state. During the movement, the thumb assembly 40 starts to curl, but the proximal assembly 450 comes into contact with a first object O₁ before the proximal assembly 450 or medial assembly 470 can be fully curled inward (i.e., allow contact between the third limiting interface region 454.1.2.1 and the first limiting interface region 432.1.2.1). In other words, the movement of the proximal assembly 450 is not independent of the medial assembly 470; thus the medial assembly 470 also stops before it can be fully curled inward. Stated another way, the CMC₂ joint 26a and the MCP joint 23e are linked together to allow the thumb assembly 40 to be underactuated. In operation, once the proximal assembly 450 or the medial assembly 470 comes into contact with a resistance point/surface (i.e., an object O₁ or the third limiting interface region 454.1.2.1 contacts an extent of the frame 432.1), the dependent distal assembly 480 starts moving or curling inward towards the palm 62.

Once the proximal assembly 450 comes into contact with the object O₁, the distal assembly 480 starts to curl inward. While curling inward, the distal assembly 480 comes into contact with a second object O₂. In other words, by positioning the object O₁ in a location that impedes proximal/medial curl, the thumb assembly 40 cannot maximize the range of movement of each joint contained in the thumb assembly 40 if a second object O2 further impedes distal curl. FIGS. 83-85 and 95-96 show the thumb assembly 40 in an eighth configuration C₈, wherein: (i) the proximal assembly 450 is in contact with a resistance point/surface (i.e., the first object O₁), and (ii) the medial and distal assemblies 470, 480 are substantially aligned. In these Figures,: (i) proximal assembly 450 revolved about the first pivot point P₁ by approximately 20° to 31°, (ii) the medial assembly 470 revolved around the sixth pivot point P₆ by approximately 23° to 34°, and (iii) the distal assembly 480 remains in a neutral state. In the eighth through tenth configurations C₈-C₁₀, the proximal and medial assemblies remain in partially curled states, while the distal assembly 480 continues to move about the eighth pivot point P₈ to a maximum flexion position or the thumb assembly 40 is in a fully curled state about the object O₁ (and potentially O₂).

For sake of brevity, movement from configuration eight to nine (C8 to C9) and from configuration nine to ten (C₉ to C₁₀) will not be discussed due to the fact that these movements are similar, if not the same as, the movements that the thumb assembly 40 undergoes when moving from the fourth to fifth (C₄ to C₅) and from fifth to sixth (C5 to C₆) configurations. However, it should be noted that the angles formed between the components in configurations nine (C₉) and ten (C₁₀) are slightly different from the angles formed between the components in configurations fifth (C₅) and sixth (C₆). In particular, the ninth configuration C₉ positions: (i) the proximal and medial assemblies 450, 470 are positioned with relationships between those discussed in connection with the second and third configurations (C₂, C₃), and (ii) the distal assembly 480 is positioned with relationships between those discussed in connection with the fifth and sixth configurations (C₅, C₆). While the tenth configuration C₁₀ positions: (i) the proximal and medial assemblies 450, 470 are positioned with relationships between those discussed in connection with the second and third configurations (C₂, C₃), and (ii) the distal assembly 480 is positioned with relationships between those discussed in connection with the fourth and fifth configurations (C₄, C₅). Finally, due to the fact the distal assembly 480 came into contact with a second object O₂, the distal assembly 480 was not able to move from a partially curled state into the fully curled state. Accordingly, the angles set forth in the eleventh configuration C11 do not match the angles disclosed in the seventh configuration C₇. In particular, the positional relationships in C₁₁ are: (i) the proximal and medial assemblies 450, 470 are positioned with relationships between those discussed in connection with the second and third configurations (C₂, C₃), and (ii) the distal assembly 480 is positioned with relationships between those discussed in connection with the sixth and seventh configurations (C₆, C₇).

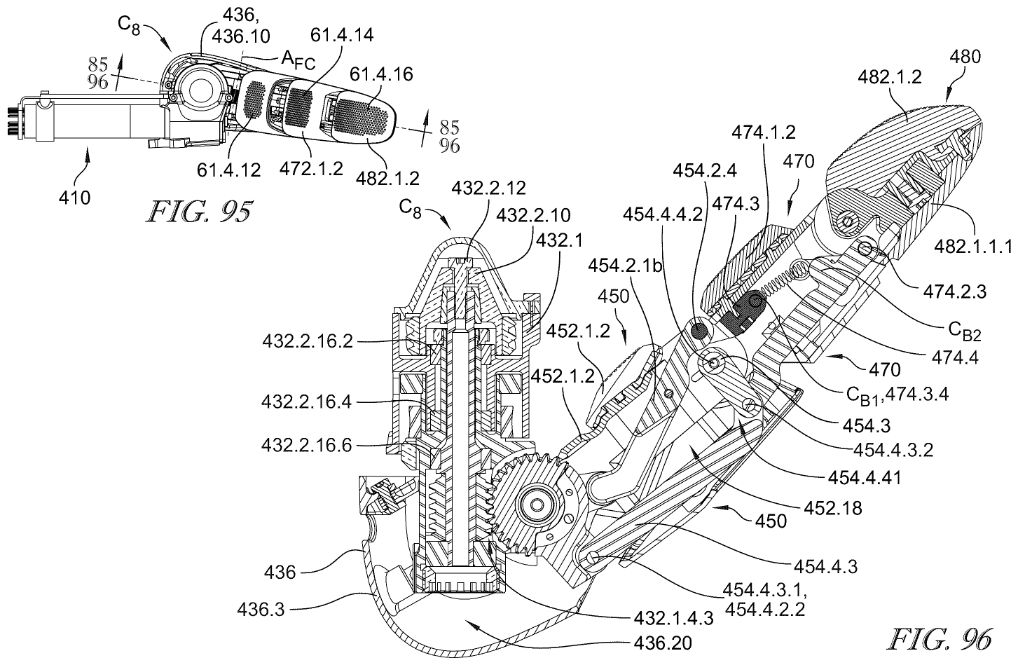

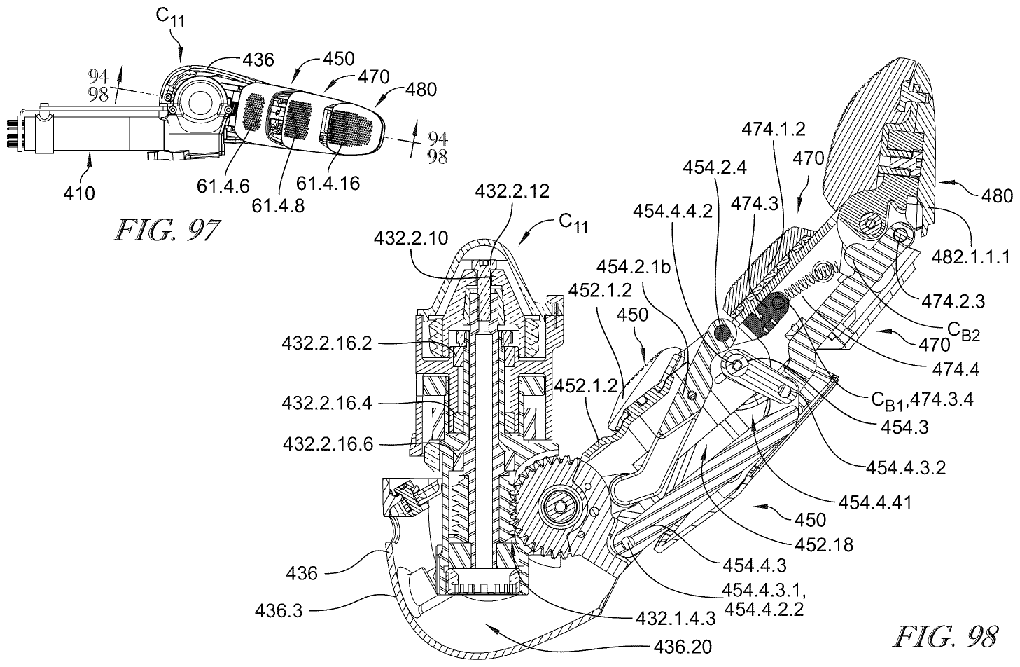

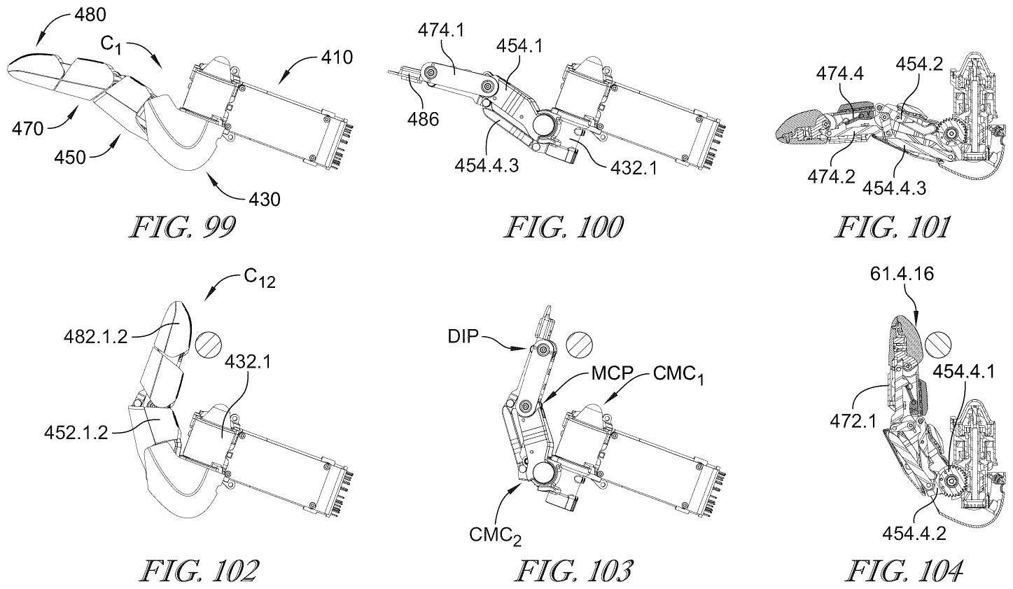

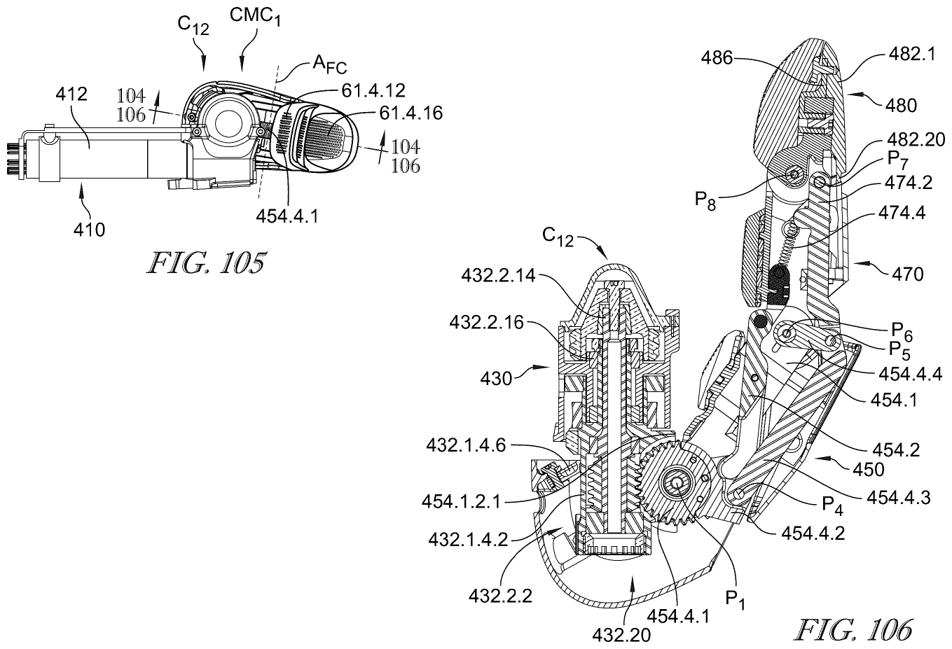

c. Scenario 3: FIGS. 99-106

The thumb assembly 40 moves from the first configuration C₁ to the twelfth configuration C₁₂. FIGS. 99-101 show the thumb assembly 40 in an open and original, uncurled and unrotated, or neutral state. During the movement, the thumb assembly 40 starts to curl, but the distal assembly 480 comes into contact with an object. Contact between the object and the distal assembly 480 prevents the thumb assembly 40 from being fully curled inward. In other words, by positioning the object in the disclosed locations, the thumb assembly 40 cannot maximize the range of movement of each joint contained in said thumb assembly 40. In fact, said contact between the object and the distal assembly 480 locks the thumb assembly 40 in position. Stated another way, said contact prevents the thumb assembly 40 from curling around the object. If this scenario happens while the end effector 10 is in use, said system will typically move the object due to compliance in the overall environment, or the robot will try to reposition the thumb assembly 40 within the environment.

FIGS. 102-106 show the thumb assembly 40 in the twelfth configuration C₁₂, wherein: (i) the distal assembly 480 is in contact with a resistance point/surface (i.e., the object), and (ii) the proximal, medial, and distal assemblies 450, 470, 480 are in a second state, wherein none of the assemblies 450, 470, 480 are substantially aligned. In said twelfth configuration C₁₂, none of the assemblies 450, 470, 480 are at a minimum or maximum flexion position. In these Figures: (i) the proximal assembly 450 revolved about the first pivot point P₁ by approximately 32° to 49°, and (ii) the medial assembly 470 revolved around the sixth pivot point P₆ by approximately 43° to 64°. It should be noted that the twelfth configuration C₁₂ is not the same as any of the first through the eleventh configurations C₁-C₁₁ because the rotation of the components is slightly different. In particular, the positional relationships between: (i) the medial and distal assemblies 470, 480 are positioned with relationships between those discussed in connection with the eighth and ninth configurations (C₈, C₉).

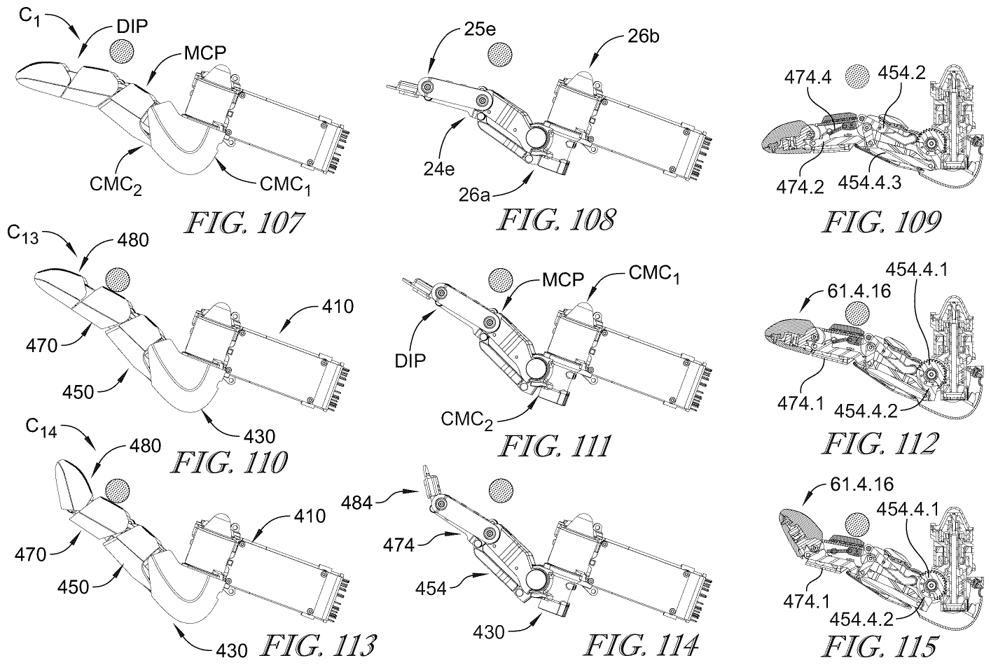

d. Scenario 4: FIGS. 107-119

The thumb assembly 40 moves from the first configuration C₁ to configurations thirteen and fourteen (C₁₃, C₁₄). FIGS. 107-109 show the thumb assembly 40 in an open and original, uncurled and unrotated, or neutral state. During the movement, the thumb assembly 40 starts to curl, but the medial assembly 470 comes into contact with an object before the proximal and medial assemblies 450, 470 can be fully curled inward (i.e., allow contact between the third limiting interface region 454.1.2.1 and the frame 432.1). In other words, by positioning the object in a fifth location, the thumb assembly 40 cannot maximize the range of movement of either the proximal or medial assemblies 450, 470. This contact between the object and the medial assembly 470 stops the proximal and medial assemblies 450, 470; however, the distal assembly 480 can continue movement.

FIGS. 110-112 and 116-117 show the thumb assembly 40 in the thirteenth configuration C₁₃, wherein: (i) the medial assembly 470 is in contact with a resistance point/surface (i.e., the object), (ii) the proximal and medial assemblies 450, 470 are in a partially curled state, and (iii) the distal assembly 480 is in a neutral state. In FIGS. 110-112 and 116-117: (i) the proximal assembly 450 revolved about the first pivot point P₁ by approximately 8° to 12°, (ii) the medial assembly 470 revolved about the sixth pivot point P₆ by approximately 7° to 9°, and (iii) the distal assembly 480 has not revolved around the eighth pivot point P₈. It should be noted that the thirteenth configuration C₁₃ is not the same as any of the first through the twelfth configurations C₁-C₁₂ because the rotation of the components is slightly different.

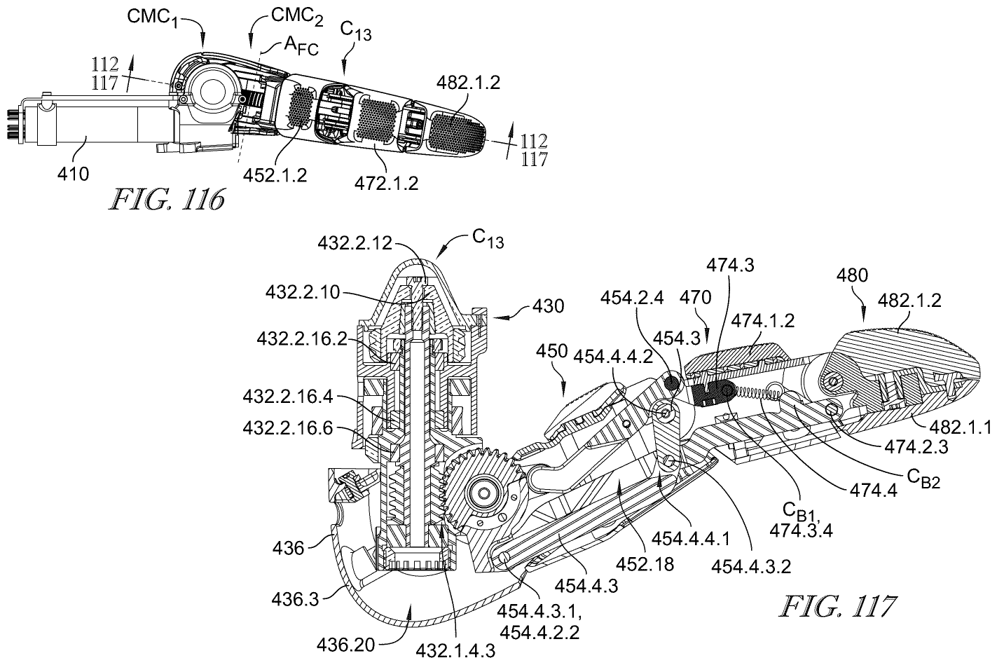

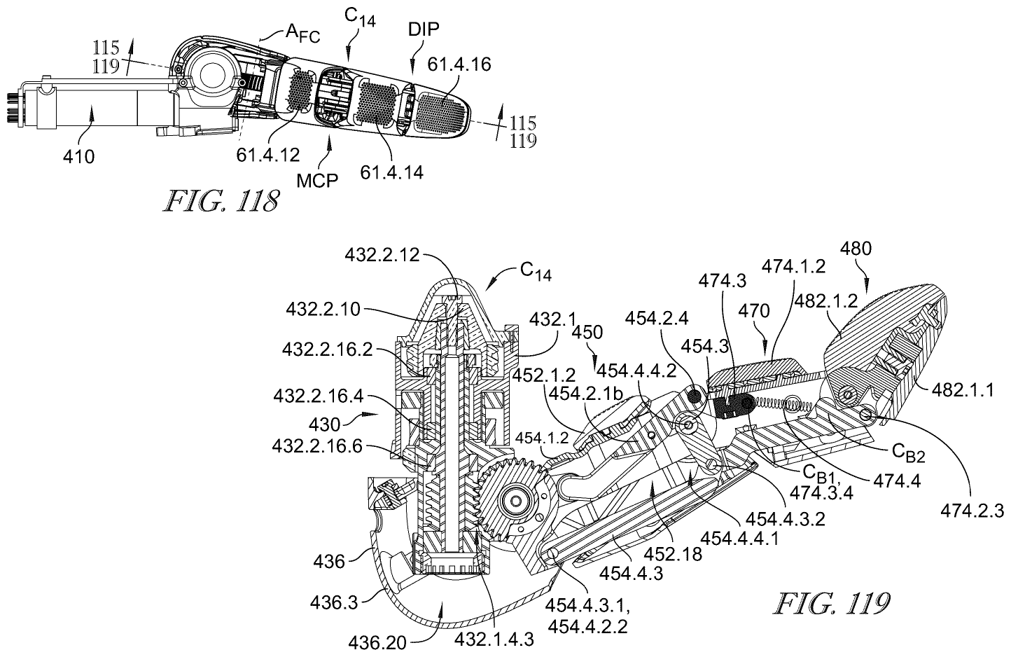

FIGS. 113-115 and 118-119 show the thumb assembly 40 in the fourteenth configuration C₁₄, wherein: (i) the medial assembly 470 is in contact with a resistance point/surface (i.e., the object), (ii) the proximal and medial assemblies 450, 470 are in a partially curled state, and (iii) the distal assembly 480 is in a maximum flexion position. In the fourteenth configuration C₁₄, neither the proximal assembly 450 nor the medial assembly 470 are at minimum or maximum flexion position. In FIGS. 118-119: (i) the proximal and medial assemblies 450, 470 remain in the same position as the thirteenth configuration C₁₃, and (ii) the distal assembly 480 revolved about the eighth pivot point P₈ by approximately 37° to 56°. It should be noted that the fourteenth configuration C₁₄ is not the same as any of the first through the thirteenth configurations C₁-C₁₃ because the rotation of the components is different.

e. Scenario 5: FIGS. 120-139

The thumb assembly 40 rotates about the first CMC₁ joint 26b allowing full inward rotation of the proximal, medial, and distal assemblies 450, 470, 480 towards the palm 62. In other words, the thumb assembly 40 can move from: (i) the unrotated state in the first configuration C₁ to (ii) to a fully rotated state in a seventeenth configuration C₁₇. To accomplish this, the second motor 418 moves the second motor drive gear 422, which interacts with the interposition gear 432.2.6 (as described above). FIGS. 120-139 illustrate the progression of movement from the first configuration C₁ to the seventeenth configuration C₁₇ while the proximal, medial, and distal assemblies 450, 470, 480 remain in an uncurled state. The angle of rotation about rotational pivot point ranges from about 228° in the first configuration C₁ to about 48° in the seventeenth configuration C₁₇.

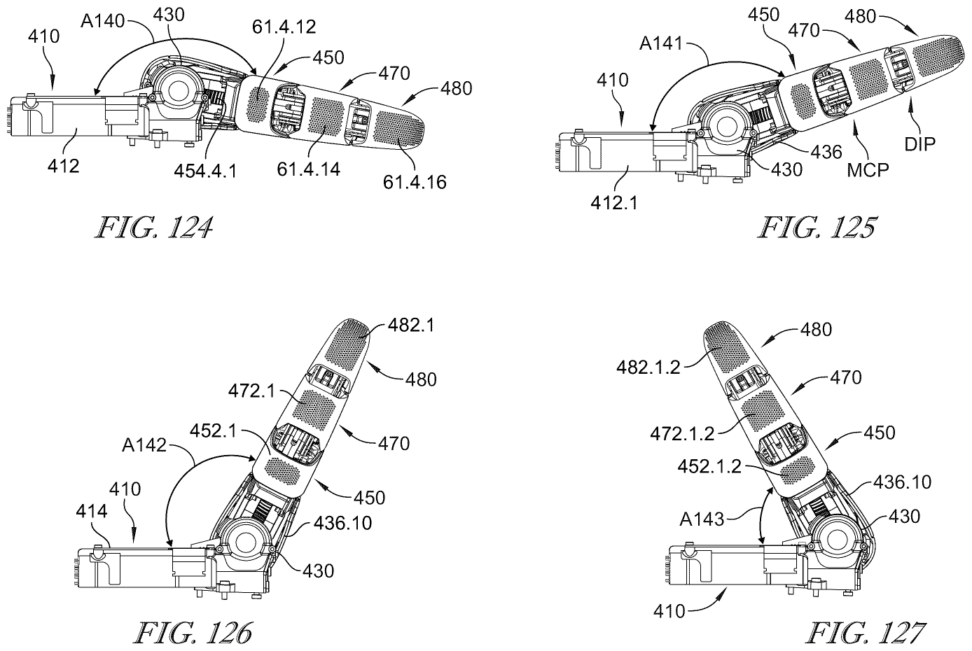

FIGS. 120 and 124 show the thumb assembly 40 in the first configuration C₁, with an angle of about 228°. In FIGS. 121, 125, and 128-131, the thumb assembly 40 is in a fifteenth configuration C₁₅, where an internal angle of about 160° is formed between an inner surface and the palm 62. In FIGS. 122, 126, and 132-135, the thumb assembly 40 is in a sixteenth configuration C₁₆, where an internal angle of about 125° is formed between an inner surface and the palm 62. In FIGS. 123, 127, and 136-139, the thumb assembly 40 is in the seventeenth configuration C₁₇, where an internal angle of about 48° is formed between an inner surface and the palm 62.

As discussed above, the first motor 412 drives the drive shaft 432.2.14 via the gears (i.e., flexion gear 432.2.4, first motor gear 416) and cap (flexion gear coupler 432.2.12 or adaptor 432.2.10) Additionally, the second motor 418 drives the anterposition gear 432.2.6, which in turn rotates an extent of the thumb frame 432.1 (specifically, the lower frame member 432.1.4). Due to the configuration of the gear (interposition gear 432.2.6), frame (thumb frame 432.1), and axle (drive shaft/flexion shaft 432.2.14), movement of the second motor 418 also moves the axle 432.2.14. The movement of the axle 432.2.14 by the second motor 418 causes the worm drive gear 432.2.2 to move the worm wheel 454.4.1, which causes flexion of the thumb assembly 40. In other words, when the thumb assembly 40 is rotated inward or towards the palm 62 during adduction the thumb assembly 40 also undergoes slight flexion or curling. Likewise, when the thumb assembly 40 is rotated outward or away from the palm 62 during abduction, the thumb assembly 40 also undergoes slight extension. Stated another way, there is a degree of coupling between the second CMC₂ joint 26 and the first CMC₁ joint 26b. To adjust for this coupling, the robot can compensate for this slight degree utilizing software. In other embodiments, the configuration of the gear (anterposition gear 432.2.6), frame (thumb frame 432.1), and axle (drive shaft/flexion shaft 432.2.14) may be altered such that there is no coupling between the first CMC₁ joint 26 and the second CMC₂ joint 26b. In this alternative embodiment, there will be no flexion or extension of the thumb assembly 40 when the assembly 40 undergoes adduction or abduction. Although the figures illustrate the thumb assembly 40 in a neutral state as an example to show the rotational movement, the same rotational movement can be applied to the thumb assembly 40 in various states of flex or extension where the proximal, medial, and distal assemblies 450, 470, 480 are uncurled, partially curled, or fully curled.

### C. Configurations, Planes, Pivot Points, Angles, and Distances

TABLE 1

| | |
|---|---|
| P_{S}, P_{22b} | Sagittal Plane or Middle Finger Plane |
| P_{TM} | Thumb Motor Plane |
| P_{SU} | Surface Plane |
| P_{S1} | First Section Plane |
| P_{S2} | Second Section Plane |

TABLE 2

| | |
|---|---|
| P₀ | Zero Pivot Point - Fixed |
| P₁ | First Pivot Point - Fixed |
| P₂ | Second Pivot Point - Fixed |
| P₃ | Third Pivot Point - Fixed |
| P₄ | Fourth Pivot Point - Not Fixed |
| P₅ | Fifth Pivot Point - Not Fixed |
| P₆ | Sixth Pivot Point - Fixed |
| P₇ | Seventh Pivot Point - Not Fixed |
| P₈ | Eighth Pivot - Fixed |

TABLE 3

| | |
|---|---|
| C₁ | First Configuration |
| C₂ | Second Configuration |
| C₃ | Third Configuration |
| C₄ | Fourth Configuration |
| C₅ | Fifth Configuration |
| C₆ | Sixth Configuration |
| C₇ | Seventh Configuration |
| C₈ | Eighth Configuration |
| C₉ | Ninth Configuration |
| C₁₀ | Tenth Configuration |
| C₁₁ | Eleventh Configuration |
| C₁₂ | Twelfth Configuration |
| C₁₃ | Thirteenth Configuration |
| C₁₄ | Fourteenth Configuration |

TABLE 4

| | | |
|---|---|---|
| L₁ | First Link Plane | Extends Between P₁ and P₆ |
| L₂ | Second Link Plane | Extends Between P₆ and P₈ |
| L₃ | Third Link Plane | Extends Between P₈ and FP |
| L₄ | Fourth Link Plane | Extends Between P₅ and P₇ |
| L₅ | Fifth Link Plane | Extends Between P₃ and CB1 |
| L₆ | Sixth Link Plane | Extends Between P₂ and P₃ |
| L₇ | Seventh Link Plane | Extends Between P₁ and P₄ |
| L₈ | Eighth Link Plane | Extends Between P₄ and P₅ |
| L₉ | Ninth Link Plane | Extends Between P₅ and P₆ |

TABLE 5

| | | | |
|---|---|---|---|
| 1.1 | First Configuration, First Pivot Point | 4.2 | Fourth Configuration, Second Pivot Point |
| 2.1 | Second Configuration, First Pivot Point | 5.2 | Fifth Configuration, Second Pivot Point |
| 3.1 | Third Configuration, First Pivot Point | 6.2 | Sixth Configuration, Second Pivot Point |
| 4.1 | Fourth Configuration, First Pivot Point | 7.2 | Seventh Configuration, Second Pivot Point |
| 5.1 | Fifth Configuration, First Pivot Point | 1.3 | First Configuration, Third Pivot Point |
| 6.1 | Sixth Configuration, First Pivot Point | 2.3 | Second Configuration, Third Pivot Point |
| 7.1 | Seventh Configuration, First Pivot Point | 3.3 | Third Configuration, Third Pivot Point |
| 1.2 | First Configuration, Second Pivot Point | 4.3 | Fourth Configuration, Third Pivot Point |
| 2.2 | Second Configuration, Second Pivot Point | 5.3 | Fifth Configuration, Third Pivot Point |
| 3.2 | Third Configuration, Second Pivot Point | 6.3 | Sixth Configuration, Third Pivot Point |
| 7.3 | Seventh Configuration, Third Pivot Point | 5.6 | Fifth Configuration, Sixth Pivot Point |
| 1.4 | First Configuration, Fourth Pivot Point | 6.6 | Sixth Configuration, Sixth Pivot Point |
| 2.4 | Second Configuration, Fourth Pivot Point | 7.6 | Seventh Configuration, Sixth Pivot Point |
| 3.4 | Third Configuration, Fourth Pivot Point | 1.7 | First Configuration, Seventh Pivot Point |
| 4.4 | Fourth Configuration, Fourth Pivot Point | 2.7 | Second Configuration, Seventh Pivot Point |
| 5.4 | Fifth Configuration, Fourth Pivot Point | 3.7 | Third Configuration, Seventh Pivot Point |
| 6.4 | Sixth Configuration, Fourth Pivot Point | 4.7 | Fourth Configuration, Seventh Pivot Point |
| 7.4 | Seventh Configuration, Fourth Pivot Point | 5.7 | Fifth Configuration, Seventh Pivot Point |
| 1.5 | First Configuration, Fifth Pivot Point | 6.7 | Sixth Configuration, Seventh Pivot Point |
| 2.5 | Second Configuration, Fifth Pivot Point | 7.7 | Seventh Configuration, Seventh Pivot Point |
| 3.5 | Third Configuration, Fifth Pivot Point | 1.8 | First Configuration, Eighth Pivot Point |
| 4.5 | Fourth Configuration, Fifth Pivot Point | 2.8 | Second Configuration, Eighth Pivot Point |
| 5.5 | Fifth Configuration, Fifth Pivot Point | 3.8 | Third Configuration, Eighth Pivot Point |
| 6.5 | Sixth Configuration, Fifth Pivot Point | 4.8 | Fourth Configuration, Eighth Pivot Point |
| 7.5 | Seventh Configuration, Fifth Pivot Point | 5.8 | Fifth Configuration, Eighth Pivot Point |
| 1.6 | First Configuration, Sixth Pivot Point | 6.8 | Sixth Configuration, Eighth Pivot Point |
| 2.6 | Second Configuration, Sixth Pivot Point | 7.8 | Seventh Configuration, Eighth Pivot Point |
| 3.6 | Third Configuration, Sixth Pivot Point | | |
| 4.6 | Fourth Configuration, Sixth Pivot Point | | |

TABLE 6

| Configuration 1 | | | Configuration 2 | | |
|---|---|---|---|---|---|
| Angle | Lower Bound | Upper Bound | Angle | Lower Bound | Upper Bound |
| A56 | 142° | 214° | A62 | 142° | 213° |
| A57 | 164° | 246° | A63 | 153° | 229° |
| A58 | 13° | 19° | A64 | 25° | 38° |
| A59 | 154° | 231° | A65 | 153° | 229° |
| A60 | 161° | 241° | A66 | 150° | 225° |
| A61 | 12° | 17° | A67 | 24° | 36° |
| Configuration 4 | | | Configuration 6 | | |
| Angle | Lower Bound | Upper Bound | Angle | Lower Bound | Upper Bound |
| A74 | 142° | 213° | A86 | 118° | 178° |
| A75 | 106° | 159° | A87 | 106° | 159° |
| A76 | 53° | 79° | A88 | 53° | 79° |
| A77 | 152° | 228° | A89 | 129° | 193° |
| A78 | 104° | 156° | A90 | 104° | 155° |
| A79 | 52° | 78° | A91 | 52° | 78° |
| Configuration 7 | | | Configuration 8 | | |
| Angle | Lower Bound | Upper Bound | Angle | Lower Bound | Upper Bound |
| A92 | 106° | 160° | A98 | 142° | 213° |
| A93 | 106° | 159° | A99 | 141° | 211° |
| A94 | 53° | 79° | A100 | 33° | 49° |
| A95 | 117° | 175° | A101 | 152° | 228° |
| A96 | 104° | 155° | A102 | 138° | 207° |
| A97 | 52° | 78° | A103 | 32° | 48° |
| Configuration 11 | | | Configuration 12 | | |
| Angle | Lower Bound | Upper Bound | Angle | Lower Bound | Upper Bound |
| A116 | 113° | 169° | A122 | 142° | 213° |
| A117 | 141° | 211° | A123 | 121° | 181° |
| A118 | 33° | 49° | A124 | 45° | 67° |
| A119 | 122° | 183° | A125 | 151° | 227° |
| A120 | 138° | 207° | A126 | 118° | 177° |
| A121 | 32° | 48° | A127 | 44° | 66° |
| Configuration 13 | | | Configuration 14 | | |
| Angle | Lower Bound | Upper Bound | Angle | Lower Bound | Upper Bound |
| A128 | 142° | 214° | A134 | 106° | 159° |
| A129 | 158° | 236° | A135 | 158° | 236° |
| A130 | 21° | 31° | A136 | 21° | 31° |
| A131 | 153° | 230° | A137 | 117° | 175° |
| A132 | 154° | 232° | A138 | 155° | 232° |
| A133 | 20° | 29° | A139 | 20° | 29° |

TABLE 7

| | Lower | Upper | Preferred | Preferred |
|---|---|---|---|---|
| Angle | Bound | Bound | Lower Bound | Upper Bound |
| λ1 | 66.0° | 154.0° | 88.0° | 132.0° |
| λ2 | 30.4° | 70.9° | 40.5° | 60.8° |
| λ3 | 43.6° | 101.8° | 58.2° | 87.3° |
| λ4 | 28.9° | 67.4° | 38.5° | 57.8° |
| λ5 | 43.3° | 101.1° | 57.8° | 86.7° |
| A15 | 3.8° | 8.8° | 5.0° | 7.5° |
| A16 | 33.6° | 78.5° | 44.8° | 67.2° |
| A17 | 5.8° | 13.6° | 7.8° | 11.7° |
| A18 | 37.4° | 87.3° | 49.9° | 74.8° |
| A19 | 42.8° | 99.8° | 57.0° | 85.6° |
| A20 | 1.7° | 3.9° | 2.3° | 3.4° |
| A21 | 80.3° | 187.4° | 107.1° | 160.7° |
| A22 | 46.7° | 109.0° | 62.3° | 93.4° |
| A23 | 46.4° | 108.2° | 61.8° | 92.8° |
| A24 | 72.7° | 169.6° | 96.9° | 145.4° |
| A25 | 96.9° | 226.2° | 129.2° | 193.9° |
| A26 | 3.5° | 8.2° | 4.7° | 7.1° |
| A27 | 10.9° | 25.4° | 14.5° | 21.7° |
| A28 | 14.9° | 34.8° | 19.9° | 29.8° |
| A29 | 2.9° | 6.8° | 3.9° | 5.8° |
| A30 | 57.8° | 135.0° | 77.1° | 115.7° |
| A31 | 42.9° | 100.2° | 57.3° | 85.9° |
| A32 | 39.1° | 91.2° | 52.1° | 78.2° |
| A33 | 5.4° | 12.6° | 7.2° | 10.8° |
| A34 | 44.5° | 103.8° | 59.3° | 88.9° |
| A35 | 54.0° | 126.0° | 72.0° | 108.0° |

TABLE 8

| | Lower | Upper | Preferred | Preferred |
|---|---|---|---|---|
| Distance | Bound | Bound | Lower Bound | Upper Bound |
| D30 | 13.5 | 31.5 | 18 | 27 |
| D31 | 18.5 | 42.5 | 24.5 | 36.5 |
| D32 | 20.5 | 47.5 | 27 | 40.5 |
| D33 | 7 | 16.5 | 9.5 | 14 |
| D34 | 6 | 14.5 | 8 | 12.5 |
| D35 | 1.5 | 3 | 1.5 | 2.5 |
| D36 | 5.5 | 13 | 7.5 | 11.5 |
| D37 | 6.5 | 15 | 8.5 | 13 |
| D38 | 5 | 11.5 | 6.5 | 10 |
| D39 | 4 | 10 | 5.5 | 8.5 |
| D40 | 0.5 | 1.5 | 1 | 1.5 |
| D41 | 1 | 2.5 | 1.5 | 2 |
| D42 | 8.5 | 19.5 | 11 | 16.5 |
| D43 | 2.5 | 6 | 3.5 | 5.5 |
| D44 | 4 | 9 | 5 | 7.5 |
| D45 | 7 | 16.5 | 9.5 | 14 |
| D46 | 11.5 | 27 | 15.5 | 23.5 |
| D47 | 12 | 27.5 | 16 | 23.5 |
| D48 | 14 | 32.5 | 18.5 | 27.5 |
| D49 | 6 | 14 | 8 | 12 |
| D50 | 17.5 | 40.5 | 23 | 35 |
| D51 | 5.5 | 13 | 7.5 | 11 |
| D52 | 18.5 | 42.5 | 24.5 | 36.5 |
| D53 | 21.5 | 49.5 | 28.5 | 42.5 |
| D54 | 20.5 | 48 | 27.5 | 41 |
| D55 | 7 | 17 | 9.5 | 14.5 |

### D. Industrial Application

While the disclosure shows illustrative embodiments of a robot (in particular, a humanoid robot), it should be understood that embodiments are designed to be examples of the principles of the disclosed assemblies, methods and systems, and are not intended to limit the broad aspects of the disclosed concepts to the embodiments illustrated. As will be realized, the disclosed robot, and its functionality and methods of operation, are capable of other and different configurations and several details are capable of being modified all without departing from the scope of the disclosed methods and systems. For example, one or more of the disclosed embodiments, in part or whole, may be combined with a disclosed assembly, method and system. As such, one or more steps from the diagrams or components in the Figures may be selectively omitted and/or combined consistent with the disclosed assemblies, methods and systems. For example, end effector 10 may lack traditional sensors (e.g., pressure, force, etc.) found in a conventional end effector 10. Additionally, those skilled in the art would recognize that many features of the implementation can be grouped together, split apart, reorganized, removed, or duplicated. Further, one or more steps from the arrangement of components may be omitted or performed in a different order. Accordingly, the drawings, diagrams, and detailed description are to be regarded as illustrative in nature, not restrictive or limiting, of the said humanoid robot.

While the above-described robot is designed as a head for use with a general-purpose humanoid robot, it should be understood that its assemblies, components, learning capabilities, and/or kinematic capabilities may be used with other robots. Examples of other robots include: articulated robot (e.g., an arm having two, six, or ten degrees of freedom, etc.), a cartesian robot (e.g., rectilinear or gantry robots, robots having three prismatic joints, etc.), Selective Compliance Assembly Robot Arm (SCARA) robots (e.g., with a donut shaped work envelope, with two parallel joints that provide compliance in one selected plane, with rotary shafts positioned vertically, with an end effector attached to an arm, etc.), delta robots (e.g., parallel link robots with parallel joint linkages connected with a common base, having direct control of each joint over the end effector, which may be used for pick-and-place or product transfer applications, etc.), polar robots (e.g., with a twisting joint connecting the arm with the base and a combination of two rotary joints and one linear joint connecting the links, having a centrally pivoting shaft and an extendable rotating arm, spherical robots, etc.), cylindrical robots (e.g., with at least one rotary joint at the base and at least one prismatic joint connecting the links, with a pivoting shaft and extendable arm that moves vertically and by sliding, with a cylindrical configuration that offers vertical and horizontal linear movement along with rotary movement about the vertical axis, etc.), self-driving car, a kitchen appliance, construction equipment, or a variety of other types of robot systems. The robot system may include one or more sensors (e.g., cameras, temperature, pressure, force, inductive or capacitive touch), motors (e.g., servo motors and stepper motors), actuators, biasing members, encoders, housing, or any other component known in the art that is used in connection with robot systems. Likewise, the robot system may omit one or more sensors (e.g., cameras, temperature, pressure, force, inductive or capacitive touch), motors (e.g., servo motors and stepper motors), actuators, biasing members, encoders, housing, or any other component known in the art that is used in connection with robot systems.

In other embodiments, other configurations and/or components may be utilized. For example, the end effector 10 may include one or more tactile sensor assemblies. The tactile sensor assembly may measure the load experienced on the finger assemblies of the end effector using a strain gauge or arrays of strain gauges. The strain gauges may measure strain, which may be used to determine the force, stress, torque, pressure, deflection, etc. experienced on the finger assemblies. The feedback provided by these tactile sensor assemblies embedded in the end effector (finger assemblies) can be combined with data from the encoders, torque sensors and/or other sensors that are positioned adjacent to or configured to obtain information from each joint. This combination of feedback, data, and/or information can be used to control the actuation of the finger assemblies, potentially enabling the robot to perform complex manipulations that require delicate touch. While the tactile sensor assemblies may be primarily designed to be embedded in the distal assembly of the finger assemblies, it should be understood that: (i) the tactile sensor assemblies may be positioned at any location in the end effector (e.g., palm, finger, thumb), (ii) may not be embedded in the assembly; instead, may be integrally formed therewith or directly secured to an outer extent of said assembly, (iii) may be formed in a layer or external covering (e.g., textile assembly—namely, a glove) that is positioned on top of or over said assembly, and/or (iv) a combination of any one of the described options. Examples of possible combinations include: (i) a portion of the tactile sensor assembly positioned in the textile assembly (e.g., glove) and a portion of the tactile sensor assembly embedded within the end effector, (ii) a portion of the tactile sensor assembly secured to the exterior of the housing of said end effector and a portion of the tactile sensor assembly embedded within the end effector, (iii) a portion of the tactile sensor assembly positioned in the textile assembly (e.g., glove), a portion of the tactile sensor assembly secured to the exterior of the housing of said end effector, and a portion of the tactile sensor assembly embedded within the end effector, (iv) a portion of the tactile sensor assembly positioned in the textile assembly (e.g., glove), a portion of the tactile sensor assembly integrally formed with the exterior of the housing of said end effector, and a portion of the tactile sensor assembly embedded within the end effector, and/or (v) any combination of hybrid thereof.

The strain gauges included in the tactile sensor assemblies may be any type of strain gauge including: (i) linear strain gauges, (ii) double linear strain gauges, (iii) shear or torsional strain gauges, (iv) rosette strain gauges (T (or Tee) shaped, rectangular shaped, delta shaped, stacked), (v) diaphragm strain gauges, (vi) biaxial strain gauges, (vii) bi-directional strain gauges, (viii) stacked strain gauges, (ix) cross strain gauges, (x) double shear, (xi) circular, (xii) any hybrid or combination thereof, and/or (xi) any other suitable strain gauge type that is known to one of skill in the art. The strain gauges may be arranged in different configurations including: (i) quarter-bridge configurations, (ii) half-bridge configurations, and/or (iii) full-bridge configurations. The strain gauges may also be foil strain gauges, semiconductor strain gauges, thin-film strain gauges, ink based strain gauges, thick-film strain gauges, optical, nano composite, and/or any combination or hybrid thereof. Further, the strain gauges may be directly integrated into the housings (interior or exterior), coupled to said housings (interior or exterior) after the housing is manufactured, coupled to another structure (e.g., bridge, spring, etc.) positioned within the housing, integrated into or coupled to the motor or motor housing, positioned between housings, and/or any other known configuration or combination thereof.

The foil strain gauges may be made from or include: (i) foils that may be or may include constantan (copper-nickel alloy) karma (nickel-chromium alloy) isoclastic (nickel-iron alloy) evanohm (nickel-chromium alloy) nichrome v (nickel-chromium alloy), and (ii) carrier that may be or may include polyimide film, epoxy or phenolic resin, glass-fiber reinforced epoxy, ceramic backing, and/or polyurethane. Finally, the strain gauges may be any gauge that meets, uses, and/or was tested with at least one of the flowing standards: ASTM E251-13 (2018), Standard Test Methods for Performance Characteristics of Metallic Bonded Resistance Strain Gages, ASTM International, ISO 376:2011, Metallic materials—Calibration of force-proving instruments used for the verification of uniaxial testing machines, ISO 9513:2012, Metallic materials—Calibration of extensometer systems used in uniaxial testing, VDI/VDE 2635 Blatt 2, Experimental structural analysis—Recommendation on the implementation of strain measurements at high temperatures, IEC 61298-3:1998, Process measurement and control devices—General methods and procedures for evaluating performance—Part 3: Tests for the effects of influence quantities, DIN 51301, which is hereby incorporated by reference for all purposes. The strain gauges may be used in combination with other sensors in the sensing assembly or at alternate locations in the robot. Other sensors or technology that may replace or be added to the tactile sensor assembles are discussed below.

It should be understood that other sensors and/or technology may be used instead of or in combination with the sensor assemblies discussed above. Other strain gauge technology that may be used includes: (i) mems-based strain gauges, (ii) nanocomposite strain gauges, (iii) thin-film or thick-film strain gauges (e.g., C4A Series or EA Series from Vishay Precision Group, RF9 Series or Y Series from Hottinger Brüel & Kjær, KFG Series or KFR Series from Kyowa Electronic Instruments, TFSG Series from BCM Sensor Technologies, SGT Series or KFH Series from Omega Engineering, ELF Series or EPL Series from Meggitt Sensing Systems, or any other known manufacture), (iv) inductive strain gauges, (v) capacitive strain gauges, (vi) piezoelectric strain gauges, (vii) optical fiber strain gauges, (viii) semiconductor strain gauges, and/or (ix) a hybrid or combination thereof. The strain gauges may provide measurements with high accuracy, but may lack high resolution. The additional sensors used in combination with the strain gauges in the sensor assembly may help provide a higher resolution. Alternative or additional sensors/technology may include photodiodes, Hall Effect sensors, capacitive sensors, piezoelectric sensors, piezoresistive sensors, optical sensors, force-sensitive resistors (FSRs), magnetic sensors, inductive sensors, micro-electro-mechanical systems (MEMS) sensors, dielectric elastomer sensors, quantum tunneling composite (QTC) sensors, fiber Bragg grating sensors, ultrasonic sensors, thermal sensors, electroactive polymers, triboelectric nanogenerators (TENGs), linear variable differential transformers (LVDTs), flex sensors, acoustic emission sensors, resistive touch sensors, proximity sensors, hydrogel-based sensors, smart skin technologies, magnetoelastic sensors, capacitive micromachined ultrasonic transducers (CMUTs), pressure-sensitive adhesives, electromagnetic acoustic transducers (EMATs), photonic crystal sensors, laser doppler vibrometers, electrical impedance tomography sensors, graphene-based sensors, nanowire sensors, electronic skin (e-skin) sensors, carbon nanotube-based sensors, barometric pressure sensors, eddy current sensors, microfluidic tactile sensors, nanogenerators, stretchable electronic sensors, force torque sensors, rheological sensors, haptic feedback sensors, polymer nanofiber sensors, ionic liquid-based sensors, thermocouple sensors, touch-sensitive field-effect transistors, terahertz radiation sensors, radar sensors, LIDAR sensors, infrared touch sensors, humidity sensors, mechanical limit switches, pressure mapping sensors, distributed fiber optic sensors, magnetostrictive sensors, optoelectronic sensors, surface acoustic wave (SAW) sensors, capaciflectance sensors, tribo-skin sensors, spintronic sensors, photonic touch sensors, acoustic resonant sensors, and capacitive tomography sensors, or any other suitable technology that is known to one of skill in the art.

In other embodiments, other configurations and/or components may be utilized. As is known in the data processing and communications arts, a general-purpose computer typically comprises a central processor or other processing device, an internal communication bus, various types of memory or storage media (RAM, ROM, EEPROM, cache memory, disk drives etc.) for code and data storage, and one or more network interface cards or ports for communication purposes. The software functionalities involve programming, including executable code as well as associated stored data. The software code is executable by the general-purpose computer. In operation, the code is stored within the general-purpose computer platform. At other times, however, the software may be stored at other locations and/or transported for loading into the appropriate general-purpose computer system.

A server, for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature, and it is presumed that those skilled in the art are adequately familiar therewith. The server functions may be implemented in a distributed fashion on a number of similar platforms, to distribute the processing load.

Hence, aspects of the disclosed methods and systems outlined above may be embodied in programming. Program aspects of the technology may be thought of as “products” or “articles of manufacture” typically in the form of executable code and/or associated data that is carried on or embodied in a type of machine-readable medium. “Storage” type media includes any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

A machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the disclosed methods and systems. Volatile storage media include dynamic memory, such as the main memory of such a computer platform. Tangible transmission media include coaxial cables, copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards, paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

It is to be understood that the invention is not limited to the exact details of construction, operation, exact materials or embodiments shown and described, as obvious modifications and equivalents will be apparent to one skilled in the art. While the specific embodiments have been illustrated and described, numerous modifications come to mind without significantly departing from the spirit of the invention, and the scope of protection is only limited by the scope of the accompanying Claims. It should also be understood that substantially utilized herein means a deviation less than 15% and preferably less than 5%. It should also be understood that other configuration or arrangements of the above-described components is contemplated by this Application. Moreover, the description provided in the background section should not be assumed to be prior art merely because it is mentioned in or associated with the background section. The background section may include information that describes one or more aspects of the subject of the technology. Finally, the mere fact that something is described as conventional does not mean that the Applicant admits it is prior art.

In this Application, to the extent any U.S. patents, U.S. patent applications, or other materials (e.g., articles) have been incorporated by reference, the text of such materials is only incorporated by reference to the extent that they do not conflict with materials, statements and drawings set forth herein. In the event of such conflict, the text of the present document controls, and terms in this document should not be given a narrower reading in virtue of the way in which those terms are used in other materials incorporated by reference. It should also be understood that structures and/or features not directly associated with a robot cannot be adopted or implemented into the disclosed humanoid robot without careful analysis and verification of the complex realities of designing, testing, manufacturing, and certifying a robot for completion of usable work nearby and/or around humans. Theoretical designs that attempt to implement such modifications from non-robotic structures and/or features are insufficient (and in some instances, woefully insufficient) because they amount to mere design exercises that are not tethered to the complex realities of successfully designing, manufacturing and testing a robot.

1. A thumb assembly for an underactuated end effector for a humanoid robot, the thumb assembly comprising:
a frame;
a sagittal plane;
a motor assembly removably coupled to the frame and including both a first motor and a second motor;
a base joint assembly coupled to the frame and comprising:
a flexion gear configured to be driven by the first motor, and wherein the first motor has a first motor shaft that is oriented at a first acute angle relative to the sagittal plane;
an interposition gear configured to be driven by the second motor, and wherein the second motor has a second motor shaft that is oriented at a second acute angle relative to the sagittal plane, and wherein the first acute angle is approximately equal to the second acute angle;
a first carpometacarpal joint formed between an extent of the base joint assembly and a digit assembly, and wherein movement of the interposition gear using the second motor causes the digit assembly to rotate about a first carpometacarpal joint axis of the first carpometacarpal joint; and
the digit assembly coupled to the base joint assembly and comprising:
a proximal assembly;
a second carpometacarpal joint pivotably coupling the proximal assembly to an extent of the base joint assembly, and wherein movement of the flexion gear using the first motor causes the digit assembly to rotate about a second carpometacarpal joint axis of the second carpometacarpal joint;
a proximal interphalangeal joint pivotably coupling the proximal assembly to a medial assembly; and
a distal interphalangeal joint pivotably coupling the medial assembly to a distal assembly.

2. The thumb assembly of claim 1, further comprising a carpometacarpal joint housing assembly configured to rotate in response to rotation of the interposition gear.

3. The thumb assembly of claim 2, wherein the carpometacarpal joint housing assembly includes an upper edge that is positioned proximate to a lower extent of a palm housing, and wherein said palm housing overlies an extent of the motor assembly.

4. The thumb assembly of claim 1, the thumb assembly further comprising:
a carpometacarpal joint housing assembly having a base joint receiver; and
a proximal housing assembly including a rear extent that is positioned within the base joint receiver when the thumb assembly is in an uncurled position, and wherein said rear extent of the proximal housing assembly is not positioned within the base joint receiver when the thumb assembly is in a curled position.

5. The thumb assembly of claim 1, wherein the proximal interphalangeal joint has a range of motion between 55 and 90 degrees.

6. The thumb assembly of claim 1, wherein the distal interphalangeal joint has a range of motion between 35 and 57 degrees.

7. The thumb assembly of claim 1, wherein the first carpometacarpal joint has a range of motion between 80 and 160 degrees, and the second carpometacarpal joint has a range of motion between 35 and 65 degrees.

8. The thumb assembly of claim 1, further comprising a rotation encoder positioned proximate the first carpometacarpal joint and configured to collect data related to rotation of the first carpometacarpal joint.

9. The thumb assembly of claim 1, wherein the thumb assembly is covered by a textile covering.

10. A thumb assembly for an underactuated end effector for a humanoid robot, the thumb assembly comprising:
a frame;
a motor assembly removably coupled to the frame and including both a first motor and a second motor;
a base joint assembly coupled to the frame and comprising:
a flexion gear configured to be driven by the first motor;
an interposition gear configured to be driven by the second motor;
a first carpometacarpal joint formed between an extent of the base joint assembly and a digit assembly, and wherein movement of the interposition gear using the second motor causes the digit assembly to rotate about a first carpometacarpal joint axis of the first carpometacarpal joint;
a carpometacarpal joint housing assembly configured to rotate in response to rotation of the interposition gear; and
the digit assembly coupled to the base joint assembly and comprising:
a proximal assembly;
a second carpometacarpal joint pivotably coupling the proximal assembly to an extent of the base joint assembly, and wherein movement of the flexion gear using the first motor causes the digit assembly to rotate about a second carpometacarpal joint axis of the second carpometacarpal joint;
a proximal interphalangeal joint pivotably coupling the proximal assembly to a medial assembly; and
a distal interphalangeal joint pivotably coupling the medial assembly to a distal assembly.

11. The thumb assembly of claim 10, wherein:
the first motor includes a first motor shaft that is rotatable about a first motor shaft axis;
the second motor includes a second motor shaft that is rotatable about a second motor shaft axis; and
the first motor shaft axis is oriented substantially parallel to the second motor shaft axis.

12. The thumb assembly of claim 10, the thumb assembly further comprising:
a proximal housing assembly including a rear extent that is positioned within the base joint receiver when the thumb assembly is in an uncurled position, and wherein said rear extent of the proximal housing assembly is not positioned within the base joint receiver when the thumb assembly is in a curled position, and
wherein the carpometacarpal joint housing assembly has a base joint receiver; and.

13. The thumb assembly of claim 10, further comprising: (i) a first encoder positioned proximate to the proximal interphalangeal joint and configured to collect data related to rotation of the proximal interphalangeal joint, and (ii) a second encoder positioned proximate to the distal interphalangeal joint and configured to collect data related to rotation of the distal interphalangeal joint.

14. The thumb assembly of claim 10, wherein the thumb assembly is covered by a textile covering.

15. The thumb assembly of claim 10, wherein the frame includes a palm region, and wherein the first motor and the second motor are at least partially located within the palm region of the frame.

16. The thumb assembly of claim 10, wherein the flexion gear is rotatable about a flexion axis, and wherein the flexion axis is oriented perpendicular to a first motor shaft axis of the first motor.

17. The thumb assembly of claim 10, wherein the thumb assembly further comprises both a biasing member coupled to an extent of the proximal assembly and an extent of the medial assembly, and wherein the biasing member is configured to bias the medial assembly toward an uncurled position.

18. An end effector for a humanoid robot, the end effector comprising:
a frame;
a plurality of finger assemblies connected to the frame, each finger assembly of the plurality of finger assemblies comprising:
a metacarpophalangeal joint;
a proximal finger interphalangeal joint;
a distal finger interphalangeal joint; and
a thumb assembly removably connected to the frame, the thumb assembly comprising:
a first carpometacarpal joint;
a second carpometacarpal joint;
a metacarpophalangeal joint;
an interphalangeal joint;
a carpometacarpal joint housing assembly having a base joint receiver;
a proximal housing assembly including a rear extent that is positioned within the base joint receiver when the thumb assembly is in an uncurled position, wherein said rear extent of the proximal housing assembly is positioned external to the base joint receiver when the thumb assembly is in a curled position;
a carpometacarpal encoder positioned proximate to the first carpometacarpal joint and configured to collect data concerning rotation of the first carpometacarpal joint;
a first thumb encoder positioned proximate to the metacarpophalangeal joint and configured to collect data concerning rotation of the metacarpophalangeal joint; and
a second thumb encoder positioned proximate the interphalangeal joint and configured to collect data concerning rotation of the interphalangeal joint, and wherein the first thumb encoder and second thumb encoder are positioned adjacent to a main medial link of the thumb assembly.

19. The end effector of claim 18, wherein the thumb assembly further comprises: (i) a first motor gear, (ii) a worm wheel configured to facilitate movement of the thumb assembly between an uncurled position and a curled position, and (iii) a thumb drive assembly in geared engagement with the first motor gear and the worm wheel.

20. The end effector of claim 19, wherein the thumb drive assembly further includes: (i) a flexion gear in geared engagement with the first motor gear, (ii) a worm drive gear in geared engagement with the worm wheel, and (iii) a drive shaft coupled to both the flexion gear and the worm drive gear.

21. The end effector of claim 18, wherein the frame includes a palm region, and wherein the first motor and the second motor are at least partially located within the palm region of the frame.

22. The end effector of claim 18, wherein the thumb assembly is configured to covered by a textile covering.

23. The end effector of claim 18, wherein the end effector has at least 2.66 degrees of freedom per motor.

24. The end effector of claim 18, further comprising a carpometacarpal joint housing assembly configured to rotate in response to rotation of an interposition gear.
